(19) United States
(12) Patent Application Publication
(10) Pub. No.: US 2002/0087573 A1
(43) Pub. Date: Jul. 4, 2002

(54) Automated prospector and targeted advertisement assembly and delivery system

(76) Inventors: Stephan Michael Reuning, Freehold, NJ (US); Nicole L. Bakos, Freehold, NJ (US)

Correspondence Address: MARK POHL, 55 MADISON AVENUE, 4TH FLOOR, MORRISTOWN, NJ, 07960

(21) Appl. No.: 09/911,024

(22) Filed: Jul. 24, 2001

Related U.S. Application Data
(63) Continuation-in-part of application No. 09/897,826, filed on Jul. 3, 2001.
Application No. 09/897,826 is a continuation of application No. 08/984,650, filed on Dec. 3, 1997.

(51) Int. Cl. G06F 7/00

(52) U.S. Cl. 707/102

(57) ABSTRACT

A system for locating professional profiles (such as resumes) on the Internet, extracting from these professional profiles contact data, compiling a database of desirable sales prospects or candidates, and merging this contact data with an advertising template to create a personalized advertisement.

### CROSS REFERENCES

This application is a continuation-in-part of REUNING, S. M., Ser. No. 09/______ which is a continuation of REUNING, S. M., Ser. No. 08/984,650, now U.S. Pat. No. ______. This application claims priority from REUNING, S. M. and N. L. BAKOS, Provisional Application No. ______, incorporated herein by reference.

### GOVERNMENT RIGHTS

None.

### BACKROUND

Direct marketing (e.g., direct mail and telemarketing) is well known. Direct marketing, of course, requires a database of targeted sales prospects.

Professional recruiting using resumes is similarly well known Until now, however, resumes have been used simply for professional recruiting.

We have realized that resumes, because they contain detailed professional profiles, could be useful in compiling a direct marketing data base to use in direct-mail campaigns for technical or professional products. Compiling such a database, however, has proven extremely labor intense. Perhaps this is why no one has yet used resumes to make a direct marketing sales prospect database. We have found a way.

Direct marketing databases can be compiled using data on purchasing agents, past purchasers of the product, highly visible executives, opt-in prospects, or respondents to “lead generation” advertising. Compiling such a database, however, has several difficulties. Industry journal subscriber lists may be available but will not be comprehensive. A list of purchasing agents may be available, but purchasing agents ultimately have little influence on a purchase decision.

Mailing list “brokers” sell access to sales-prospect databases, but these databases do not include any reasonably large list of technical or esoteric sales prospects (e.g., electron microscope end users, their supervisors and those who maintain, repair and sell electron microscopes and accessories). For example, there are currently 174 list “brokers” listed in the Direct Marketing Association's directory. None of these brokers, however, is currently able to provide a list of, for example: (1) electron microscope operators, (2) spectrophotometer operators, or (3) IBM AS/400® computer programmers or operators.

Job hunting web sites are another option for employers to display notices of available job positions. Unfortunately, many candidates do not post their resumes to such sites. Some candidates post their resume to only one or two sites. Other job candidates only post their resume on specialty resume posting “bulletin boards.” There are over 2,500 resume posting sites on the Internet. The vast number of these sites s a significant hurtle to employers who would like to see all potential candidates because employers would have to search each of these sites.

Job candidates may pre-register for notification of certain types of services, products, news, and jobs on specialty web sites. Relevant messages and advertisements are automatically sent to those prospects registered at these sites, generally via electronic mail. This reduces the need of the candidate to visit the web site on a daily basis in order to review any new offerings. However, the “push” method makes available to employers only those candidates willing to fill out the forms to these “Push” services. Pre-registration web sites also suffer because email addresses become stale quickly (so most of the electronic mail sent is undeliverable); certain services are recognized bulk mailers, so their e-mails are sent to a “bulk mail” folder which recipients seldom review; and potential candidates refuse mailing permission, thus removing themselves from the solicitation universe.

Two companies—“Resume Robot” and “Resputin”—search the Internet for resumes and supply the text version of resumes as documents or electronic computer file. These systems make available professional profiles of candidates in a manageable batch. They do not, however, “normalize” the contact information into specific record fields in a data structure so that the job candidates may be efficiently sorted and contacted via an automated system. In other words, the employer must read each resume, determine whether the candidate is qualified, locate the contact information on the resume, and then manually transfer that information to a communication medium such as electronic mail, a postal mail letter, or a facsimile. None of these resume collection systems provide a way to obtain the candidate contact information in a data structure. Because such a database compilation technology does not yet exist, it has not been possible to use resume information for product marketing tool, where the text of the resume is used to identify potential consumers of specific products.

The system we disclose requires only that the candidate post their professional profile in one place on the Internet This can be done by submitting it to the operator of our system, posting on their personal home page, posting on any public website, posting to a job website, or submiting in response to an advertisement. No other participation on the part of the prospect is required; our system will identify that candidate's professional profile when a relevant product or employment position becomes available, and then notify the candidate.

### SUMMARY

Our invention provides advertisers a method of assembling advertisements and supplying or creating a list of targets for those advertisements from a remote location. The advertiser uses a remote client or Internet browser to access the system and select images, text objects, and other digital objects to be assembled into a single advertisement. Once assembled and stored the operator may review the assembled advertisement as it might be generated for a specific prospect contact. Advertiser operators may access an interface that allows them to submit their own digital objects that may be assembled with other cataloged objects.

### BRIEF DESCRIPTION OF THE DRAWINGS

FIG. 1 shows the major procedural steps of our invention.

FIG. 2 shows a subset of procedural steps of step 1000 as shown in FIG. 1 that are related to the collection of professional profiles using our invention.

FIG. 3 shows a subset of procedural steps of step 1200 as shown in FIG. 2 that are related to the collection of professional profiles via the harvesting method using our invention.

FIG. 3A is a continuation of FIG. 3 and shows a subset of procedural steps of step 1200 as shown in FIG. 2 which are related to the collection of professional profiles via the harvesting method using our invention.

FIG. 3B shows a subset of procedural steps of step 1400 as shown in FIG. 2 that are related to the collection of professional profiles via the Third Party Import method using our invention.

FIG. 3C shows a subset of procedaral steps of step 1600 as shown in FIG. 2 that are related to the collection of professional profiles via the Portal Collection Site method using our invention.

FIG. 3D shows a subset of procedural steps of step 1800 as shown in FIG. 2 that are related to the collection of professional profiles via the Traditional Advertising method using our invention.

FIG. 4 shows a subset of procedural steps of step 2000 as shown in FIG. 1 that are related to Normalizing the data contained in collected professional profiles using our invention

FIG. 5 shows a subset of procedural steps of step 3000 as shown in FIG. 1 that are related to storing normalized professional profiles into a database using our invention.

FIG. 6 shows a subset of procedural steps of step 10000 as shown in FIG. 1 that are related to creating and storing media and media templates using our invention.

FIG. 6A shows a subset of procedural steps of step 11000 as shown in FIG. 1 that are related to creating and storing images using our invention.

FIG. 6B shows a subset of procedural steps of step 12000 as shown in FIG. 1 that are related to creating and storing headlines using our invention.

FIG. 7 shows a subset of procedural steps of step 5000 as shown in FIG. 1 that are related to selecting or submitting images using our invention.

FIG. 8 shows a subset of procedural steps of step 6000 as shown in FIG. 1 that are related to selecting and submitting headlines using our invention.

FIG. 9 shows a subset of procedural steps of step 4000 as shown in FIG. 1 that are related to selecting media and media templates using our invention.

FIG. 10 shows a subset of procedural steps of step 7000 as shown in FIG. 1 that are related to entering advertisement copy using our invention.

FIG. 11 shows a subset of procedural steps of step 8000 as shown in FIG. 1 that are related to selecting or entering a list of contacts using our invention.

FIG. 12 shows a subset of procedural steps of step 9000 as shown in FIG. 1 that are related to submitting and reviewing an advertisement using our invention.

FIG. 14 is a schematic diagram of a professional profile collecting and storing, contact database storage, advertising and notice creating, delivery list creating, and media delivering system according to our invention.

FIG. 17 is a schematic diagram demonstrating the database record format used by the system in storing contact data.

FIG. 18 shows the format of a normalized professional profile where the contact information fields are delimited by “Return” characters using our invention.

FIG. 18A shows the format of a normalized professional profile where the contact information fields are delimited by “Tab” characters using our invention.

FIG. 19 is an invention application software and computer interface that provides for the operator to import records into the contact database according to our invention.

FIG. 20 is an invention application software and computer interface that provides for the operator to be warned of potential duplicate records and input storage instructions related to said records while importing records into the contact database according to our invention.

FIG. 21 is an invention application software and computer interface that provides for the operator to select Internet search engines or input URL addresses as described in Step 1215 according to our invention.

FIG. 22 is an invention application software and computer interface that provides for the operator to insert search criteria, page filtering criteria, link qualifying criteria, and ignore URLs as described in Steps 1215, 1220, 1225, 1235 according to our invention.

FIG. 23 is an invention application software and computer interface that provides for the operator to observe real time results reporting as described in Step 1315 according to our invention.

FIG. 24 is an invention application software and computer interface that provides for the operator with real time reporting of harvested results as described in Step 1320 according to our invention.

FIG. 25 is an invention application software and computer interface that provides for the operator to exit the software program, export data and preferences imported to the application software, import previously exported data or import the results of a specific search according to our invention.

FIG. 26 is an invention application software and computer interface that provides for the operator to import a stored selection of originate hosts, or a stored selection of URLs to ignore or a stored selection of search criteria according to our invention.

FIG. 27 is an invention application software and computer interface that provides for the operator to export previously imported URLs to ignore or to export previously input search criteria to a storage file so that they may be imported and used at another time according to our invention.

FIG. 28 is an invention application software and computer interface that provides for the operator to resume a search that has been postponed or paused, or start a new search, or stop a search that is actively running on the apparatus according to our invention.

FIG. 29 is an invention application software and computer interface that provides for the operator to control the dialog window as it is displayed on the operating system desktop and/or to enter the preferences interface of the application software according to our invention.

FIG. 30 is an invention application software and computer interface that provides for the operator to access the preferences dialog window of the application software according to our invention.

FIG. 31 is an invention application software and computer interface that provides for the operator to enter preferences as described in Steps 1240, 1245, 1250, 1255, 1260, 1265, 1270, 1275, 1280, 1285, 1290, and 1295 FIGS. 3 and 3A according to our invention.

FIG. 32 is our invention application software interface that provides for the operator to set search engine controls as described in Step 1210.

FIG. 33 is an invention application software and computer interface that provides for the operator to access help menus according to our invention.

FIG. 34 is a schematic diagram demonstrating the database record format used by our invention system in advertisement submission data and data catalogs according to our invention.

FIG. 34A is an invention application software and computer interface that provides for the operator to select a computer operation related to the creation, updating, selecting, cataloging, assembling and otherwise processing advertisement images and data according to our invention.

FIG. 34B is an invention application software and computer interface that provides for the operator to input information relating to a new user of the advertisement submission system of our invention according to our invention.

FIG. 34C is an invention application software and computer interface that provides for the operator to submit a new advertisement according to our invention.

FIG. 34D-1 is an invention application software and computer interface that provides for the operator to submit new post card images, new letter head images and new border images to the Advertisement Submission Database according to our invention.

FIG. 34D-2 is an invention application software and computer interface, as one of many possible alternative to the interface demonstrated in FIG. 34D-1, that provides for the operator to submit new post card images, new letter head images and new border images to the Advertisement Submission Database according to our invention.

FIG. 34D-3 is an invention application software and computer interface that provides for the operator to receive a message informing of the result of the submission of images and data to the Advertisement Submission Database according to our invention.

FIG. 34E is an invention application software and computer interface that provides for the operator to submit new headlines to the Advertisement Submission Database according to our invention.

FIG. 34F is an invention application software and computer interface that provides for the operator to search for, locate, view and update submitted advertisements in the Advertisement Submission Database according to our invention.

FIG. 34G is an invention application software and computer interface that provides for the operator to view and update submitted advertisements in the Advertisement Submission Database according to our invention.

FIG. 34H is an invention application software and computer interface that provides for the operator to search for, locate, view and select images in the Advertisement Submission Database according to our invention.

FIG. 34I is a schematic diagram demonstrating the scroll down menus used by our invention system by the Advertisement Submission Interfaces according to our invention.

FIG. 34J is an invention application software and computer interface that provides for the operator to select a computer operation related to the selecting, creating, importing, and otherwise providing for a contact list for merger with a submitted advertisement according to our invention.

FIG. 34K is an invention application software and computer interface that provides for the operator to submit a contact list for merger with a submitted advertisement according to our invention.

FIG. 34L is an invention application software and computer interface that provides for the operator to search an invention contact database for the purpose of creating a contact list for merger with a submitted advertisement according to our invention.

FIG. 34M is an invention application software and computer interface that provides for the operator to process submitted advertisements according to our invention.

FIG. 34N is an invention application software and computer interface that provides for the operator to export processed advertisements to an assembly and print staging area according to our invention.

FIG. 35 is an assembly drawing that is a Z fold single page letter advertisement, as it may be produced by our invention, inserted into a windowed envelope.

FIG. 35A is a schematic that is the front and back side of a postcard, as it may be produced by our invention.

FIG. 35B is a schematic that is how an image variable, headline variables and a name field variable merge to form the image side of a postcard, as it may be produced by our invention.

FIG. 35C is a schematic that is how a copy field variable, a first name field variable, a street field variable, a first city field variable, a state field variable and a postal code field variable merge to form the message side of a postcard, as it may be produced by our invention.

FIG. 35D is a schematic that is how, in our invention, the Post Card Template or Post Card Profile or Post Card Job appears in a computer interface screenshot of a graphic application such as Darwin Desktop and QuarkXpress (herein incorporated as reference) according to our invention.

FIG. 35E is a schematic that is how, in our invention, the Letter Head Only Template or Letter Head Only Profile or Letter Head Only Job appears in a computer interface screenshot of a graphic application such as Darwin Desktop and QuarkXpress (herein incorporated as reference) according to our invention.

FIG. 35F is a schematic that is the printed side of a Letter Head Only letter advertisement, as it may be produced by our invention.

FIG. 35G is a schematic that is he printed side of a Letter Head and Left Border letter advertisement, as it may be produced by our invention.

FIG. 35H is a schematic that is how, in our invention, the Letter Head and Left Border Template or Letter Head and Left Border Profile or Letter Head and Left Border Job appears in a computer interface screenshot of a graphic application such as Darwin Desktop and QuarkXpress (herein incorporated as reference) according to our invention.

FIG. 35I is an illustration that is a post card media QuarkXPress layout with variable data boxes.

FIG. 35J is a Microsoft Word 2000 document with variable input fields.

FIG. 36 is a schematic that is how, in our invention, key features of the New Profile window appear in a computer interface screenshot of a graphic application such as Darwin Desktop® and QuarkXpress® used according to our invention.

FIG. 36A is a schematic that is how, in our invention, key features of the New Job window appear in a computer interface screenshot of a graphic application such as Darwin Desktop® and QuarkXpress® used according to our invention.

FIG. 36B is a schematic that is how, in our invention, key features of the Data window appear in a computer interface screenshot of a graphic application such as Darwin Desktop and QuarkXpress used according to our invention.

FIG. 36C is a schematic that is how, in our invention, key features of the Pages window appear in a computer interface screenshot of a graphic application such as Darwin Desktop and QuarkXpress used according to our invention.

FIG. 36D is a schematic that is how, in our invention, key features of the CoPilot window appear in a computer interface screenshot of a graphic application such as Darwin Desktop and QuarkXpress used according to our invention.

FIG. 36E is a schematic that is how, in our invention, key features of the Pages window appear in a computer interface screenshot of a graphic application such as Darwin Desktop and QuarkXpress (herein incorporated as reference) displaying a Post Card layout as it may appear when used according to our invention.

FIG. 36F is a schematic that is how, in our invention, key features of the Print Run Information window appear in a computer interface screenshot of a graphic application such as Darwin Desktop and QuarkXpress used according to our invention.

FIG. 36G is a schematic that is how, in our invention, key features of the Print Runs window appear in a computer interface screenshot of a graphic application such as Darwin Desktop and QuarkXpress used according to our invention.

FIG. 36H is a schematic that is how, in our invention, key features of the Library window appear in a computer interface screenshot of a graphic application such as Darwin Desktop and QuarkXpress used according to our invention.

FIG. 37 shows a subset of procedural steps of step 13000 as shown in FIG. 1 that are related to processing media using our invention.

FIG. 38 shows a subset of procedural steps of step 14000 as shown in FIG. 1 that are related to printing and finishing media using our invention.

FIGS. 39 and 39A is an invention application software and computer interface that provides for the submission of professional profile information and contact information via a computer network such as the Internet.

FIG. 40 is an invention application software and computer interface that provides for the positioning of a professional profile collection device, like that described in Step 1600, on a community portal website as demonstrated by element 800 in 0.

FIG. 41 and FIG. 42 is an invention application software and computer interface that provides for the operator to normalize professional profiles such as in Steps 2100 through 2150.

FIG. 43 is an invention application software and computer interface that provides for the operator to set parameters for wildcard characters used by the Normalizer Program.

FIG. 44 is an invention application software and computer interface that provides for the operator to input patterns and declare their types within the Normalizer

FIG. 45 is an invention application software and computer interface that provides for the operator to input tags and declare their pattern types and fields and declare distance to search from patter for a tag within the Normalizer Program.

FIG. 46 is an invention application software and computer interface that provides for the operator to input and declare field reporting order within the Normalizer Program.

FIG. 47 is a sample text document used to demonstrate the operation of the Normalizer Program during Steps 2100 through 2150 FIG. 4.

FIG. 48 is four postcards printed on one sheet before cutting.

### DETAILED DESCRIPTION

Our system can for convenience be thought of as involving two general parts: (1) compiling a data base of candidate contact information, and (2) using this data as the variable inputs in a mail merge to create a customized advertisement delivered to the specific candidate. We discuss each aspect in turn.

Compiling the Data Base of Candidate Contact Data

At Step 1000, professional profiles are collected and stored in a database. This may be done with ADAPT(T software by Bond International Software [472] for the purpose of importing, sorting, searching, retrieving reporting and exporting information on prospective contacts. Other database programs may be used. The invention is generally applied to advertise to end users of business product and potential employee recruits. Thus, the descriptions herein refer mostly to contact information based on professional profile data. Other forms of contact information related records, however, may be used. Data comprising professional profiles (e.g., resume or curriculum vitae data) are collected [1000] and stored in a data structure (or “database”).

Four professional profile collection strategies are describe d. One involves harvesting Personal Profiles from the Internet and is described in Steps 1200 through 1370. Another involves collecting contact data from third party sources such as data suppliers, resume collection website companies, etc., and is described in Steps 1400 through 1430. Another collection strategy involves collecting professional profiles via a collection program placed on websites such as community portals [800] and is described in Steps 1600 through 1640. Another collection strategy involves collecting professional profiles as a response to conventional help wanted advertising in such mediums as newspapers, trade journals, and Internet job posting websites and is described in Steps 1800 through 1850.

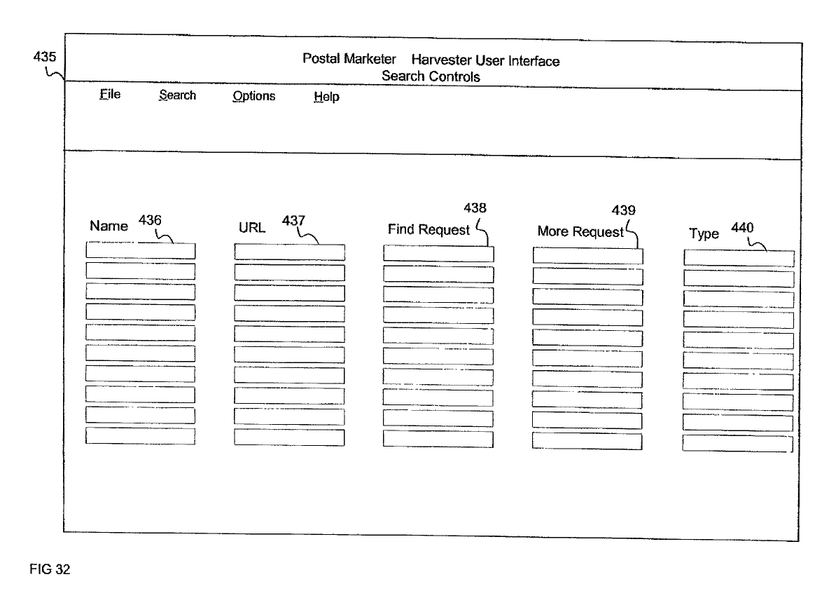

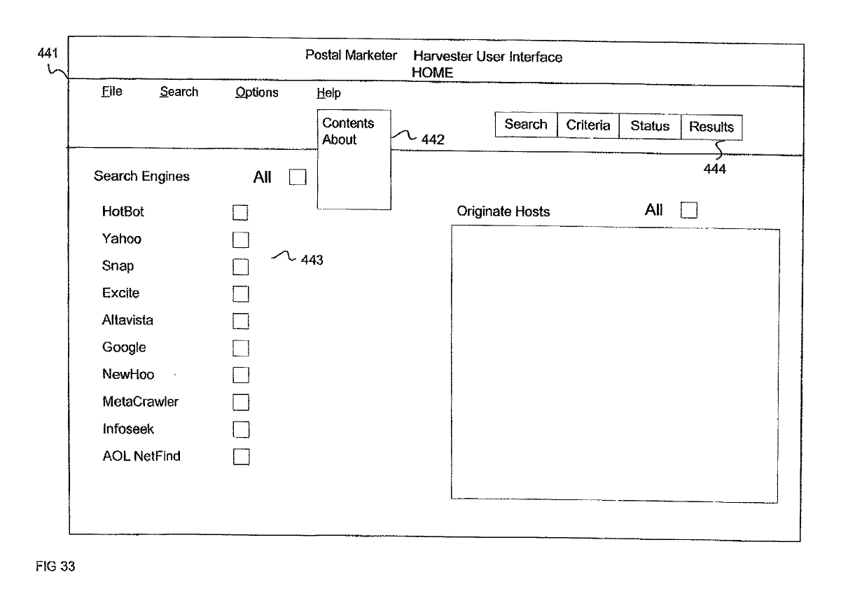

Professional profiles are harvested from websites on the Internet [1210-1370]. At Step 1210, the operator sets Search Engine Controls. See FIG. 32. The preferred embodiment of our invention provides for the “harvesting” of website page content based on three distinctly different searching algorithm strategies. They are numerical IP address, search engine results, and predetermined URL addresses. The embodiment of our invention which uses the search engine type strategy, requires that the operator preset search engine algorithms. Search engines are a specific category of Internet sites dedicated to categorizing and indexing the location of websites based on certain criteria specific to that search engine. For example Altavista, Excite, Go to, Hotbot, Infoseek, Look Smart, Lycos, Web Crawler, and Yahoo each have their own specific type of information which they catalog or categorize and method by which they report the matching sites URLs. In this step, the operator analyzes each desired search engine's search algorithm system and enters into the preferences/engines interface of our invention. The preferences/engines interface of our invention s rows divided by five columns. The preferences/engines interface, is ed on the computer monitor of the apparatus by a “dialog window”. The operator determines what data to enter into the rows based the criteria described in the following paragraphs.

For example, professional profiles may be are harvested [1200] from websites. Search Engine Controls are set [1210]. The operator enters [1215] the URL Search Criteria or IP Address Sequence or URL Set. The operator determines [1220] link-qualifying criteria. The operator determines [1225] page-qualifying criteria. If a relevant embellishment (URL Search Criteria method) of method is implemented, the operator determines [1230] Search Engines. The operator may determine URLs to ignore [1235], maximum total connections [1240], maximum connections per server [1245], connection time out [1250], data timeout [1255], the maximum results per Search Engine [1260], the largest pages to accept [1265], whether or not to search in Meta content of pages [1270], whether to search in body text of page [1275], whether to count level depth from source URL or from top domain [1280], number of levels from initial link to follow [1285], selects “Email Addresses” or “Pages as HTML” or “Pages as Text” [1290], determines whether a Proxy server is to be used [1295], determines User Agent Identification [1300],

User Interface Example

The entry “dialog window” has rows divided into five columns labeled. “Name”, “URL”, “Find Request”, “More Request” and “Type”. The “Name” column requires the entry of a “user friendly” name for the search engine or for the searches it is used for. The “URL” column requires the entry of an Internet address in the format of a URL (Universal Resource Locator). The address could be the URL for a search engine such as www.altavista.com or it can be a URL for sites that is not a search engine. The operator may specify not only the domain (e.g. www.altavista.com) but a particular subdirectory in it, e.g. wwww.altavista.com/Recreation.shtrnl for the Recreation directory of Altavista. A URL may point to any number of levels deep below the top domain, e.g.:

dir.altavista.com/Society/Politics/Political/Humor.shtml

for the Political Humor sub-section of the Altavista Search Engine. This enables our invention to target searches precisely. If the operator intends to use one and the same search engine for two or more direct searches to folders, they must be listed two or more times as separate search engines with their respective URLs, e.g. altavista.com/Recreation/Humor/shtml for travel-related searches in Altavista and dir.yahoo.com/Business_and_Economy (the Business directory of Yahoo).

The “Find Request” column requires the entry of the search engine's query algorithm with the Search Criteria keywords/word expressions replaced with “|s” (vertical slashes). E.g.:

http://www.euroseek.net/query?iflang=uk&query=|&domain=world&lang=world

for Euroseek. The operator can isolate the proper Find Request for an engine by opening the search engines home page in a browser such as Microsoft Internet Explorer4 and submitting a query (this will make the request available in the address field of the browser), then copying and pasting the content of browser's address field and replacing the query keywords with |s (vertical slashes).

The “More Request” column requires the entry of the corresponding search engine's More Request identifier, which is used to send a More Request to the search engine. The apparatus is setup to execute the three common types of More Request field entries depending on the type of the link executing the More Request on the page. They are text links, button links, and image links. For text-type links, the More Request field must contain the exact text of the link for buttons—the text on the button face, exactly as it appears even if it contains non-letter type characters, (e.g. Next >>); for images—the file name of the image together with its path (It can be retrieved from the HTML source of the page).

The “Type” drop-down list column requires the selection of a More Request type. The valid choices are “Link”, “Button”, “Image” and none (blank). Once a More Request has been entered, the Type selection is required.

Searching for Professional Profiles

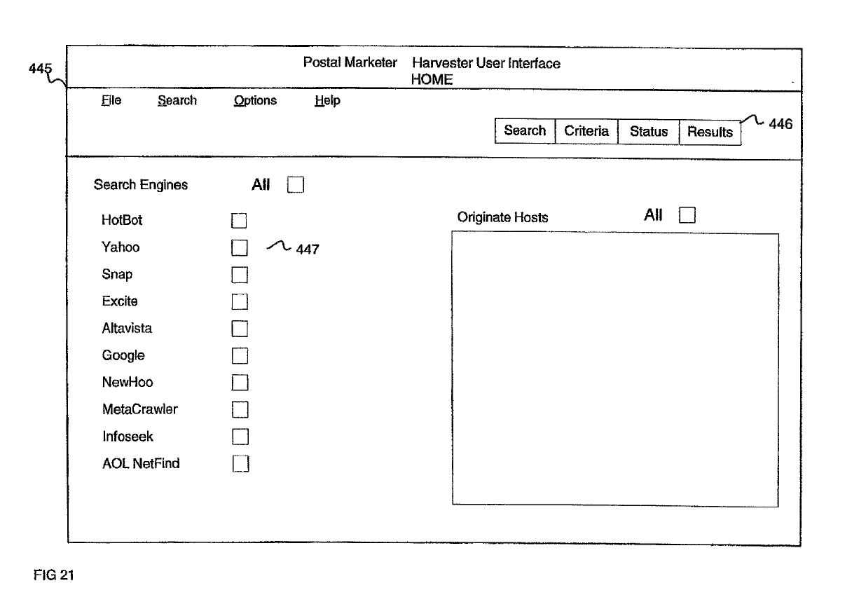

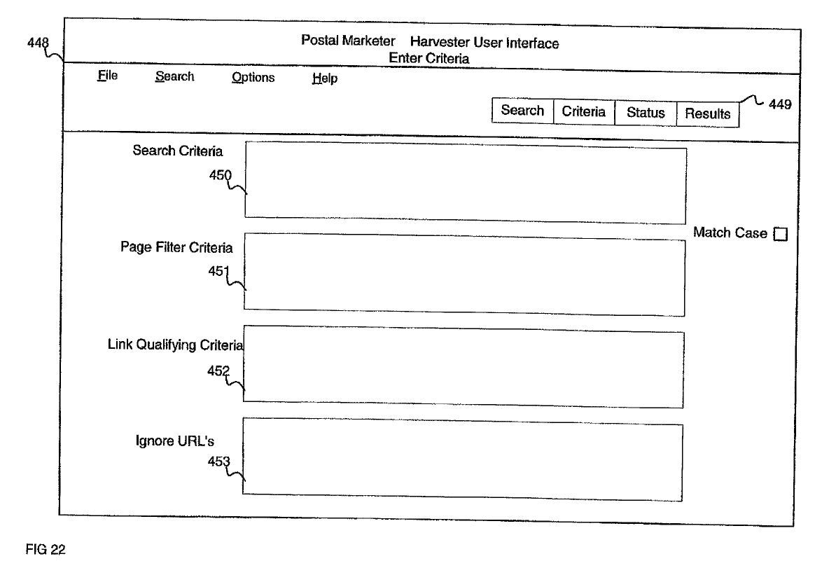

At Step 1215, operator determines URL Search Criteria or IP Address Sequence or URL Set. See FIG. 21 and FIG. 22. If the “search engine” type of collection strategy is to be used then search criteria must be entered into the criteria interface of our invention. In later steps, when the search operation is initiated, the apparatus shall use the entries into the search criteria field as a variable to substitute into the search algorithm for each search engine that was entered during Step 1210 into the search engine controls interface and more specifically each criteria will replace the variable described as a “vertical slash” in Step 1210. When our invention interfaces with the world wide web search engine Internet sites, the substitution of the search criteria variable into the search engine controls “find request” column algorithm will correctly instruct the search engine to return a specific set of results, those results being URL addresses of web sites which the search engine cataloged or categorized as related to the search criteria entered.

The operator then starts [1305] the search. The apparatus initiates contact [1310] with a search engine or specified URL. The apparatus reports status [1315]. The apparatus then reports the results [1320]. The apparatus downloads content [1325] and conducts comparisons. At Step 1330, the apparatus collects URL addresses contained in HTML statements commonly called “Hyperlinks” and generally referenced with the command suffix “HREF=” for only those visited website pages that match the link qualifying criteria entered during Step 1220.

At Step 1335, apparatus check for new URLs and then repeats steps starting with Step 1325 for the new URL. At Step 1340, if during Step 1290 “Email Addresses” was selected, then the apparatus collects and stores email addresses that are located in the text content of the downloaded page for only those visited website pages that match the page qualifying criteria entered during Step 1225. At Step 1345, if during Step 1290, “Pages as HTML” was selected, then the apparatus collects and stores the entire HTML code file of the downloaded page for only those visited website pages that match the page qualifying criteria entered during Step 1225.

At Step 1350, if during Step 1290, “Pages as Text” was selected, then the apparatus collects and stores the entire body text of the downloaded page for only those visited website pages that match the page qualifying criteria entered during Step 1225. At Step 1355, if “Pages as HTML or “Pages as Text” are selected in Step 1290, then each “matching” page is stored as a file onto a mass storage device, such as the hard drive, in a desirable format such as HTML or ASCII and contact information is “normalized.” At step 1360, normalized documents are imported into a database.

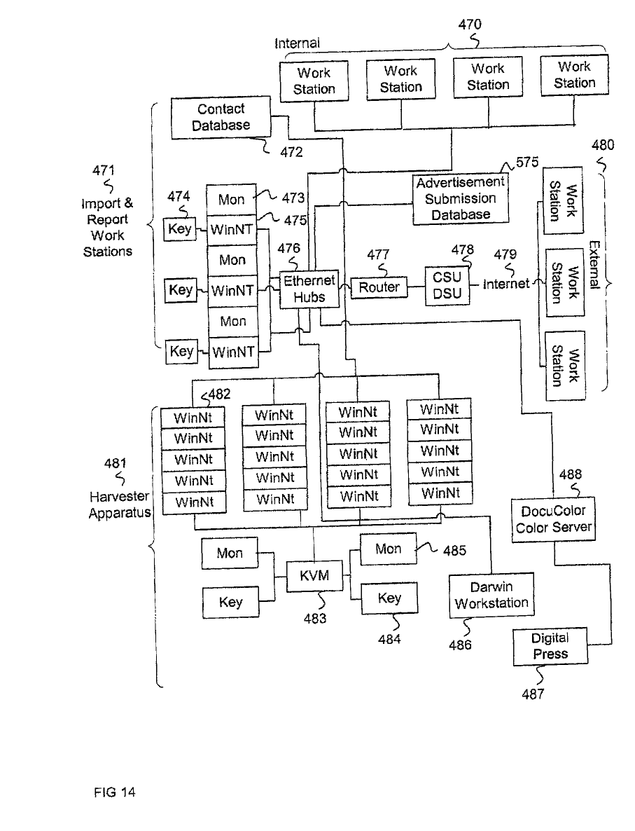

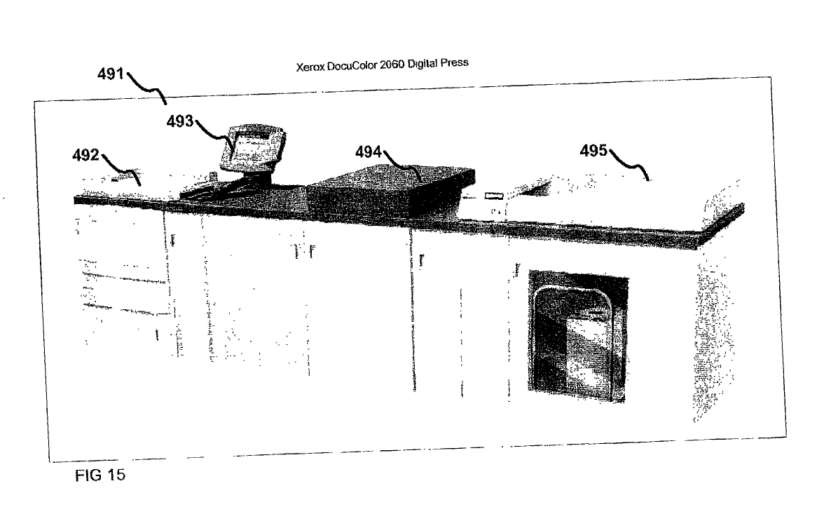

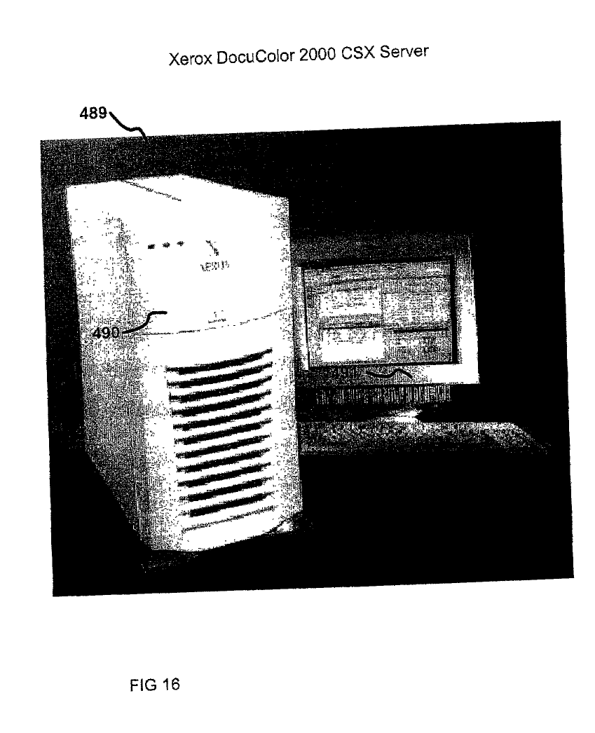

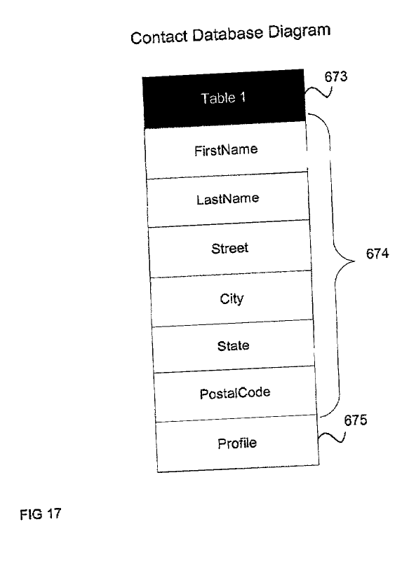

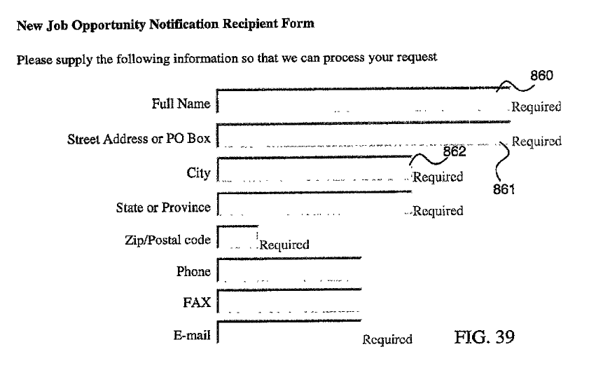

At Step 1365, the database is indexed. At Step 1370, the records are reported. At Step 1400, information on prospective contacts is collected and normalized At Step 1410, the operator defines, locates and acquires desirable collections of information on prospective contacts. At Step 1420, our invention normalizes data collected in Step 1410 to our invention's standards. At Step 1430, the system stores the information on prospective contacts that was normalized in Step 1420 into a computer storage device. At Step 1600, a professional profile Collection Device, in the form of a server software program, is placed on Internet community web portals such as demonstrated by element 800. Using the professional profile Collection Device, individual visitors to the Internet community web portals submit their resumes, curriculum vitae, professional profiles, job applications, biographies or other format in which a career biographies might exist using an interface such as that demonstrated in FIG. 39 and FIG. 39A so that they are ultimately stored in the Contact Database shown as Element 472 of FIG. 14 and shown in FIG. 17.

At Step 1610, the system searches for websites that could serve as professional profile collection points and contacts the operators of desirable sites and reaches an agreement to install and maintain a professional profile collection device, in the form of a server software program [800]. At Step 1620, the system installs and maintains a professional profile Collection Device, in the form of a server software program [800]. At Step 1630, professional profiles are submitted to professional profile Collection Devices posted on websites.

At Step 1640, the professional profiles arrive at collection point [472] where they are stored in the Contact Database element [472] in a computer storage device.

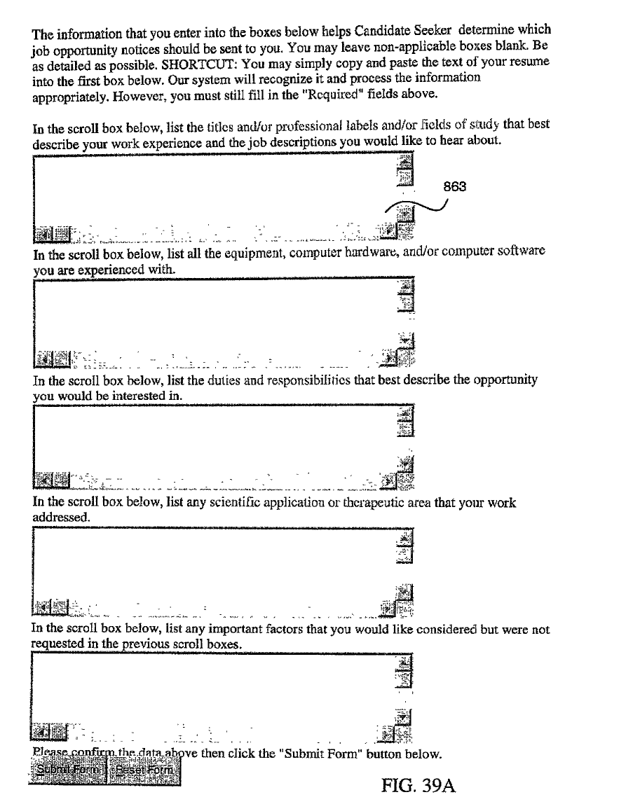

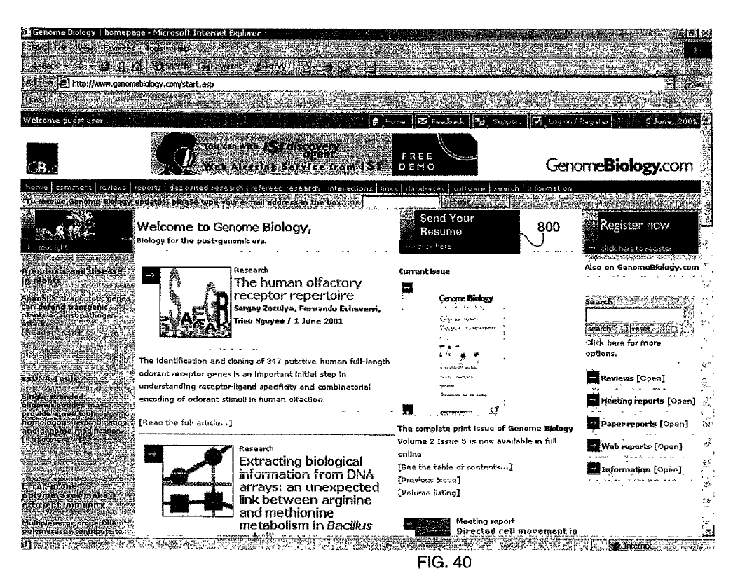

At Step 1800, advertisements are placed in traditional help wanted advertising media such as newspapers, magazines, job websites, and trade journals. Candidates respond to the advertisements as in FIG. 40, FIG. 39 and FIG. 39A or emailing their professional profiles, resumes, curriculum vitae, job applications, biographies or other format in which a career biographies might exist so that it they are ultimately stored in the Contact Database shown as Element 472 of FIG. 14 and shown in FIG. 17.

At Step 1810, the system determines the types of prospects that shall be needed for future advertising and what employment positions those types of contacts might hold. At Step 1820, the system places advertisements in traditional help wanted advertising media such as newspapers, magazines, job websites, and trade journals.

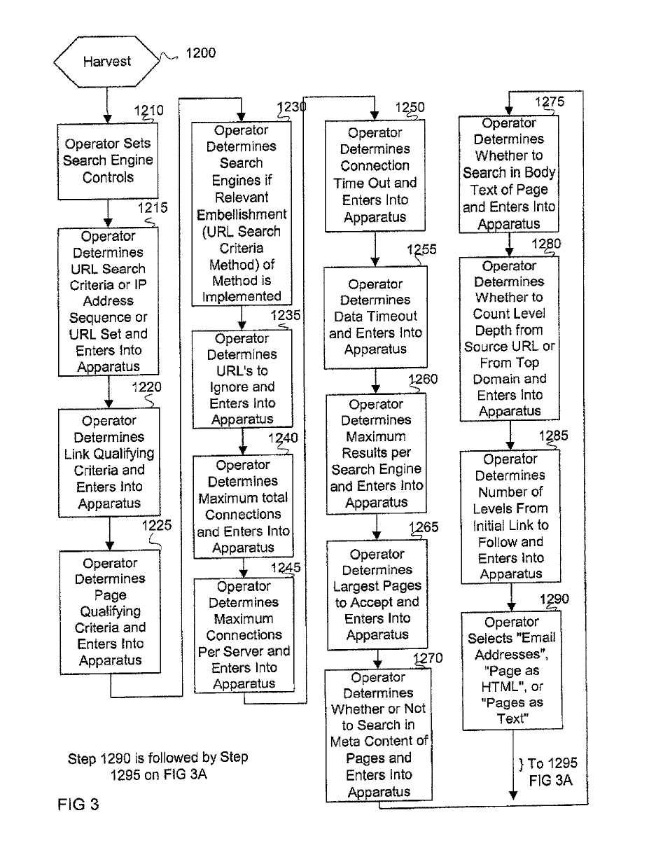

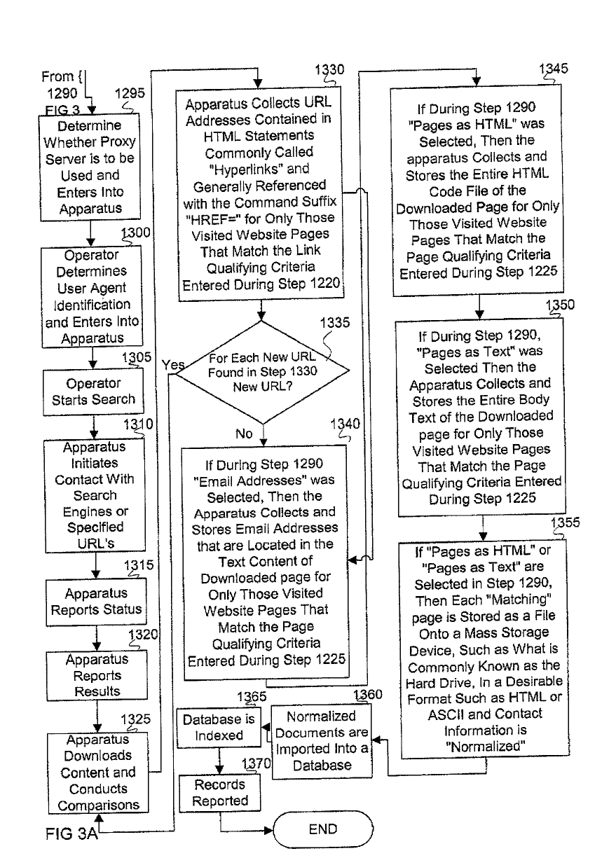

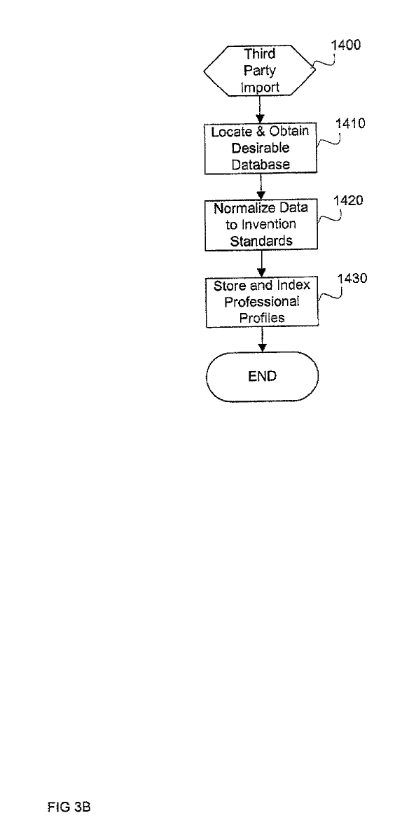

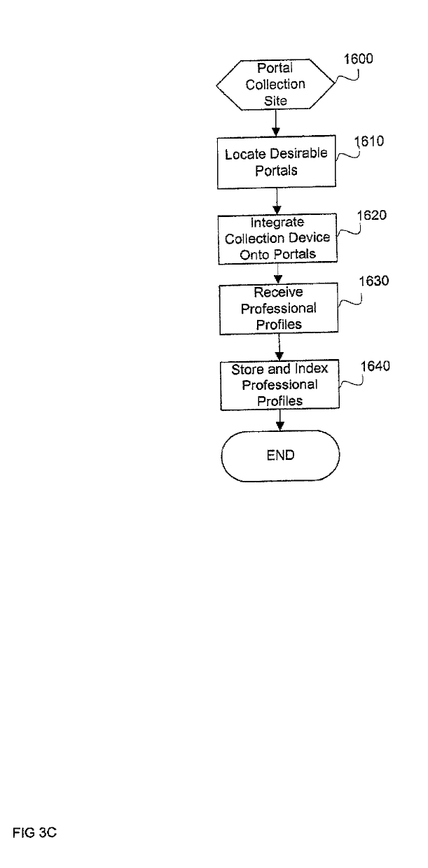

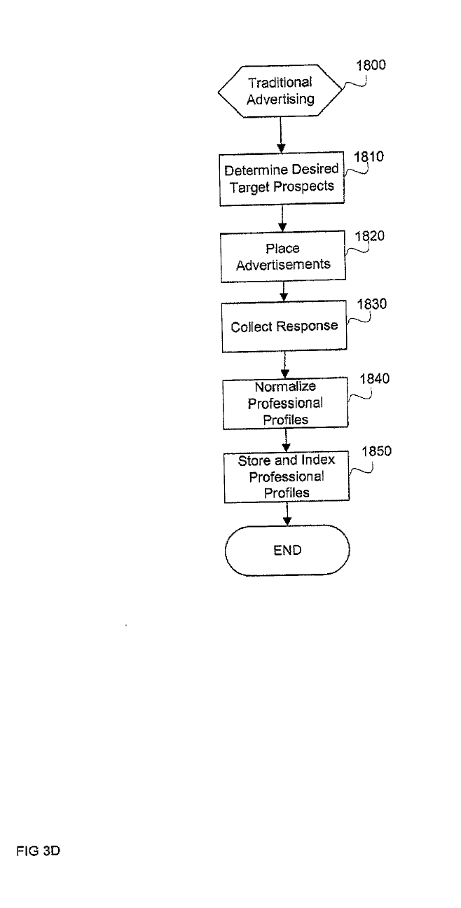

At Step 1830 FIG. 3D, Prospective Contacts respond to the advertisements placed in Step 1820 FIG. 3D by mailing, faxing, submitting via website such as in FIG. 40, FIG. 39 and FIG. 39A or emailing their professional profiles, resumes, curriculum vitae, job applications, biographies or other format in which a career biographies might exist and they are stored at a collection point element 471 of FIG. 14 until later steps when they are normalized and stored in the Contact Database [472].

At Step 1840, the system normalizes data collected in Step 1830 FIG. 3D to our invention's standards. At Step 1850 FIG. 3D, the system stores the information on prospective contacts that was normalized in Step 1840 FIG. 3D into a computer storage device [472].

Normalization

At Step 2000, the system “normalizes” the professional profiles data collected by our invention. “Normalizing” means converting and modifying data into a uniform format in preparation for importation into a database. In this specific case, our invention normalizes contact information such as Name, Street Address, City, State, Postal Code, Telephone Numbers and Email Address and our invention normalizes content information such as a prospective contact's practical, academic, and corporate experience. cover letters, forms or other communication indicating the prospective contact's preferences, objectives or goals; publications, documents; and testimonial or reference documentation. At Step 2010 the system chooses a method for normalizing professional profiles that is called “Semimanual” because it involves a large amount of operator intervention as compared to the “Automated” method described in Step 2100. The semiannual method takes place in Steps 1025 through 2055.

Semi-manual Normalization

A computer workstation [475] equipped with software capable of reading the file formats used by the general public to publish and deliver resumes and other forms of professional profiles opens [2015] the files collected in Steps 1000 through Steps 1999. The document is reviewed [2020] for special conditions, which are explained later in greater detail.

Relevant content information copy in the message window opened during Step 2015 is selected [2025]. The “paste special unformatted text” command of Microsoft Word® (or a similar command in another application) places [2030] the text into a file (we use one called Info_Coord_ResumeTemplate.dot). The document opened in Step 2015 is revisited [2035]. If it contains attachments, then the attachment is opened. If not, the document is closed and deleted. If a new document is opened during this step, then relevant content information copy in the message window opened during Step 2015 is selected [2025], and the procedure is continued on the newly-opened document.

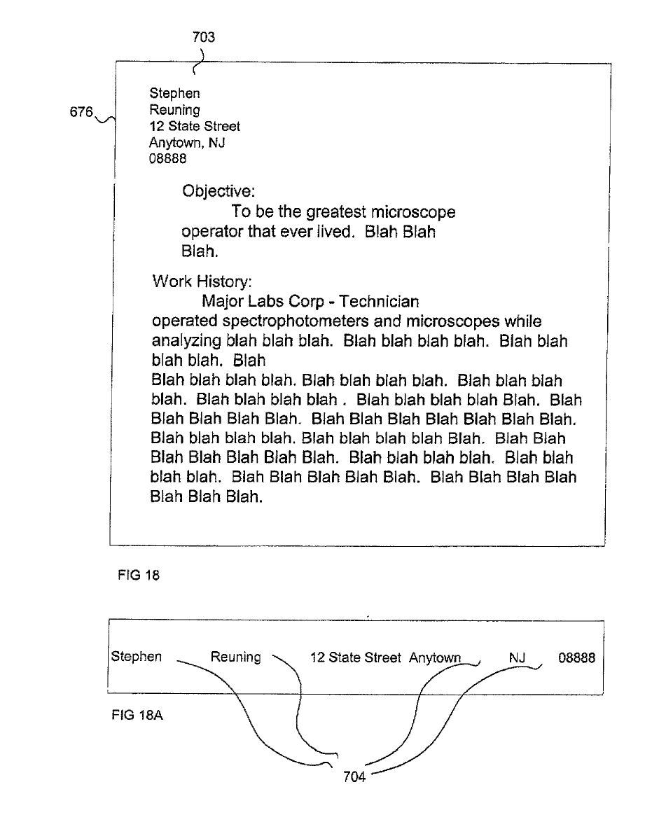

Headers or Footers are inspected [2040] for contact information. If yes, then the contact information is copied, then pasted as special unformatted text into Info_Coord_ResumeTemplate.dot. Advertisements and non-prospect related information are removed [2045]. Contact information is copied and pasted [2050] into the top left of the document in the standard delimited format, as in FIG. 18 and FIG. 18A. The normalized document is saved [2055] on a computer storage device where it awaits importation [3000].

Automated Normalization

At Step 2100, a method for normalizing professional profiles is selected that is called “Automated” because it involves a smaller amount of operator intervention as compared to the “Semimanual” method [2010-2055]. The automated method takes place in Steps 2100 through 2140.

Preferences and options are adjusted [2105] in the Normalizer Program. At Step 2110 the system uses a computer workstation [471] equipped with application software programmed to identify contact information by recognizing patterns and parsing character sets into data fields (we refer to this kind of software as a “Normalizer Program”) and, using an interface, selects a directory on a computer storage device from which to import and normalize files.

A file of the directory submitted [2110] is opened [2115] and postal codes are identified and, for each matching set of characters, are stored in a data structure (e.g., as a table or array) in the postal code field. A string of characters denoting a state or province is identified [2120] and stored in the data structure in the State field, in the row that corresponds to the Postal Code.

A string of characters denoting a city or town and is identified [2122] and stored in the data structure in the column reserved for City in the row that corresponds to the State and Postal Code. A string of characters denoting a street address is identified [2125] and stored in the data structure in the column reserved for Street.

A string of characters denoting a last name is identified [2130] and stored in a table or array in memory in the column reserved for Last Name in the row that corresponds to the Street Address, City and State or Province and Postal Code following directly and located and stored in Steps 2115, 2120, 2122 and 2125. A string of characters denoting a first name is identified and stored in a table or array in memory in the column reserved for First Name in the row that corresponds to the Street Address, City and State or Province and Postal Code following directly and located and stored in Steps 2115, 2120, 2122 and 2125.

Step 2135 is preparing to store the file with the data saved in a table or array in memory [2115-2130] with the delimiter selected [812] between each data field such that the file would display in a computer text window as shown in FIG. 18 if the delimiter character were a Return character or as shown in FIG. 18A if the delimiter character was a Tab character.

At Step 2140, stores the file on a computer storage device, with the delimiter selected [812] between each data field such that the file would display in a computer text window as shown in FIG. 18 if the delimiter character were a Return character or, as shown in FIG. 18A, if the delimiter character was a Tab character.

Merging the Normalized Data

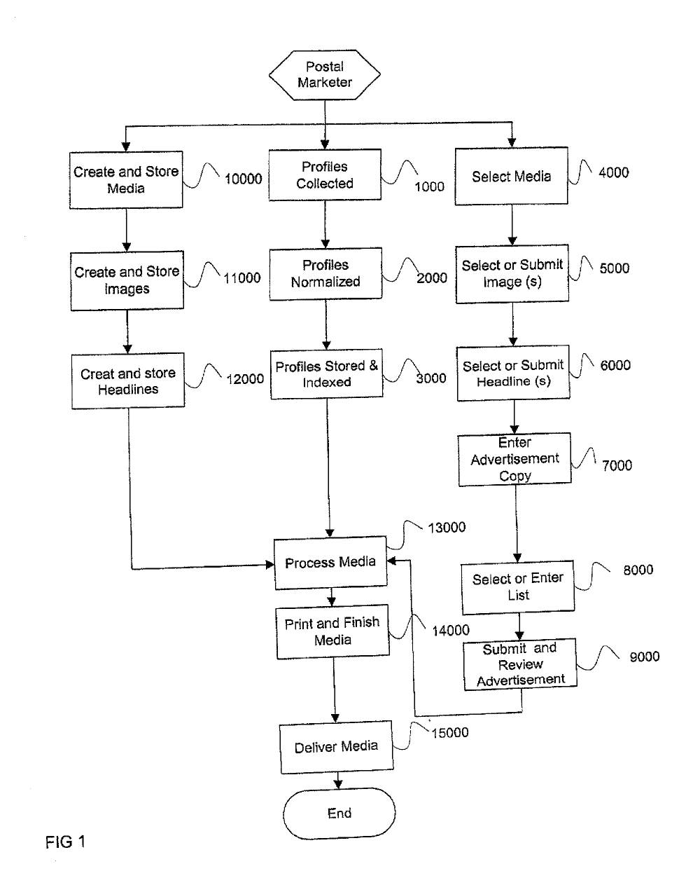

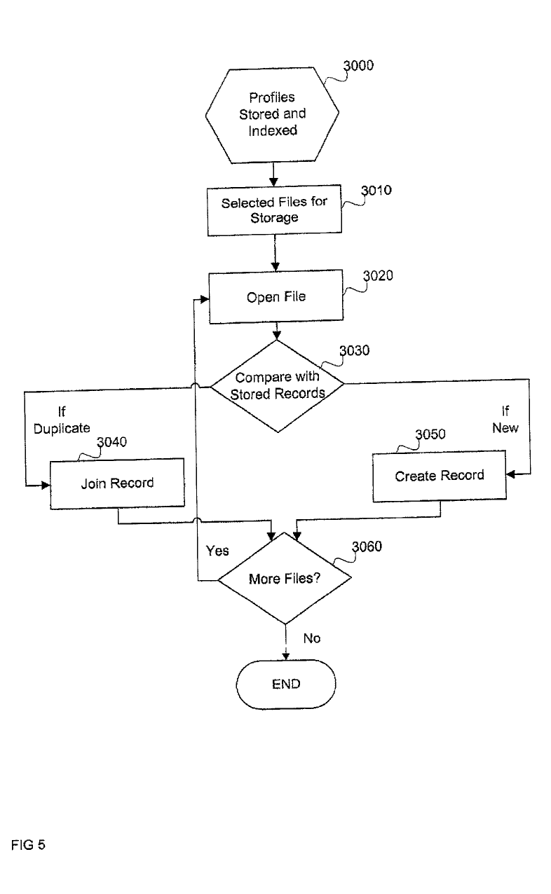

At Step 3000 FIG. 1 and FIG. 5, the system imports the files saved in Step 2140 into the Contact Database element 472 FIG. 14. At Step 3010 FIG. 5, the system selects documents saved in Step 2140 from a directory on a network or computer storage device. At Step 3020 FIG. 5, the system opens a file selected during Step 3010 FIG. 5. At Step 3030 FIG. 5, the system compares contact information from the file opened in Step 3020 FIG. 5 with contact information of records already stored in into the Contact Database element 472 FIG. 14 and decides if it duplicates an already stored prospective contact record. If the record is a duplicate then our invention proceeds to Step 3040 FIG. 5 if the record is not a duplicate then our invention proceeds to Step 3050 FIG. 5.

At Step 3040 FIG. 5, the system joins information from a file selected during Step 3010 FIG. 5 with a record stored in the Contact Database element 472 FIG. 14. At Step 3050 FIG. 5, the system creates a new record for a file selected during Step 3010 FIG. 5 in the Contact Database element 472 FIG. 14 and imports the information from a file selected during Step 3010 FIG. 5.

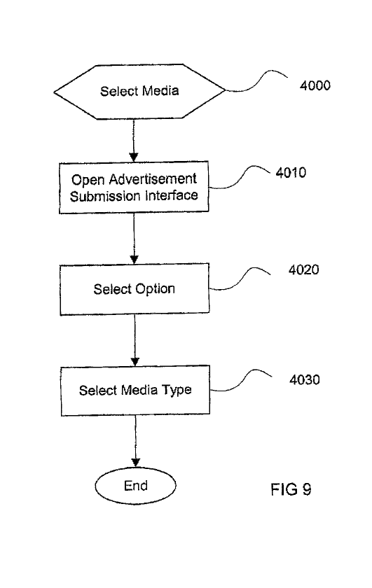

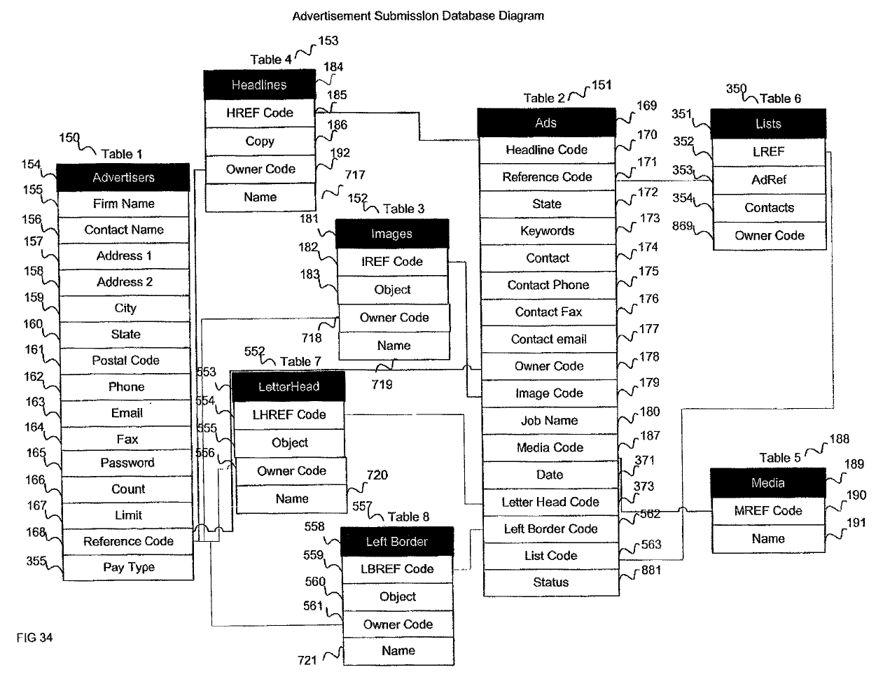

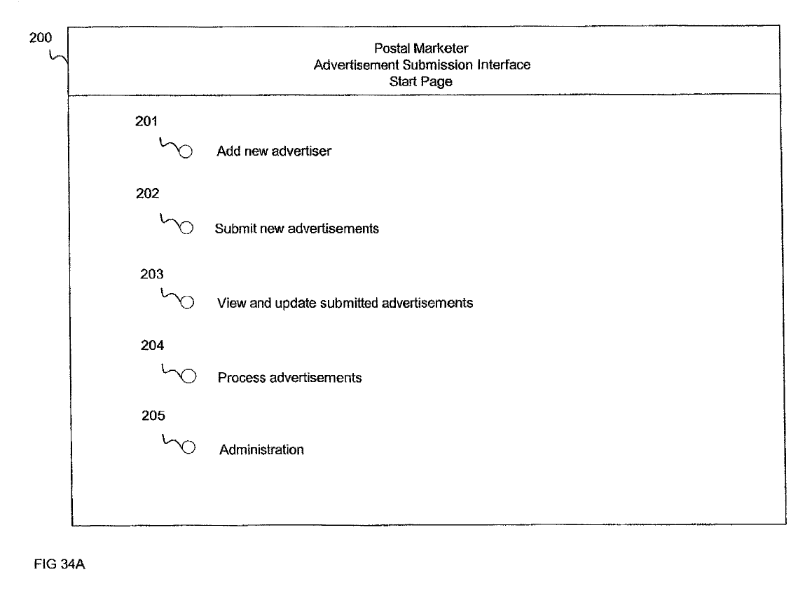

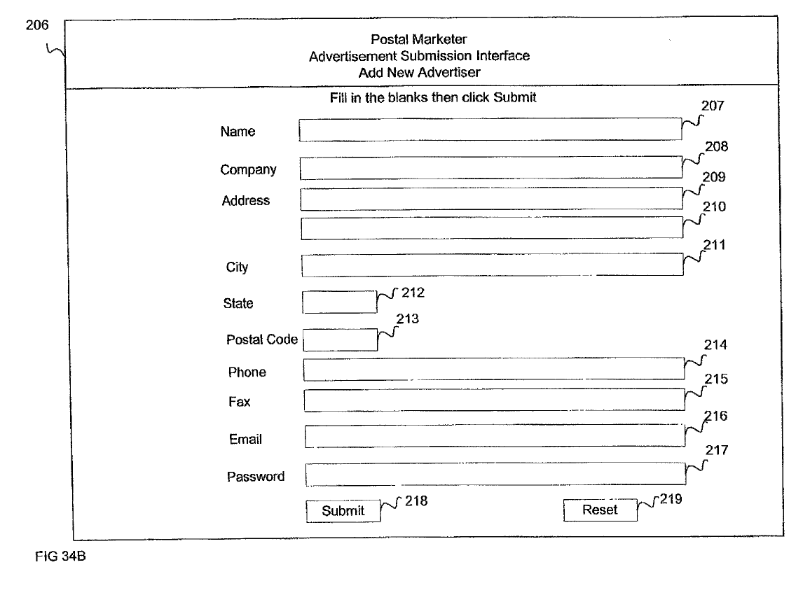

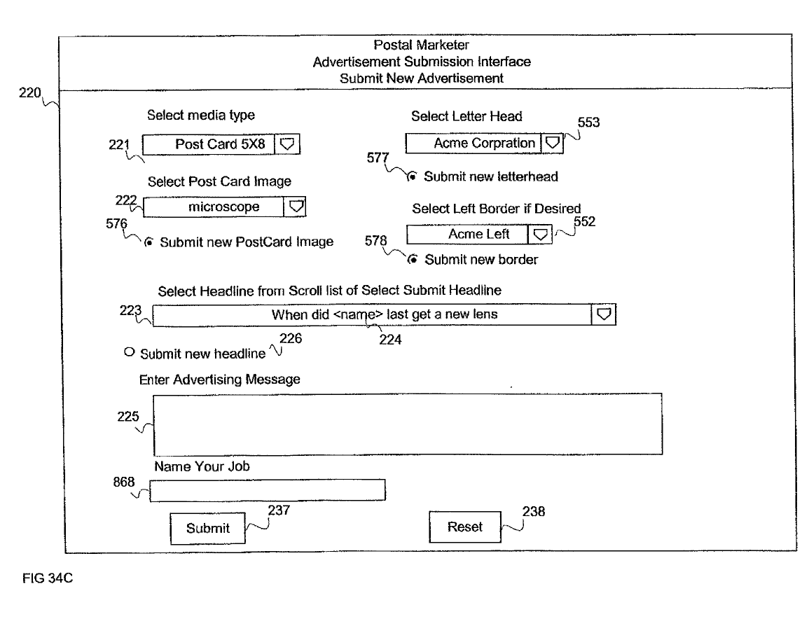

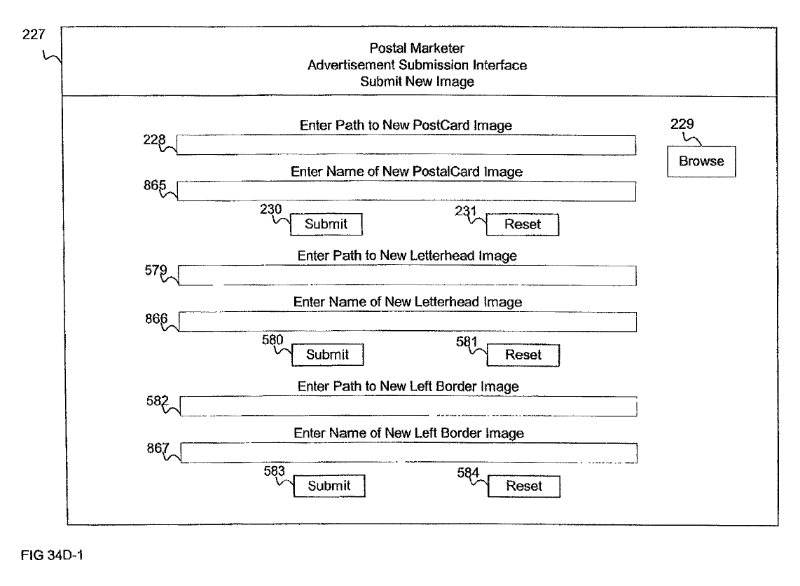

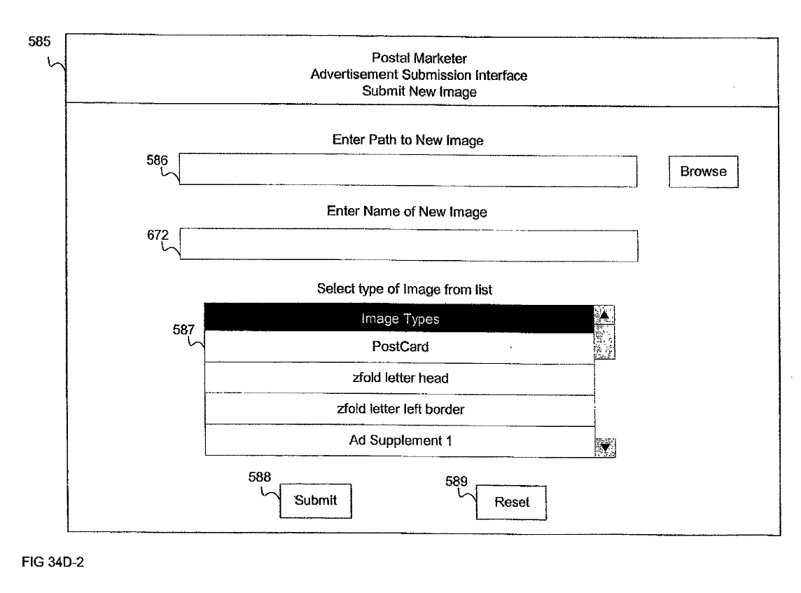

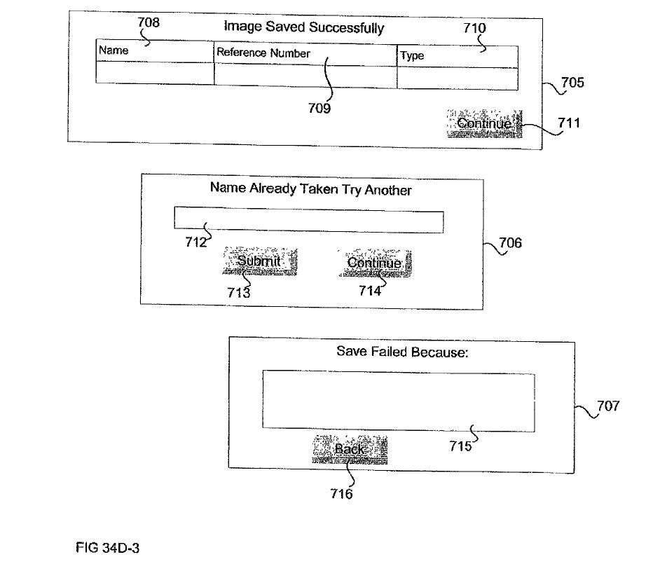

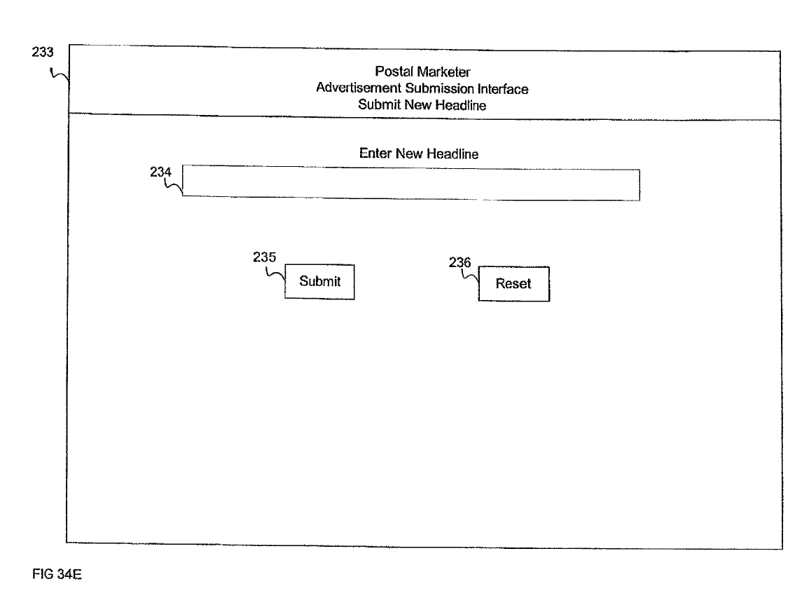

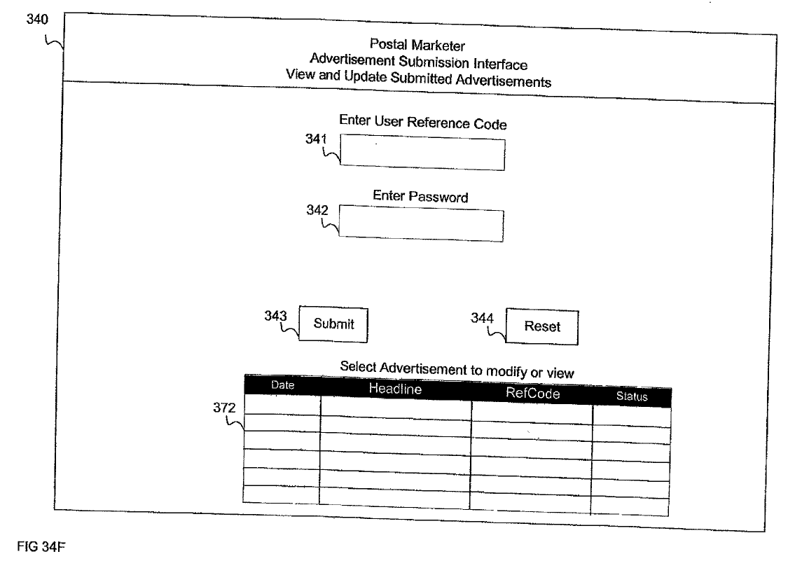

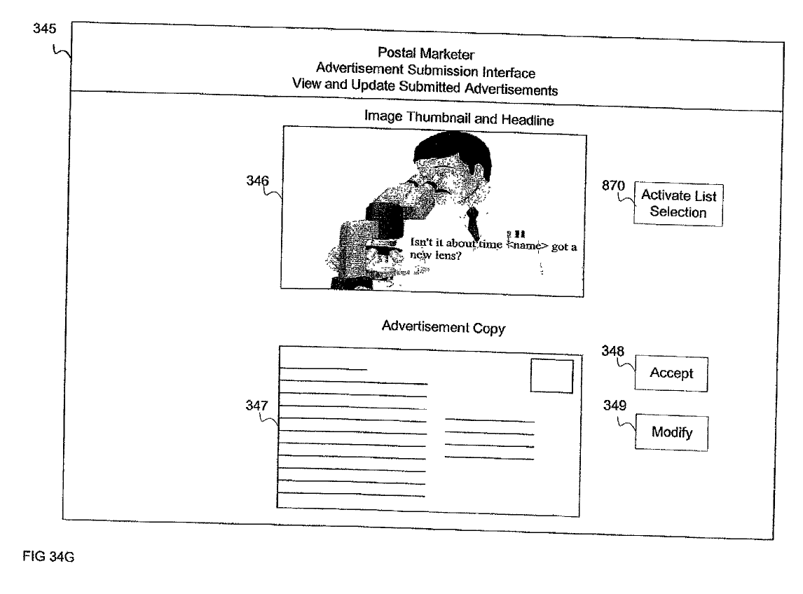

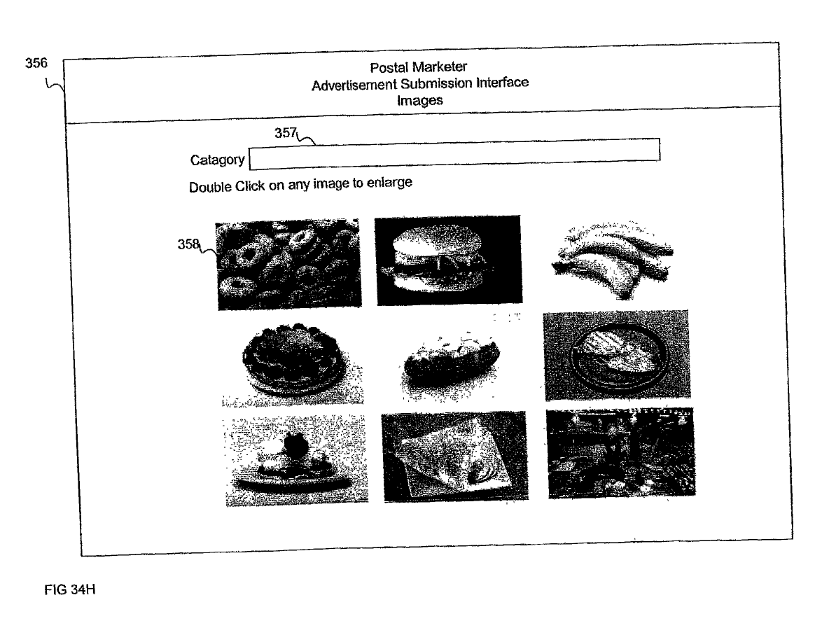

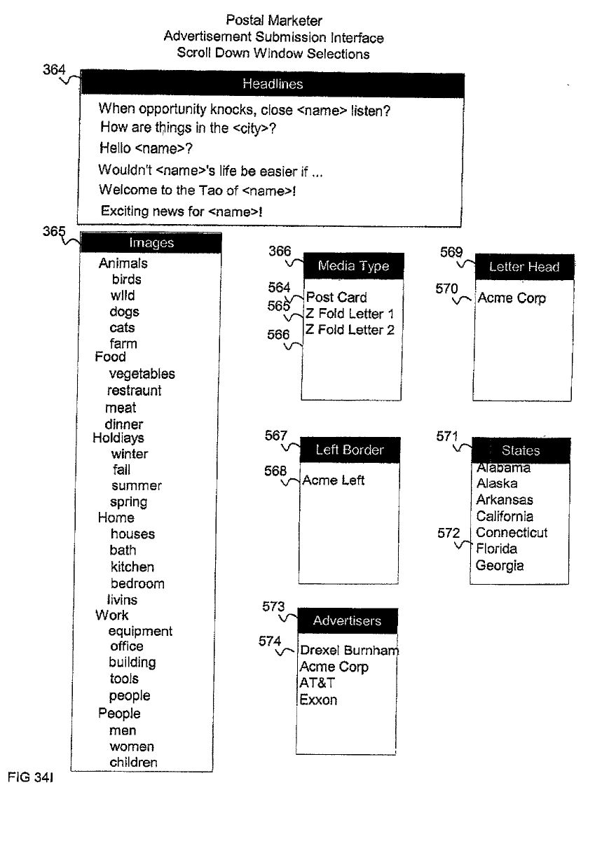

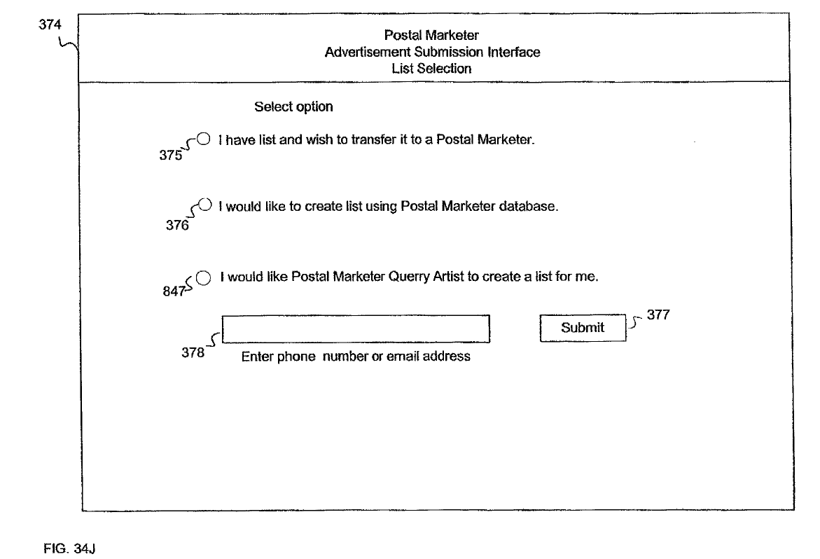

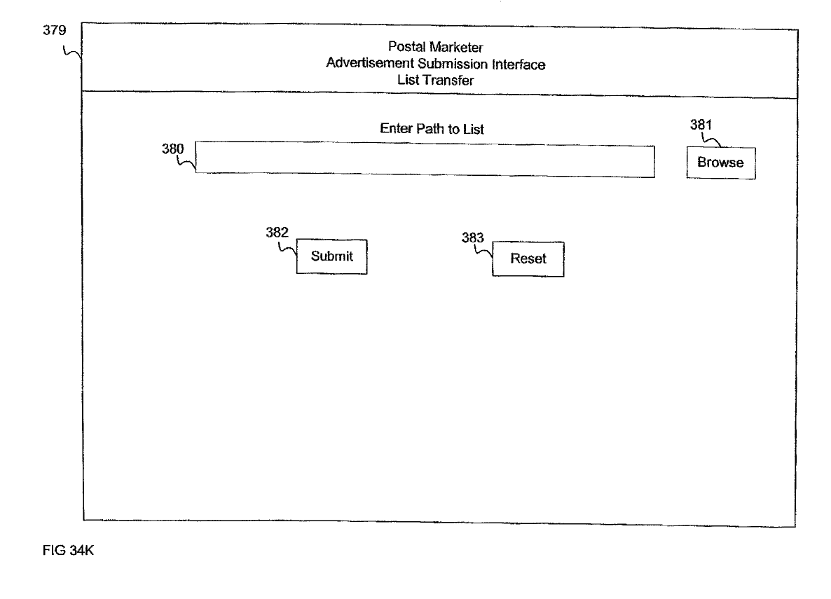

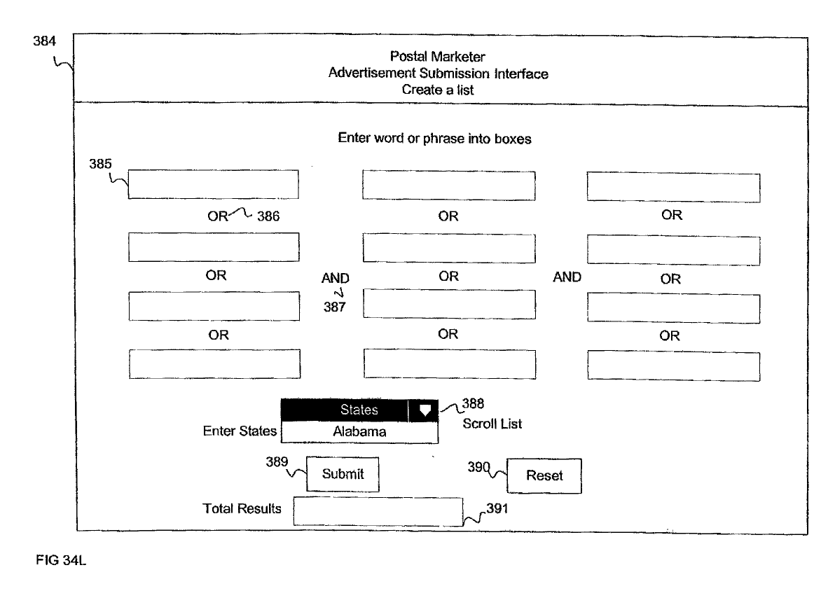

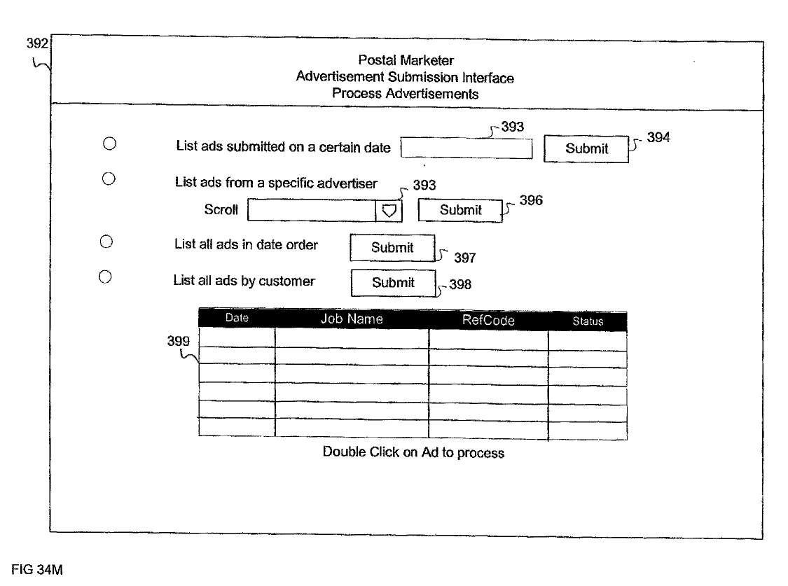

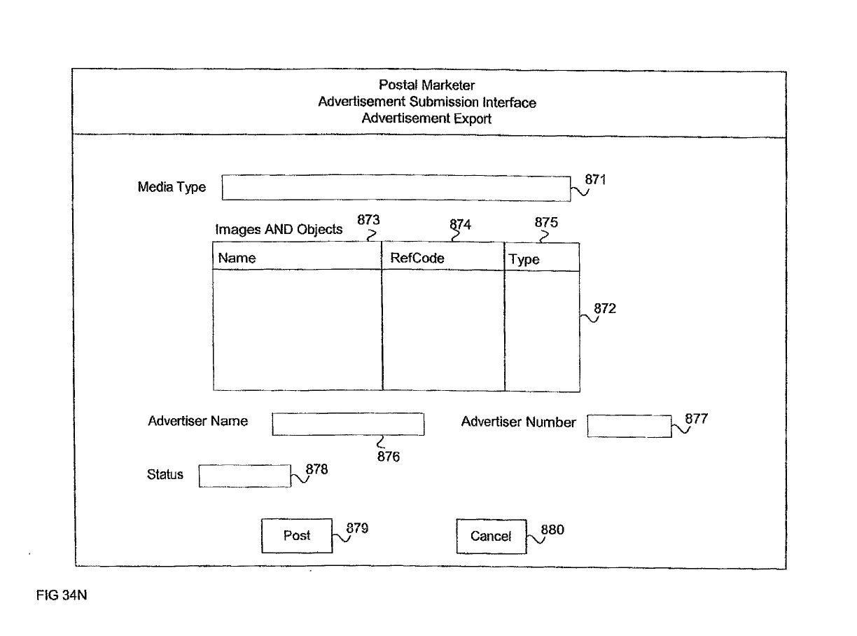

At Step 3060 FIG. 5, the system checks for files not yet processed in Steps 3020 through 3050 that were selected in Step 3100 FIG. 5 and executes Steps 3020 through 3050 each not yet processed file. At Step 4000 FIG. 1 and FIG. 9, the system enters new advertisers into Advertisement Submission Program database located at element 575 FIG. 14 using a computer software user interface such as that demonstrated in FIGS. 34A and 34B and, or in the case of previously entered advertisers, then selects a media type for processing in later steps based on input by an advertiser. At Step 4010 FIG. 9, an advertiser of the system starts the Advertisement Submission Interface located at element 575 FIG. 14 and demonstrated by FIG. 34A. At Step 4020 FIG. 9, an advertiser of the system selects an option from the Advertisement Submission Interface Start Page located at element 575 FIG. 14 and demonstrated by FIG. 34A.

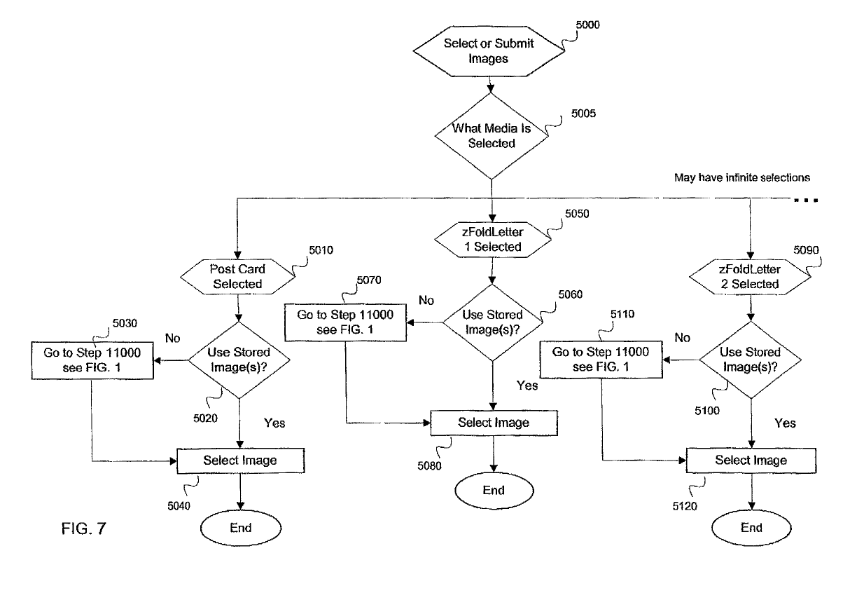

At Step 4030 FIG. 9, an advertiser of the system selects a media type element 221 FIG. 34C from an Advertisement Submission Program Interface Submit New Advertisement page located at element 575 FIG. 14 and demonstrated by FIG. 34C. At Step 5000 FIG. 1 and FIG. 7, the system provides image selections based on the media type selected in Step 4030 for which an advertiser inputs a selection using element 222, and/or 553 and/or 552 FIG. 34C from an Advertisement Submission Program Interface Submit New Advertisement page located at element 575 FIG. 14 and demonstrated by FIG. 34C. At Step 5005 FIG. 7, the system Advertisement Submission Program determines, based on the media type selection made by the advertiser in Step 4030 FIG. 9, which set of steps to follow.

At Step 5010 FIG. 7, the system Advertisement Submission Program, based on the media type selection made by the advertiser in Step 4030 FIG. 9 and the advertiser's user ID, displays a selection of image titles in an Advertisement Submission Program Submit New Advertisement interface FIG. 34c at element 222 Select Post Card Image. At Step 5020 FIG. 7, the advertiser of the system Advertisement Submission Program decides to use images already stored in an Advertisement Submission Program database or to submit a new image and indicates selection by selecting element 222 or element 576 of FIG. 34C.

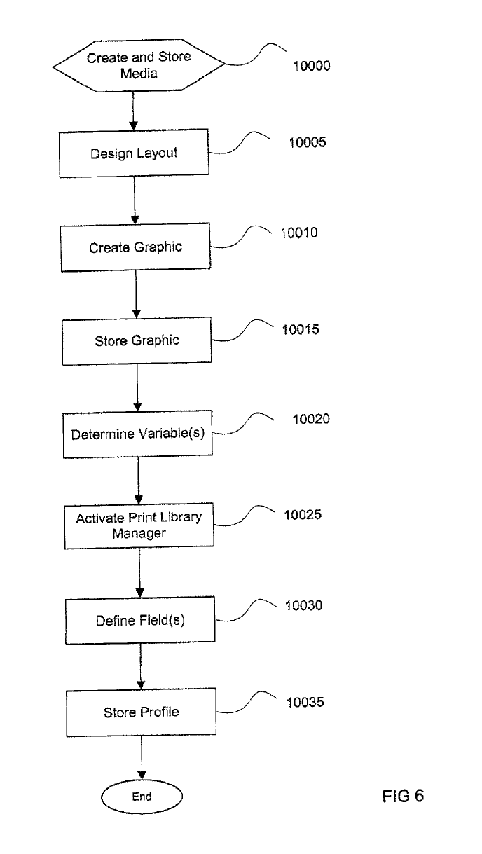

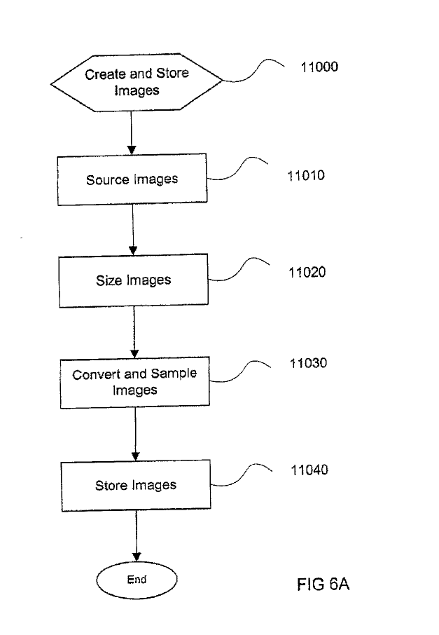

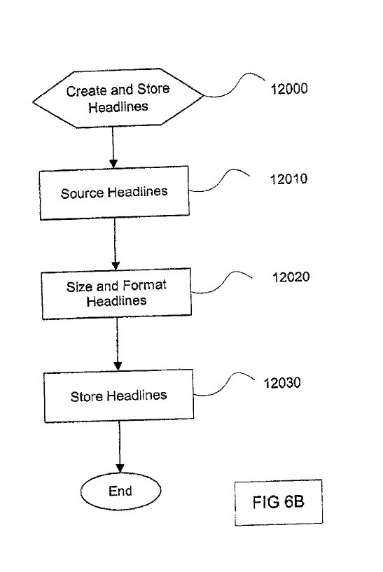

At Step 5030 FIG. 7, the advertiser of the system Advertisement Submission Program proceed to Step 11000 FIG. 1 and FIG. 6A if advertiser chose “Submit New Post Card Image” element 576 FIG. 34C during Step 5020. At Step 5040 FIG. 7, the advertiser of the system Advertisement Submission Program selects an image from an Advertisement Submission Program database. At Step 5050 FIG. 7, the system Advertisement Submission Program, based on the media type selection made by the advertiser in Step 4030 FIG. 9 and the advertiser's user ID, displays a selection of image titles in an Advertisement Submission Program Submit New Advertisement interface FIG. 34c at element 553 Select Letter Head.

At Step 5060 FIG. 7, the advertiser of the system Advertisement Submission Program decides to use images already stored in an Advertisement Submission Program database or to submit a new image and indicates selection by selecting element 553 or element 577 of FIG. 34C. At Step 5070 FIG. 7, the advertiser of the system Advertisement Submission Program proceed to Step 11000 FIG. 1 and FIG. 6A if advertiser chose “Submit New Letter Head” element 577 FIG. 34C during Step 5060. At Step 5080 FIG. 7, the advertiser of the system Advertisement Submission Program selects an image from an Advertisement Submission Program database.

At Step 5090 FIG. 7, the system Advertisement Submission Program, based on the media type selection made by the advertiser in Step 4030 FIG. 9 and the advertiser's user ID, displays a selection of image titles in an Advertisement Submission Program Submit New Advertisement interface FIG. 34c at element 553 Select Letter Head and/or element 552 Select Left Border if Desired. At Step 5100 FIG. 7, the advertiser of the system Advertisement Submission Program decides to use images already stored in an Advertisement Submission Program database or to submit a new image and indicates selection by selecting element 553 or element 577 of FIG. 34C and element 552 or element 578 of FIG. 34C.

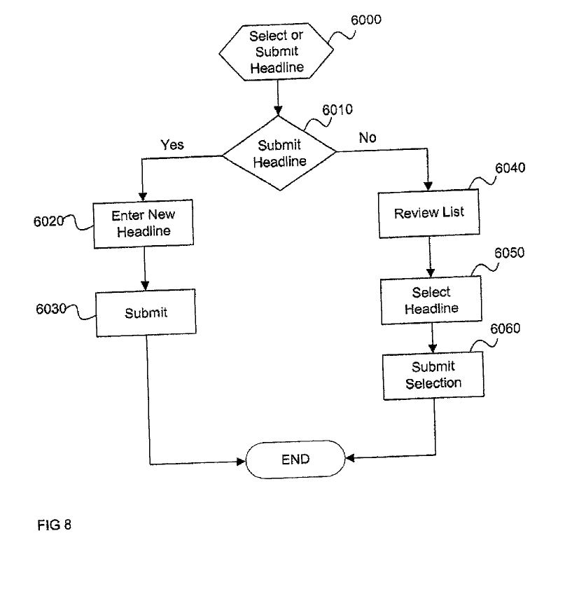

At Step 5110 FIG. 7, the advertiser of the system Advertisement Submission Program proceed to Step 11000 FIG. 1 and FIG. 6A if advertiser chose “Submit New Letter Head” element 577 FIG. 34C during Step 5100 or “Submit New Border” element 578 FIG. 34C during Step 5100. At Step 5120 FIG. 7, the advertiser of the system Advertisement Submission Program selects an image from an Advertisement Submission Program database. At Step 6000 FIG. 1 and FIG. 8, the system provides headline selections based on the media type selected in Step 4030 FIG. 9 for which an advertiser inputs a selection using element 223 FIG. 34C from an Advertisement Submission Program Interface Submit New Advertisement page located at element 575 FIG. 14 and demonstrated by FIG. 34C and the choice to enter a new headline by selecting element 226 FIG. 34C.

At Step 6010 FIG. 8, the advertiser of the system Advertisement Submission Program decides to use headlines already stored in an Advertisement Submission Program database or to submit a new headline and indicates selection by selecting element 223 or element 226 of FIG. 34C. At Step 6020 FIG. 8, the advertiser of the system uses an Advertisement Submission Program Submit New Headline interface FIG. 34E to enter a new headline element 234 FIG. 34E.

At Step 6030 FIG. 8, the advertiser of the system stores the headline entered in Step 6020 FIG. 8 in the Advertisement Submission Database FIG. 34 by clicking the Submit button on an Advertisement Submission Program Submit New Headline interface FIG. 34E. At Step 6040 FIG. 8, the advertiser of the system reviews the list of headlines available by scrolling the list in at element 223 of FIG. 34C of an Advertisement Submission Program Submit New Advertisement page FIG. 34C At Step 6050 FIG. 8, the advertiser of the system selects a headline from the list of headlines available by scrolling the list in at element 223 of FIG. 34C of an Advertisement Submission Program Submit New Advertisement page FIG. 34C by clicking on it so that it is highlighted At Step 6060 FIG. 8, the advertiser submits the selections made at an Advertisement Submission Program Submit New Advertisement page FIG. 34C by clicking on the Submit button element 237 and stores them in the Advertisement Submission Database FIG. 34.

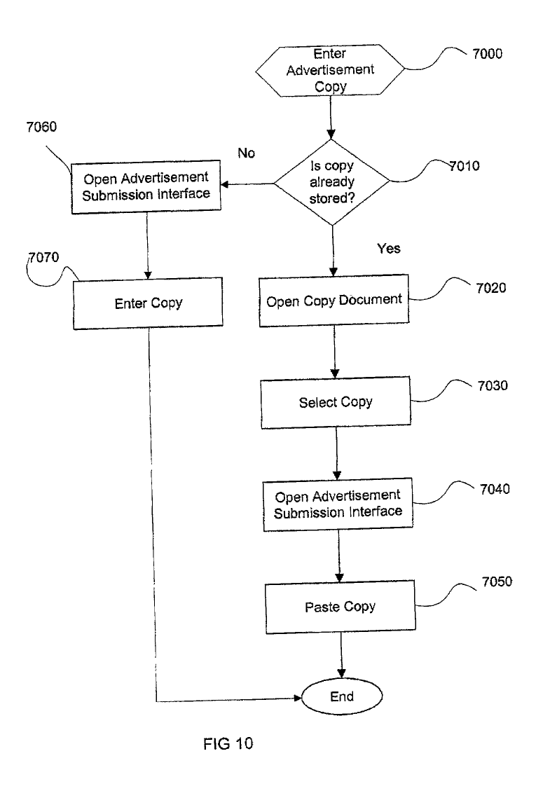

At Step 7000 FIG. 1 and FIG. 10, the advertiser of the system enters advertising copy into an Advertisement Submission Program Submit New Advertisement page FIG. 34C by typing it in directly or copying and pasting it from an already created document At Step 7010 FIG. 10, the advertiser of the system decides whether to copy and paste advertisement copy from an already created document or type the advertisement copy directly into the interface and based on that choice proceeds to Step 7060 or Step 7020 accordingly. At Step 7020 FIG. 10, if the advertiser of the system chose to copy and paste advertisement copy from an already created document in Step 7010 then open the document file in which the advertisement copy is stored.

At Step 7030 FIG. 10, if the advertiser of the system chose to copy and paste advertisement copy from an already created document in Step 7010 then select and copy the advertisement text from the document opened in Step 7020 FIG. 10. At Step 7040 FIG. 10, if the advertiser of the system chose to copy and paste advertisement copy from an already created document in Step 7010 then open an Advertisement Submission Program Submit New Advertisement interface page FIG. 34C. At Step 7050 FIG. 10, the advertiser of the system pastes the advertisement copy copied in Step 7030 FIG. 10 into element 225 FIG. 34C of an Advertisement Submission Program Submit New Advertisement interface page.

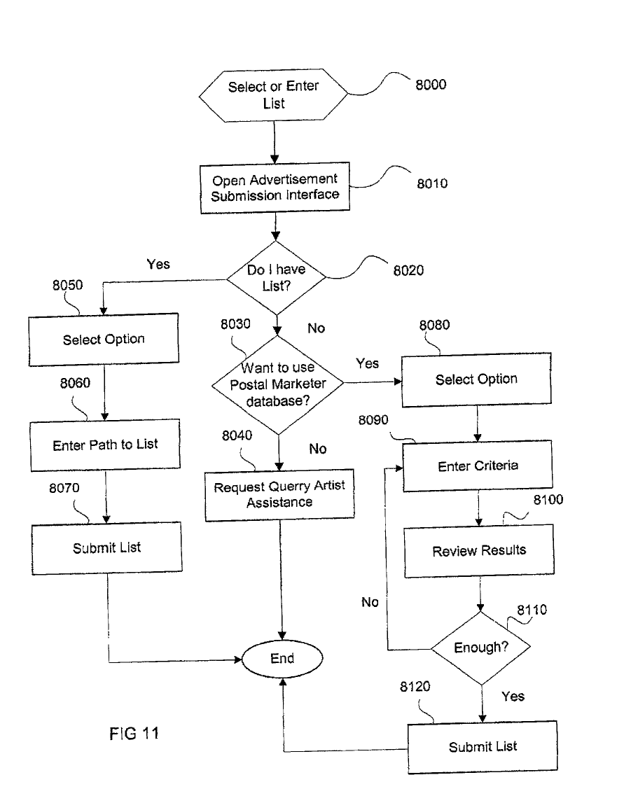

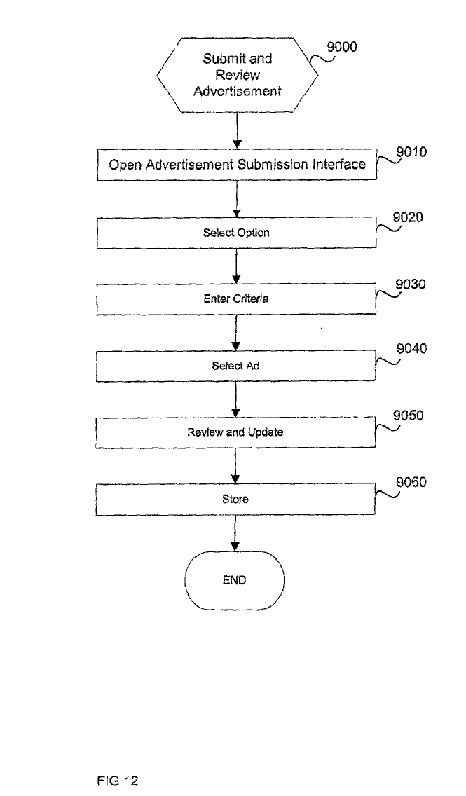

At Step 7060 FIG. 10, the advertiser of the system opens an Advertisement Submission Program Submit New Advertisement interface page FIG. 34C. At Step 7070 FIG. 10, the advertiser of the system types advertisement copy into element 225 FIG. 34C of an Advertisement Submission Program Submit New Advertisement interface page. At Step 8000 FIG. 1 and FIG. 11, the advertiser of the system submits a list of prospects from a source other than our invention's Contact Database and submits that list to be merged with the advertisement copy and selected images into the selected media type OR requests the help of an experienced Query Artist who will later search for a list of prospects from the Contact Database element 472 FIG. 14 submits that list to be merged with the advertisement copy and selected images into the selected media type OR searches for a list of prospects from the Contact Database element 472 FIG. 14 and submits that list to be merged with the advertisement copy and selected images into the selected media type.

At Step 8010 FIG. 11, the advertiser of the system opens an Advertisement Submission Program List Selection Interface FIG. 34J. At Step 8020 FIG. 11, the advertiser of the system proceeds to Step 8050 FIG. 11 if the advertiser decided to enter a list of prospects from a source other than our invention's Contact Database or proceeds to Step 8030 FIG. 11. At Step 8030 FIG. 11, the advertiser of the system proceeds to Step 8040 FIG. 11 if the advertiser decided to seek the help of an experienced Query Artist to search our invention's Contact Database or proceeds to Step 8080 FIG. 11 if the advertiser decided to search for a list of prospects from the Contact Database element 472 FIG. 14 and submit that list to be merged with the advertisement copy and selected images into the selected media type.

At Step 8040 FIG. 11, the advertiser of the system highlights the radio button element 847 FIG. 34J and clicks the Submit button element 377 FIG. 34J. At Step 8050 FIG. 11, the advertiser of the system highlights the radio button element 375 FIG. 34J and clicks the Submit button element 377 FIG. 34J which action opens an Advertisement Submission Program List Transfer interface FIG. 34K. At Step 8060 FIG. 11, the advertiser of the system enters the network path to the storage location of the file containing a pre-prepared contact list into an Advertisement Submission Program List Transfer interface element 380 FIG. 34K. At Step 8070 FIG. 11, the advertiser of the system submits the list which path was entered in Step 8060 FIG. 11 into the Advertisement Submission Database FIG. 34 by clicking the Submit button element 382 FIG. 34K.

At Step 8080 FIG. 11, the advertiser of the system highlights the radio button element 376 FIG. 34J and clicks the Submit button element 377 FIG. 34J which action opens an Advertisement Submission Program Create a List interface FIG. 34L. At Step 8090 FIG. 11, the advertiser of the system enters search criteria into the fields, demonstrated by element 385 FIG. 34L, of an Advertisement Submission Program Create a List interface FIG. 34L and click the Submit button element 389 FIG. 34L. At Step 8100 FIG. 11, the system displays the total number of matches at element 391 FIG. 34L At Step 8110 FIG. 11, the advertiser of the system reviews the number of matches displayed at element 391 FIG. 34L and decides whether the list should be expanded or narrowed. If list is acceptable “as is” then the advertiser proceeds to Step is 8120 if not, then the advertiser proceeds to Step 8090 in order to run search again using expanding or narrowing criteria.

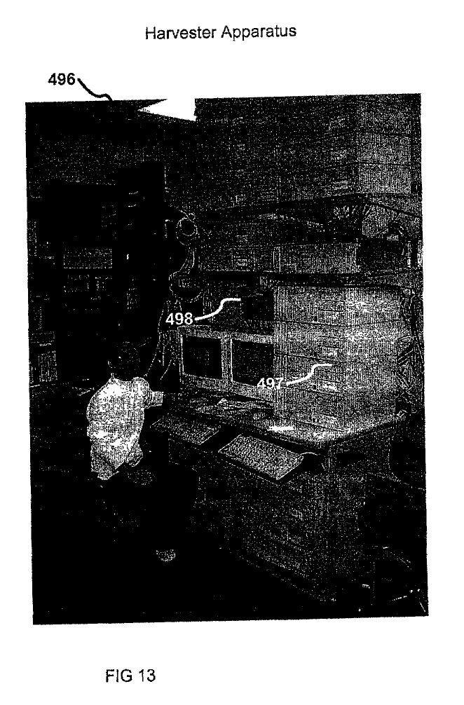

At Step 8120 FIG. 11, the system submits the list to Advertisement Submission Database FIG. 34 by clicking on the Submit button element 389 FIG. 34L. At Step 9000 FIG. 1 and FIG. 12, the system opens an Advertisement Submission Program Start Page interface FIG. 34A, selects option “View and update submitted advertisements” element 203 FIG. 34A, opens an Advertisement Submission Program View and Update Submitted Advertisements interface FIG. 34F where the operator of our invention enters an identification code and password, the system displays a list of advertisements in a table element 372 FIG. 34F then the operator of our invention selects and advertisement by clicking on its row and, in response, our invention opens an Advertisement Submission Program View and Update Submitted Advertisements interface FIG. 34G and the operator of the system reviews the advertisement and then chooses to modify or accept the advertisement.

At Step 9010 FIG. 12, the system opens an Advertisement Submission Program Start Page interface FIG. 34A. At Step 9020 FIG. 12, the operator of the system selects option “View and update submitted advertisements” element 203 FIG. 34A. At Step 9030 FIG. 12, the operator of the system enters a user identification into element 341 FIG. 34F and the corresponding password into element 342 FIG. 34F and then clicks the Submit button element 343 FIG. 34F.

At Step 9040 FIG. 12, based on the criteria entered in Step 9030 FIG. 12 our invention reports to an Advertisement Submission Program View and Update S Submitted Advertisements interface FIG. 34F in table element 372 FIG. 34F a list of matching advertisements. The operator of the system selects an advertisement by clicking on its row in element 372 FIG. 34F. At Step 9050 FIG. 12, based on the row clicked in element 372 FIG. 34F during Step 9040 FIG. 12 our invention displays advertisement components in an Advertisement Submission Program View and Update Submitted Advertisements interface FIG. 34G so that the operator can view and review said advertising components and decide modify or accept the advertisement.

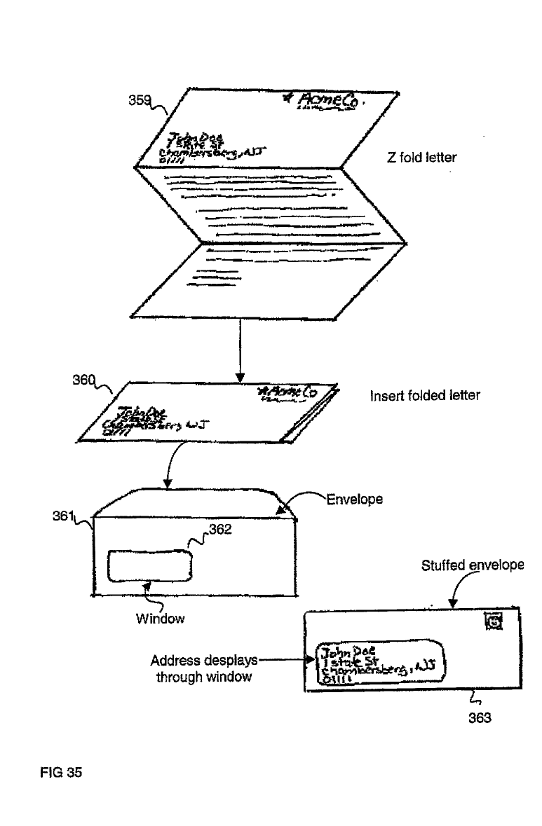

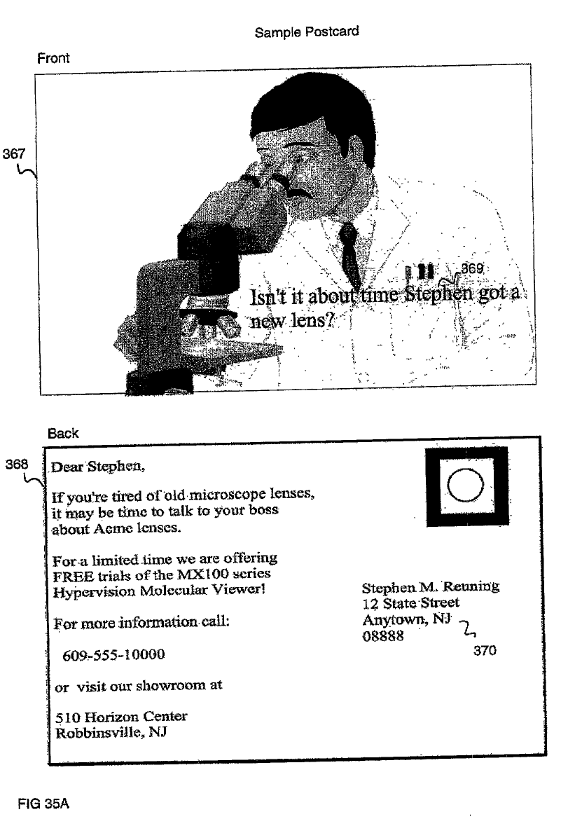

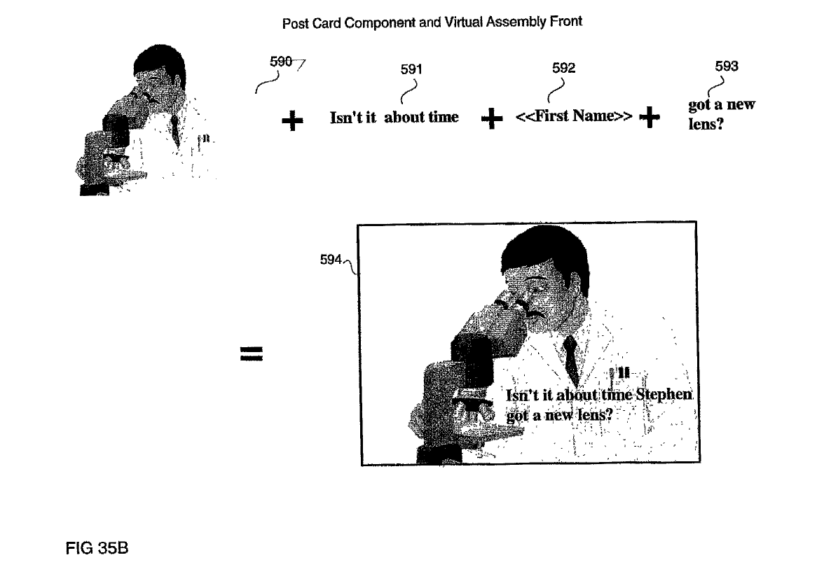

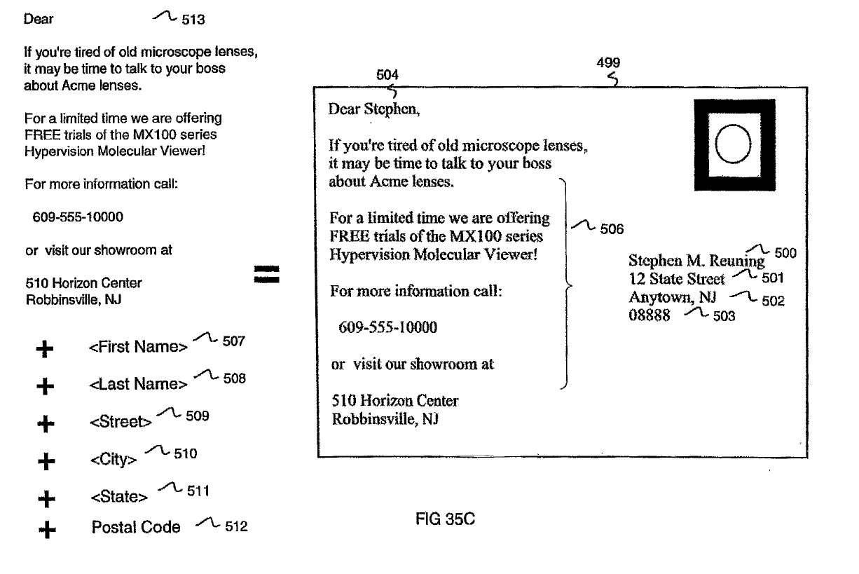

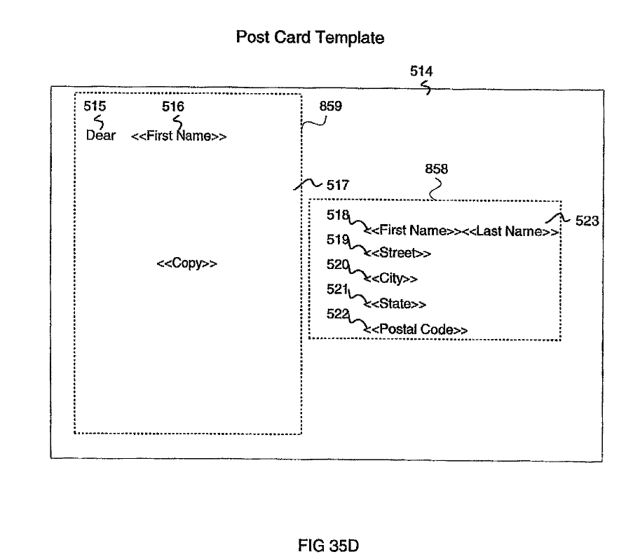

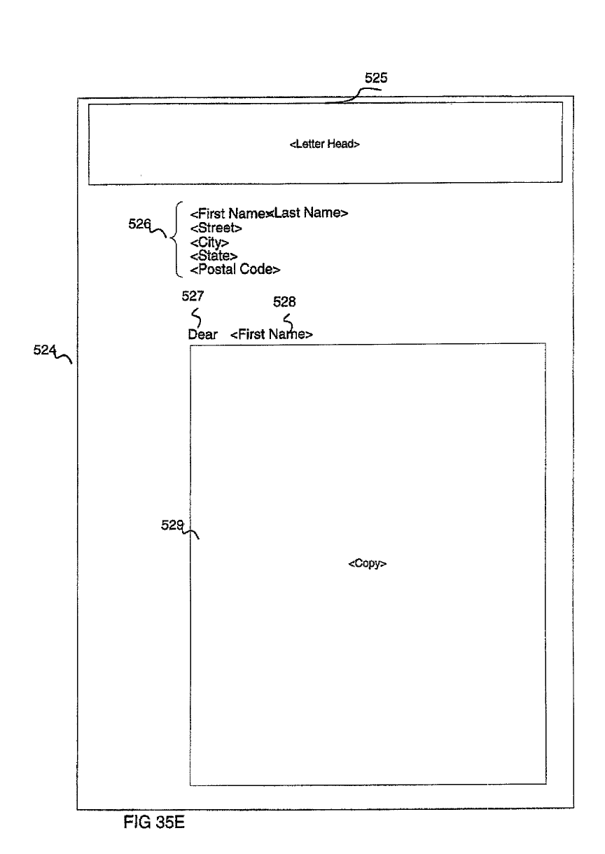

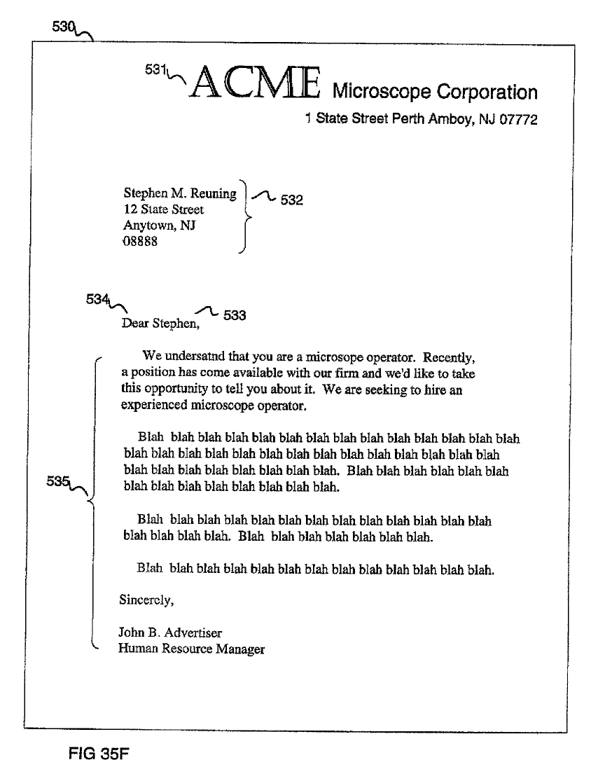

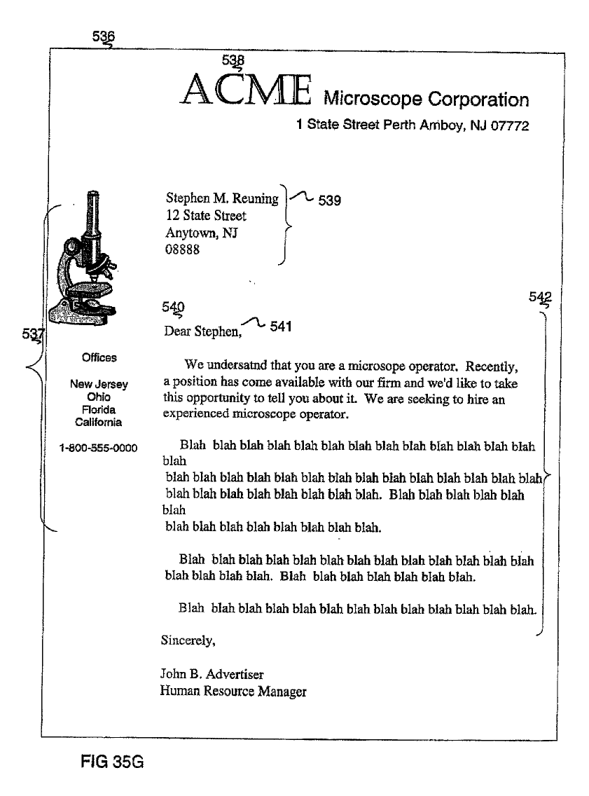

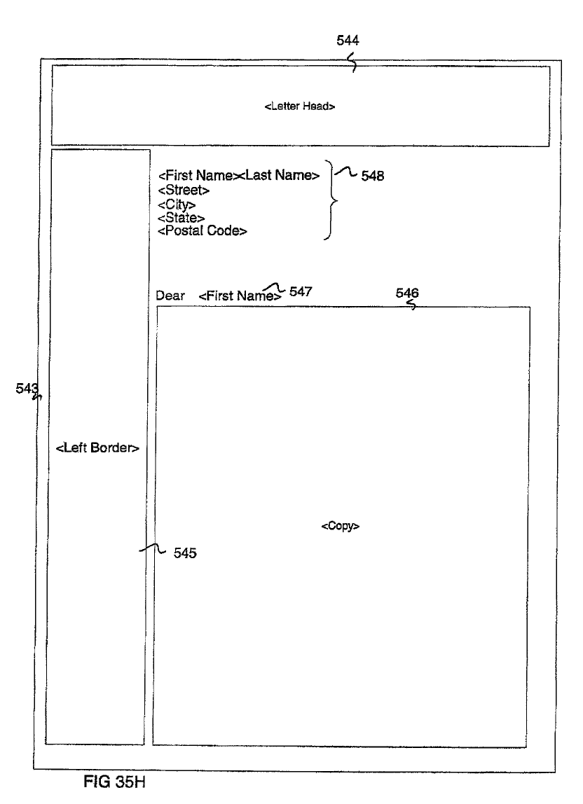

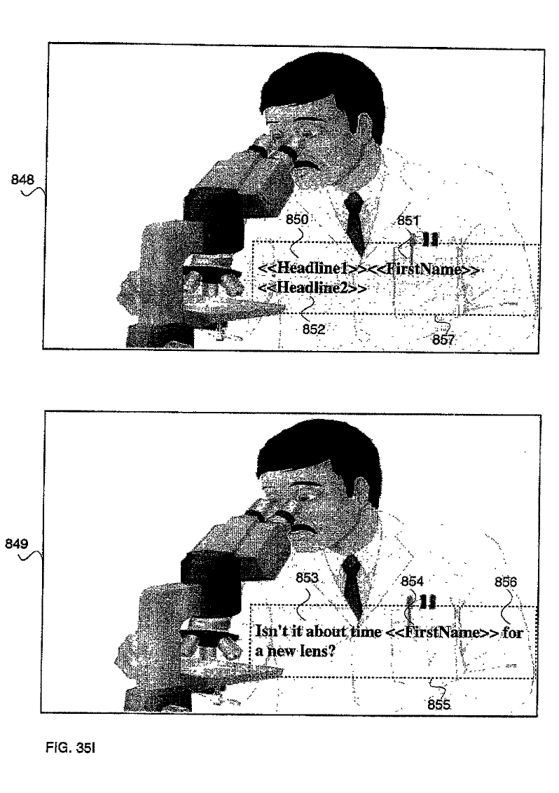

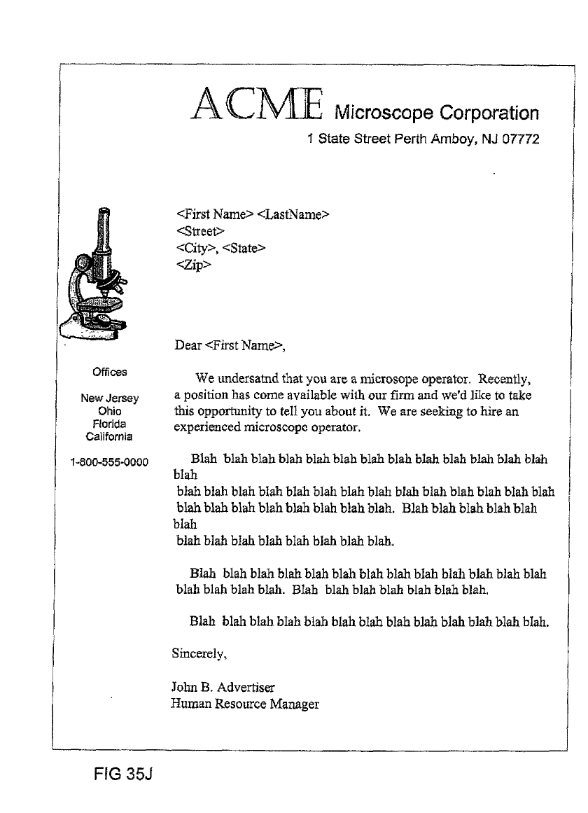

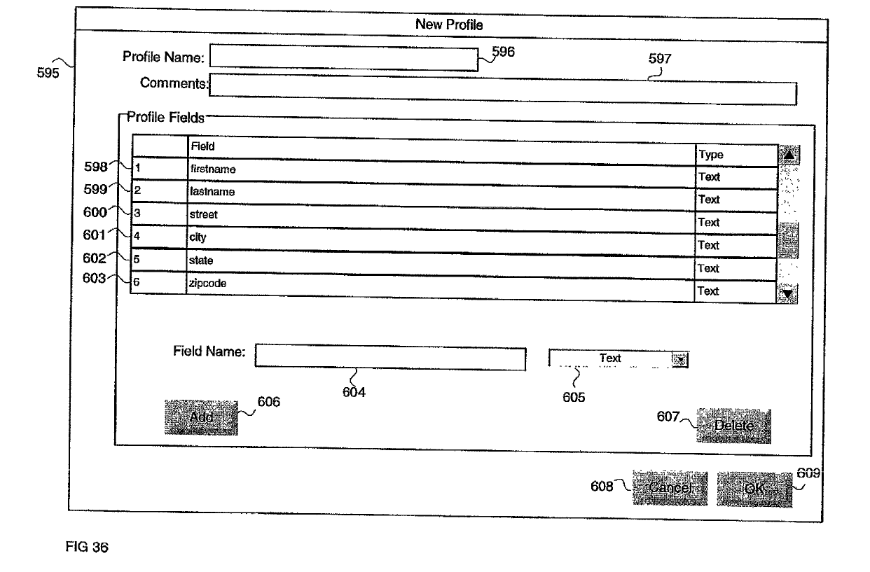

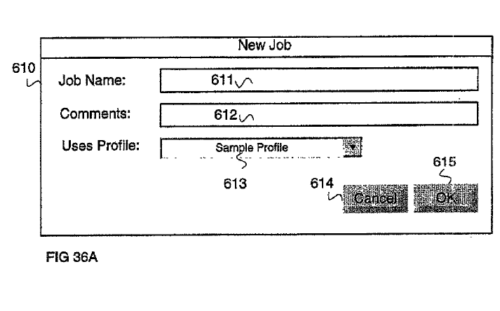

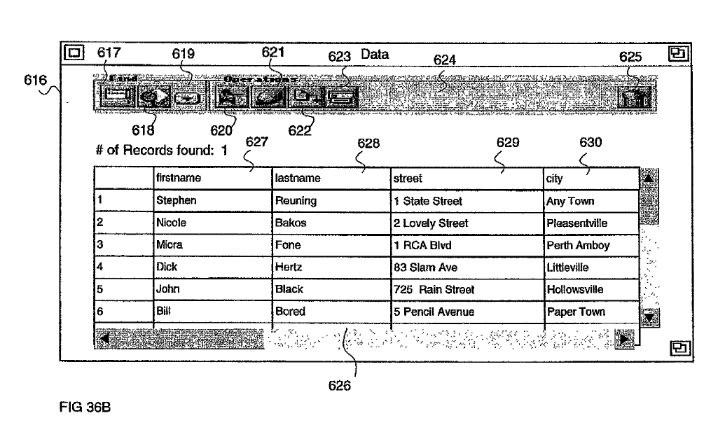

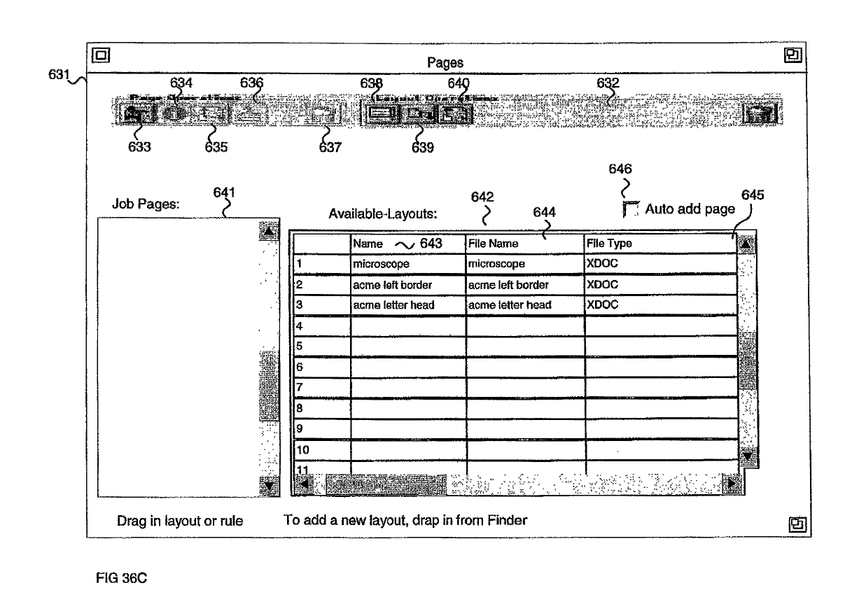

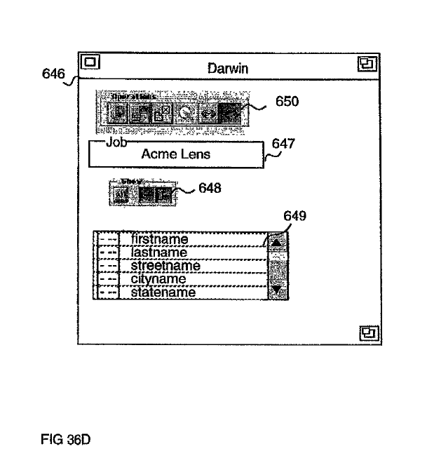

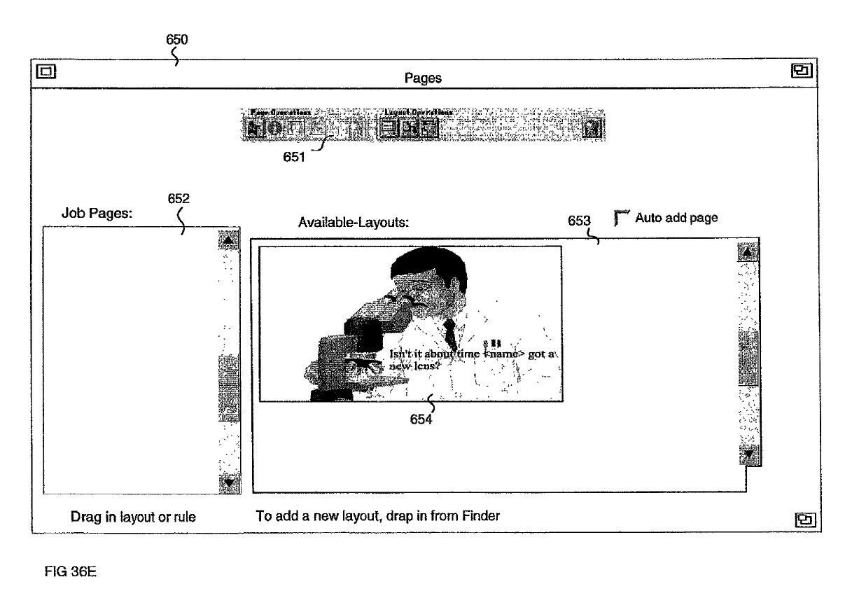

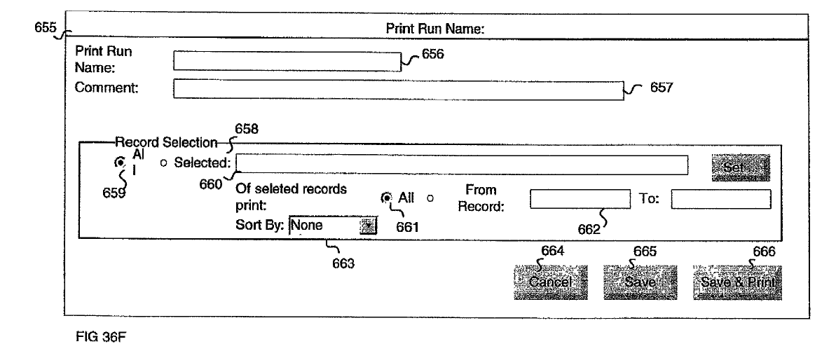

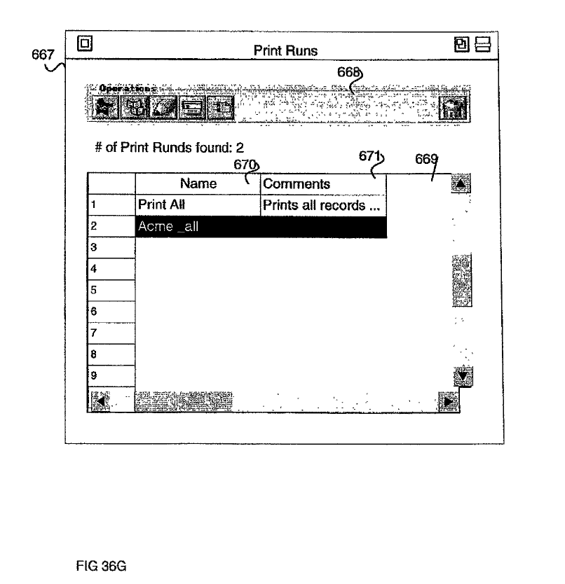

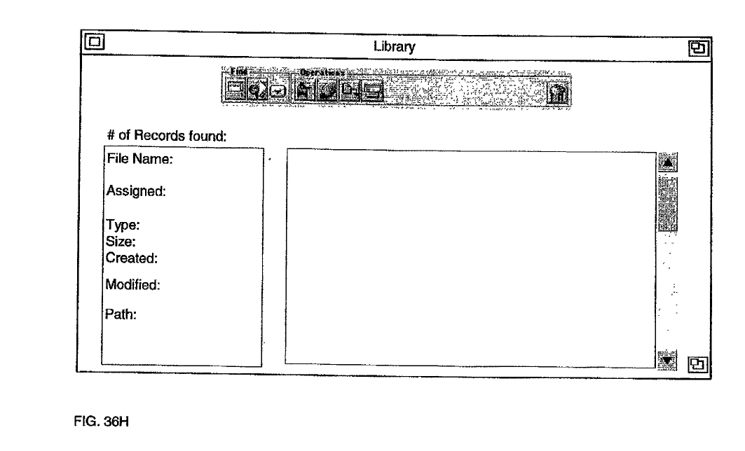

At Step 9060 FIG. 12, based on the decision to decide modify or accept the advertisement made in Step 9050 FIG. 12, the operator of the system clicks on the Accept button element 348 FIG. 34G or the Modify button element 349 FIG. 34G. At Step 10000 FIG. 1 and FIG. 6, the operator of the system designs media layouts such as those demonstrated in FIG. 35D, FIG. 35E and then creates a graphic layout using a graphic layout application such as QuarkXPress FIG. 36C and then stores the graphic layout at element 486 FIG. 14 and then creates a profile using a graphic variable manager software application such as Scitex Darwin Pilot FIG. 36 and then stores the profile into a library.

At Step 10005 FIG. 6, the operator of the system designs media layouts such as those demonstrated in FIG. 35D, FIG. 35E, and 35H. At Step 10010 FIG. 6, the operator of the system creates a graphic such as that demonstrated as element 590 FIG. 35B using any of the many available graphic programs and converts to our invention's standard layout using a graphic layout application such as QuarkXPress FIG. 36C.

At Step 10015 FIG. 6, the operator of the system stores the graphic created and converted into our invention's standard into a computer storage device such as that demonstrated in FIG. 14 as element 486 Darwin Workstation. At Step 10020 FIG. 6, the operator of the system determines the variable images and text files to be applied in variable data documents such as those demonstrated in FIGS. 35D, 35E and 35H. At Step 10025 FIG. 6, the operator of the system stores the variable data documents selected in Step 10020 into the Darwin library using the Darwin Library Interface FIG. 36H. At Step 10030 FIG. 6, the system fields are defined as in FIG. 36 and saved as a profile.

At Step 10035 FIG. 6, the system saves a profile created in the New Profile Interface of Darwin FIG. 36. At Step 11000 FIG. 1 and FIG. 6A, the operator of the system creates or obtains images; uses graphic manipulation software applications to adjust images to standard sizes, resolutions and formats and stores the images. At Step 11010 FIG. 6A, the operator of the system creates or obtains images. At Step 11020 FIG. 6A, the operator of the system uses graphic manipulation software applications to adjust images to standard sizes. At Step 11030 FIG. 6A, the operator of the system uses graphic manipulation software applications to adjust resolutions and formats of images.

At Step 11040 FIG. 6A, the operator of the system stores the images into appropriate databases and directories on computer storage devices. At Step 12000 FIG. 1 and FIG. 6B, the operator of the system creates or obtains headlines then uses text manipulation software applications to adjust the headline text to standard sizes and formats and stores the headlines. At Step 12010 FIG. 6B, the operator of the system creates or obtains headlines. At Step 12020 FIG. 6B, the operator of the system uses text manipulation software applications to adjust headlines to standard sizes and formats.

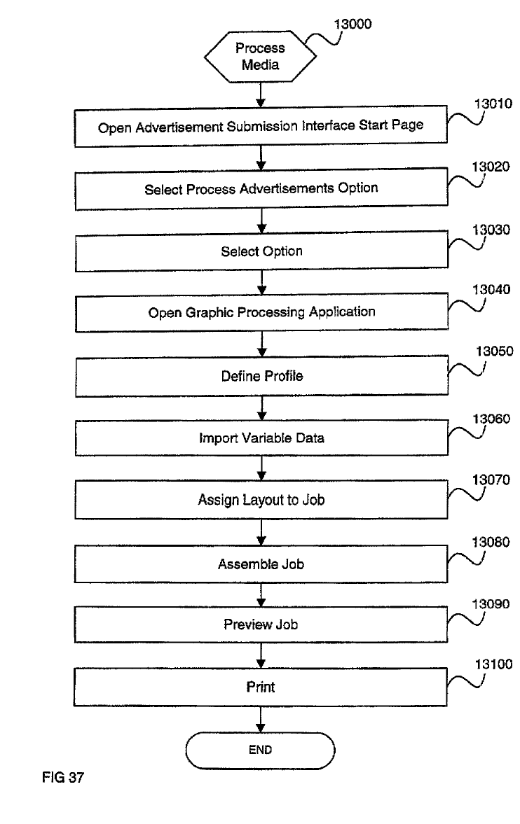

At Step 12030 FIG. 6B, the operator of the system stores the headlines into appropriate databases and directories on computer storage devices. At Step 13000 FIG. 1 and FIG. 37, the operator of the system selects an advertisement submission for processing then, using the graphic processing software applications located at element 486 FIG. 14, prepares the layout for printing and merging into the list selected or submitted by an advertiser or Query Artist during Steps 8000 through 8120 FIG. 11, imports the list previews the job using a computer software interface at element 486 FIG. 14 and then inputs the command to print or export the advertisements. At Step 13010 FIG. 37, the operator of the system opens an Advertisement Submission Program Start Page FIG. 34A.

At Step 13020 FIG. 37, the operator of the system clicks on the element 204 of an Advertisement Submission Program Start Page FIG. 34A to activate an Advertisement Submission Program Process Advertisements interface FIG. 34M. At Step 13030 FIG. 37, the operator of the system selects an option from an Advertisement Submission Program Process Advertisements interface FIG. 34M and in response our invention reports a list of advertisement submissions in the table element 399 FIG. 34M. At Step 13040 FIG. 37, the operator of the system activates the graphic processing software applications located at Darwin Workstation element 486 FIG. 14.

At Step 13050 FIG. 37, the operator of the system loads an already stored profile or creates a profile using the graphic processing software applications located at Darwin Workstation element 486 FIG. 14. At Step 13060 FIG. 37, the operator of the system imports variable field data from a file created by during Steps 8000 through 8120 FIG. 11. At Step 13070 FIG. 37, the operator of the system assigns a QuarkXPress layout using a Scitex Darwin software application to the job. At Step 13080 FIG. 37, the operator of the system using QuarkXPress and a Scitex Darwin software application assembles the components of the job. At Step 13090 FIG. 37, the operator of the system using QuarkXPress and a Scitex Darwin software application to preview the job.

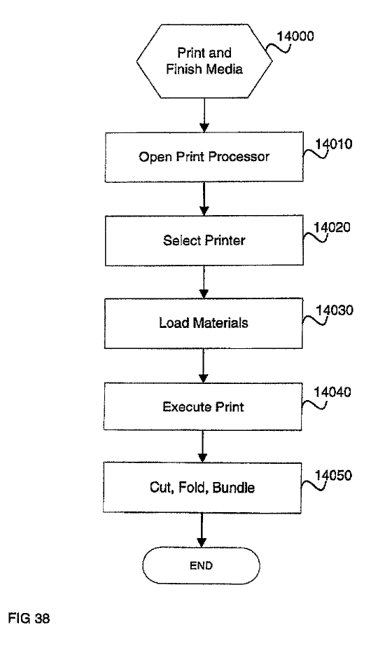

At Step 13100 FIG. 37, the operator of the system using QuarkXPress and a Scitex Darwin software application inputs the command to print or export the advertisements. At Step 14000 FIG. 1 and FIG. 38, the operator of the system opens the print processor, selects a printer to process the print job, loads materials into the printer, executes the print command which activates the print server element [488], removes the printed materials and cuts, folds, inserts bundles, stamps and otherwise prepare for delivery.

At Step 14010 FIG. 38, the operator of the system opens the print processor located at Darwin Workstation element 486 FIG. 14 that displays a computer software interface such as shown in FIG. 36F. At Step 14020 FIG. 38, the operator of the system selects the printer or computer storage device to receive the print job. At Step 14030 FIG. 38, the operator of the system loads paper and printing supplies into printer located at element 487 FIG. 14. At Step 14040 FIG. 38, the operator of the system executes the print command from a software application interface such as that demonstrated in FIG. 36F. At Step 14050 FIG. 38, the operator of the system removes the printed materials from a printer and cuts, folds, inserts bundles, stamps and otherwise prepare for delivery such as in FIG, 35.

At Step 1220 FIG. 3, operator determines link-qualifying criteria. See FIG. 22. Once our invention begins its search on the Internet (during a later Step of Operation), our invention downloads from web site servers on the Internet, through the connection to the Internet, the text and Meta page content into its computer memory. The content is then analyzed by the apparatus for combinations of characters, words, phrases, or combinations of characters, words and phrases, or combination of words and phrases based on what the operator enters during this step. In the case when the content of the page matches one of the link qualifying criteria then the hyperlinks listed in the body text content or HTML code of the page will be stored by the computer in memory or mass storage device in a table or other organizing format so that it may be reviewed by our invention at a later step in the process when our invention uses the address of each stored hyperlink to locate that directory on a server on the Internet and download its content In other words, the operator is instructing our invention to “follow” hyperlinks on only those pages which contain words, phrase, or combinations of such that match the entry in the link qualifying criteria field.

Advertisement Assembly

Our invention is a system for assembling advertisements from a catalog of digital objects. These objects could be static images, text objects, sound objects and video objects. Our invention also provides a system for isolating a list of desirable contacts to receive an advertisement. Our system may optionally include automated merging of variable sales-prospect contact information (such as name, street, city, state) into an advertisement, and manifesting the merged advertisement into a readable format such as printed post cards, printed letters, or electronic mail deliverable objects or files.

Once an advertiser creates a satisfactory advertisement, the operator may search our invention's contact database for prospective contacts. Our invention provides a fully text indexed database of professional profiles from which a subset of desirable end users might be isolated. For example, an advertiser of a microscope part might isolate the professional profiles that contain the word “microscope” thus isolating individuals who operate, design, repair or otherwise work with microscopes. The advertiser may also submit his/her own list of contacts. Contact information such as Name, Street, City, State, etc. are merged into variable data fields on the advertisement creating a customized advertisement for each prospect on the list.

The system administrator uses our invention to process the submitted advertisements into a deliverable format For example, if the advertiser selected printed post card medium for the advertisement then the system administrator would merge the digital objects selected and submitted by the advertiser and the variable data from the contact list using the method and systems of our invention and print them via a digital printer specifically attributed to merging and printing digital objects.

Our invention provides system administrators a method for assembling, cataloging and storing digital objects such as static images, text objects, sound objects and video objects using a remote computer workstation. As the number of selectable objects increases, greater advantages are ed to advertisers because they have a wider selection of differing objects to use in building exciting and creative advertisements. Administrative operators develop, buy or lease digital objects that may be desirable to advertisers and input those objects into our invention system so they appear in the selection catalog ed by our invention to advertisers.

Our invention provides system administrators a method for assembling, cataloging and storing professional profiles using a remote computer workstation. Resumes, Curriculum vitas, Home Page Personal Profiles, an other professional profile sources are collected and stored using several collection methods. In one approach, professional profiles are collected using an Internet spidering technique. In another, professional profiles are purchased or leased or otherwise collected from third parties. In another, professional profiles are collected via a software script supplied to Internet portal and community site operators. In another, professional profiles are collected as response to traditional advertising methods. Once professional profiles are collected, our invention system isolates contact information such as name, street address, city, state, postal code, telephone numbers and email address spread randomly in a computerized document and parses or normalizes that information into specified fields of a database record. professional profiles stored in our invention system are then available to advertisers for the purpose of isolating prospect contacts.

An Example (or “Preferred Embodiment”) of Our System

In a preferred embodiment of our invention the link qualifying criteria operators, and filter criteria fields follow the rules as indicated for the “search criteria” field described in Step 1215. The link qualifying criteria is a Filter to be applied to the pages returned by the search engines. The link qualifying criteria are applied to the body text and/or the Meta content of the pages. The link qualifying Criteria field supports multiple rows of filter criteria. The program considers multiple rows as linked to each other with the “OR” operator. (Logical operators are not to be placed at the end or the beginning of a row).

Step 1200 et seq.

At step 1225 FIG. 3, operator determines page-qualifying criteria. See FIG. 22.

When entering search expressions in Search Criteria and Page Filter Criteria fields (Criteria tab of Main Window), the following rules are observed in our preferred embodiment of our invention.

1. The Search Criteria matching is always case-sensitive.

2. All expressions (strings with spaces) are put in quotes (single or double).

3. The only logical operator allowed is AND. It must always be in capital letters.

4. A row cannot begin or end with the logical operator (AND).

5. Where multiple rows are allowed (in the Page Filter Criteria and Ignore URL fields), the program processes them as linked with “OR” operators. (Do not enter “OR” at the ends or the beginnings of the lines.)

6. Except for the “” and ‘’ (quotes as expression symbols), the program does not recognize special characters in the Search Criteria field. The usable options for this field are restricted by the search engines' syntax (which is usually very limited). Using the special characters in the Search Criteria field may result in irrelevant search results. (The special characters are intended for use in Page Filter Criteria expressions.)

7. The elements within [ ] (brackets as multitude symbols) are treated as linked to each other with “or” operators. E.g. [A-ETZ] means “either any capital letter from A to E, or capital T, or capital Z”. (Operator should not enter “OR” or any separators such as commas.)

8. The following symbols are special characters outside [ ] (brackets as multitude symbols): * (string symbol), ? (alphanumeric character), # (numerical character symbol), and & (letter symbol). They are recognized literally in a search string, should they be put it in brackets, e.g. “J [&] B”.

9. The following symbols are special characters inside [ ] (multitude symbols): ! (the exclude prefix), - (range prefix), and ˜ (escape prefix). Invention recognizes any of them literally, if operator puts the ˜ (escape prefix) before it, like this: ˜-, ˜!, ˜˜. Example: “Rh [+˜-]”

Once our invention begins its search on the Internet, it downloads from web site servers the text and Meta page content. The content is then analyzed for combinations of characters, words, or phrases, based on what the operator enters. When the content of a page matches one of the page qualifying criteria, then the email address and HTML text or body text of any “matching” page will be stored by the computer. In other words, the system is instructed to save specified content [1290] from only those web pages which contain words, phrase, or combinations that match the entry in the page qualifying criteria field.

In the preferred embodiment of our invention the page qualifying criteria operators, and filter criteria fields follow the same rules as indicated for the “search criteria” field described in Step 1215.

The following are an example of page qualifying criteria used by we: “my resume”, “vitae”, “resume for”, “resume of”, “C.V.”, “CV”, “online resume”, “personal resume”, “work history”, “work experience”, “job history”, “job experience”, “my skills”, “personal skills”, “personal profile”, “personal experience”, “career experience”, “professional profile”, “career profile”, “my profile”, “career objective”, “career history”. An example of what might be used to search for Visual Basic Programmers' professional profiles is: “my resume”, “computer programmer” AND “Visual Basic” AND “vitae”, “computer programmer” AND “Visual Basic” AND “resume for”, “computer programmer” AND “Visual Basic” AND “resume of”, “computer programmer” AND “Visual Basic” AND “C.V.”, “computer programmer” AND “Visual Basic” AND “CV”, “computer programmer” AND “Visual Basic” AND “online resume”, “computer programmer” AND “Visual Basic” AND “personal resume”, “computer programmer” AND “Visual Basic” AND “work history”, “computer programmer” AND “Visual Basic” AND “work experience”, “computer programmer” AND “Visual Basic” AND “job history”, “computer programmer” AND “Visual Basic” AND “job experience”, “computer programmer” AND “Visual Basic” AND “my skills”, “computer programmer” AND “Visual Basic” AND “personal skills”, “computer programmer” AND “Visual Basic” AND “personal profile”, “computer programmer” AND “Visual Basic” AND “personal experience”, “computer programmer” AND “Visual Basic” AND “career experience”, “computer programmer” AND “Visual Basic” AND “professional profile”, “computer programmer” AND “Visual Basic” AND “career profile”, “computer programmer” AND “Visual Basic” AND “my profile”, “computer programmer” AND “Visual Basic” AND “career objective”, “computer programmer” AND “Visual Basic” AND “career history”.

At Step 1230 FIG. 3, operator determines Search Engines if relevant embellishment (URL Search Criteria method) of method is implemented. See FIG. 21. The search/search engine interface provides a selection list of search engines, which is determined by the entries made in Step 1210. In other words, if three search engines were entered during Step 1210 then the list appearing on the search/search engine interface as indicated in FIG. 21 would consist of three search engines that can be selected. If during Step 1210 eight search engines were entered, then on the search/search engine interface ten search engines would be listed for possible selection The preferred embodiment of our invention lists the search engines by their “friendly” name as listed in the search engine controls (FIG. 32) interface dialog window column labeled “Name”.

The operator could select all or none of the search engines depending on the search strategy as determined by the query art preferred. Determining which search engines to use and which search criteria to use will require subjective and objective judgement on the part of the operators inputting the criteria and selecting the appropriate search engines. The inventor calls this the “query art”. It is called art because there is a certain amount of intuitive input on the part of the operator or the operator's agents with regard to determining the most ideal strategy for searching the web. In any case, once it has been determined which search engines are to be investigated by our invention then those search engines are selected by indication through the computer interface as shown in FIG. 21 in the search/search engines field.

At Step 1235 FIG. 3, operator determines URLs to Ignore. See FIG. 22. There are hundreds of millions of pages of content located on the World Wide Web Internet. Every one of these pages is a potential source of data for our invention. With experience, the operator will learn that there are many servers on the Internet that do not contain information relevant or desirable and/or for other reasons determine web site locations that should not be visited. For example, the operator may learn that our invention visits sensitive military and government locations and upon reprimand by the government determine that it is inappropriate for our invention to download content from those sites. In any case, where it is desirable to ignore a specific URL then the operator many enter that URL into the “ignore URL” field.

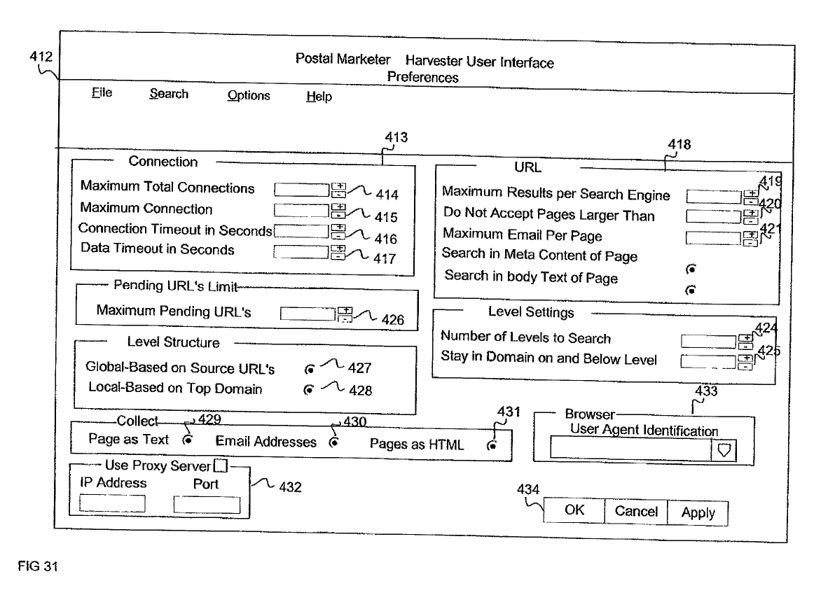

At Step 1240 FIG. 3, operator determines maximum total connections. See FIG. 31. Our invention requires that its “application program” be installed on one or more computers. The capacity of certain components of the computer determine the speed, capacity, and other performance measurements of the application program which comprises a part of the apparatus of our invention. Some of the computer's components' performance measurements that might effect the operation of our invention include the speed of the microprocessor, the size of the cache, the size of the RAM memory, the speed of the bus and the speed and capacity of the storage devices involved. Other components in this system include its connection to the Internet which may be through, but not limited to, network devices such as local area network hubs, interface cards, wiring, wireless broadcasters, modems, cable television protocol connections, and telecomm bandwidth connections which are commonly called T1, cloud, frame relay etc. The speed at which the apparatus can communicate to other servers on the Internet will determine the load on the microprocessor, the cache, the memory, the bus and the mass storage devices within the computer. Through experience, the operator may determine the ideal load based on all the preferences set into the operation of the apparatus. In certain situations and under certain conditions, it will become desirable to limit the number of “threads” that the apparatus maintains with servers on the Internet. The word “thread”, as it is applied here in this document, res the communication activity between the computer on which our inventions application program resides and a specific site server or a specific number of threads on a site server on the Internet. In other words, the operator can determine the specific limit to the number of pages that can be downloaded from outside websites at any given moment The operator limits the number of separate pages, which are downloaded at any given moment by inserting or selecting a number in the total connection field.

At Step 1245 FIG. 3, operator determines maximum connections per server. See FIG. 31. The World Wide Web Internet is comprised of a collection of millions of computers communicating with each other using an agreed upon communication protocol, but little else is standardized. Consequently, the abilities, capacities, qualities, and security of the servers that could possibly be connected with by our invention vary greatly. There may be situations in cases where the owner or operator of a specific computer server on the Internet would be willing to share content with our invention however, because of the low bandwidth, low processor capability, or other low performance issue require that a maximum number of connections between our invention and said server be determined in order to create a limit on the amount of resources our invention could use on a server at any given time. The operator can determine a specific number of maximum connections per server at any single time by entering a number into the “maximum connection” field. For example by entering the number two into the maximum connection field, the operator causes our invention upon its initiation of search activity to limit itself to only two connections to any specific server located anywhere on the internet.

At Step 1250 FIG. 3, operator determines connection time out. See FIG. 31. Most users of Internet browsers have experienced web sites, which freeze, download slowly, or never download content at all. In order that our invention does not allocate its resources such as bandwidth and processor time to a slower or dysfunctional World Wide Web website, the operator may determine a maximum connection time. By entering an amount of time in to the connection timeout field, the operator instructs the apparatus to drop the connection or thread to that site address after a specific amount of time passes by without a reply and thus release resources to the next hyperlink search.

At Step 1255 FIG. 3, operator determines data timeout. See FIG. 31. Most users of Internet browsers have experienced web sites, which freeze, download slowly, or never download content at all. In order that our invention does not allocate its resources such as bandwidth and processor time to a slower or dysfunctional World Wide Web website, the operator may determine a maximum data download time. By entering an amount of time in to the data timeout field, the operator instructs the apparatus to drop the connection or thread to that site address after a specific amount of time spent downloading data and thus release resources to the next hyperlink search.

At Step 1260 FIG. 3, operator determines maximum results per Search Engine See FIG. 31. Some World Wide Web Internet search engines can turn up an endless or very large number of matching URL results. Typically, the results are returned by the search engine, in groups of ten, twenty, or fifty. The initial results returned tend to more accurately match a given criteria than the later returned results. For example, the first one hundred results provided by a search engine may list content with several repeated incidents of the search criteria while the last results, for example results 40,000 through results 40,100 may contain only one of the words of the phrase of the search criteria and thusly be less relevant.

For whatever reason as may be determined by the operator, it may be desirable to limit the search engine results used by the apparatus. The operator can instruct our invention by entering the number of maximum results desired into the “maximum results per search” field.

At Step 1265 FIG. 3, operator determines largest pages to accept. See FIG. 31. There is no protocol that pre determines what comprises a “page” of data on the Internet except that it is a HTML file stored as a document within a sub directory on a server connected to and providing Internet server services to the Internet. Since there is no limitation to the amount of information that could be contained on any given “page”, pages could be infinitely large. The preferred embodiment of our invention provides for a maximum limit to the size of page that may be downloaded and that maximum limit may be pre determined by the operator. The operator inserts a number into the “largest pages to accept” field. That number res the amount of content to download in a universally used measurement commonly known as “bytes”.

At Step 1270 FIG. 3, operator determines whether or not to search in Meta content of pages. See FIG. 31. HTML and Internet protocol provide for the sub division of website page data into the categories of “body text” and “meta content”. The body text is what is commonly displayed in a browser window when a visitor comes to a web site via a computerized browser interface. The Meta content is embedded “behind the scenes” in the HTML of the server which communicates with the browser to display the page. In the meta content, creators of the page embed text for many purposes including key words and descriptions that may not be displayed via the browser but are available to search engines and search devices for the purpose of categorizing, filtering, and querying on the Internet. As we envision the operation of our invention, it is highly likely that the operator will determine that either the meta contents and body text of website pages should be searched for the variables as determined in Steps 1220 and Step 1225 more specifically the link qualifying criteria and a page qualifying criteria.

At Step 1275 FIG. 3, operator determines whether to search in body text of page. See FIG. 31. HTML and Internet protocol provide for the sub division of website page data into the categories of “body text” and “meta content”. The body text is what is commonly displayed in a browser window when a visitor comes to a web site via a computerized browser interface. As we envision the operation of our invention, it is sometimes likely that the operator will determine that the only the body text of website pages should be searched for the variables as determined in Steps 1220 and Step 1225 more specifically the link qualifying criteria and page qualifying criteria.

At Step 1280 FIG. 3, operator determines whether to count level depth from source URL or from top domain. See FIG. 31. During a later step, the apparatus downloads content from World Wide Web Internet sites. If content down loaded from a specific site matches qualifying criteria as entered in step 1220, the apparatus stores the address of every hyperlink on the selected page. In a later step the apparatus will visit the pages at those stored hyperlink addresses, download their content and store the hyperlinks on those pages if they meet the link qualifying criteria and then do the same for those links in what could be an endless collection of links and visiting links and collecting more links and visiting links and so on. It is possible, in our invention, to limit, from a source URL or from a top domain, the number of levels to follow. For example, if the domain Diedre Moire.com or URL www.diedremoire.com were returned, and the content downloaded, several hyperlinks would be found including, for example, “candidateseeker.com”. The domain or URL for candidateseeker.com would be considered the second level. Should the apparatus not be limited to only two levels, and it would visit the domain of diedremoire.com it would find, for example, hyperlinks to the address candidateseeker.com/intro.htrn as well as many others. The URL “candidateseeker.com/intro.htrn” would be considered the third level. If the apparatus was instructed to permit searches beyond the third level then it would at a later step visit the URL “candidateseeker.com/into.htm” where it would download the content and locate many more hyperlinks including one, for example, candidateseeker.com/faq/whyusecandidateseeker.htm. The address candidateseeker.com/faq/whyusecandidateseeker.htm would be the fourth level.

It is possible based on the search criteria, originating URLs, data available on the Internet and other factors for web pages to be less desirable as the apparatus gets further into levels(i.e. the number of levels gets higher). Consequently, the operator may decide to limit the level depth and in doing so base it on the source URL which is the URL returned from a search engine as entered in Step 1215 or from the top domain of any URL that may be located. The difference between a source URL and a top domain is determined as follows, a source URL could be several levels down from the top domain. For example, the source URL www.diedremoire.com/trainee/into/faq would be four levels from the top domain in the case that “top domain” was selected or the first level should the selection “source URL” be selected.

At Step 1285 FIG. 3, operator determines number of levels from initial link to follow. See FIG. 31. During a later step, the apparatus downloads content from World Wide Web Internet sites. If content down loaded from a specific site matches qualifying criteria as entered in step 1220, the apparatus stores the address of every hyperlink on the selected page. In a later step the apparatus will visit the pages at those stored addresses, download their content and store the hyperlinks on those pages if they meet the link qualifying criteria and then do the same for those links in what could be an endless collection of links and visiting links and collecting more links and visiting links and so on. It is possible, in our invention, to limit, from a source URL or from a top domain, the number of levels to follow. For example, if the domain Diedre Moire.com or URL www.diedremoire.com were returned, and the content downloaded, several hyperlinks would be found including, for example, “candidateseeker.com”. The domain or URL for candidateseeker.com would be considered the second level. Should the apparatus not be limited to only two levels, and it would visit the domain of diedremoire.com it would find, for example, hyperlinks to the address candidateseeker.com/intro.htm as well as many others. The URL “candidateseeker.com/intro.htm” would be considered the third level. If the apparatus was instructed to permit searches beyond the third level then it would at a later step visit the URL “candidateseeker.com/into.htm” where it would download the content and locate many more hyperlinks including one, for example, candidateseeker.com/faq/whyusecandidateseeker.htm. The address candidateseeker.com/faq/whyusecandidateseeker.htm would be the fourth level.

It is possible based on the search criteria, originating URLs, data available on the Internet and other factors for web pages to be less desirable as the apparatus gets further into levels(i.e. the number of levels gets higher). Consequently, the operator may decide to limit the level depth and in doing so base it on the source URL which is the URL returned from a search engine as entered in Step 1215 or from the top domain of any URL that may be located. The difference between a source URL and a top domain is determined as follows, a source URL could be several levels down from the top domain. For example, the source URL www.diedremoire.com/trainee/into/faq would be four levels from the top domain in the case that “top domain” was selected or the first level should the selection “source URL” be selected. In this step the operator enters the number of levels the apparatus should follow.

At Step 1290 FIG. 3, operator selects “Email Addresses”, “Pages as HTML” or “Pages as Text”. See FIG. 31. This step instructs the apparatus on which types of content should be stored if found during later steps.

At Step 1295 FIG. 3A, operator determines whether Proxy server is to be used. See FIG. 31. One embodiment of our invention is based on the application software being installed on the Windows 95, Windows 98, or Windows NT operating system Within those systems, access to network resources and the internet defaults to the operating system unless the system is instructed to use a specific proxy server and port on the network as addressed by an IP number such 192.000.000.32:80 in which “192.000.000.32” res an internal local area network IP address and “:80” res a specific designated port on said server located at that IP address which is set up to act as a proxy or firewall to the Internet. In our invention the operator leaves the “proxy” field blank if the operating system defaults on the computer where the application program resides will suffice a connection to the Internet or enters the IP address and port number of the local area networks proxy server.

Methods for spidering the Internet web are well known to those with ordinary skill in the art as demonstrated by the attached documents: 13. http://bargandevil.com/robots.html, Robots and Web Site Spidering, Superior Software Solutions, Jun. 7, 2001, 4 pages; 14. Martijn Koster, NEXOR Robots in the Web: threat or treat?, ConneXions Revise 1997, 17 pages; and 18. Martjin Koster, The Web Robots FAQ, http://www.robotstxt.org/wc/fag.htm Jun. 7, 2001, 10 pages.

Steps 1300 et seq.

At Step 1300 FIG. 3A, operator determines User Agent Identification. See FIG. 31. The universe of Internet users is populated by many different types of Internet browsing application programs, many of which are years older than others and consequently there is a variation in capabilities based on computer software standards and formats. Consequently, many Internet servers ask visiting browser clients to I) themselves using a “friendly” name and version number so that the server can select an appropriately compatible program extension by which to download website page content. At the time of the filing of this patent, the most current and widely accepted browser formats are Microsoft Internet Explorer 4.0 and Netscape Communicator 4.0. The preferred embodiment of our invention downloads Meta content and text only. Therefore, compatibility issues are minimal. However, many servers require a “hand shake” from a visiting client computer that is based on identifying a known browser format by name. The preferred embodiment of our invention, as built by we, contains a list of all the known browser formats so that in such cases as may not be yet anticipated if there is a specific reason to handshake with a specific browser format, then it may be implemented. In the preferred embodiment of our invention, the operator would select Internet Explorer 4.0 or Netscape Communicator 4.0 in the field labeled “user agent identification”.

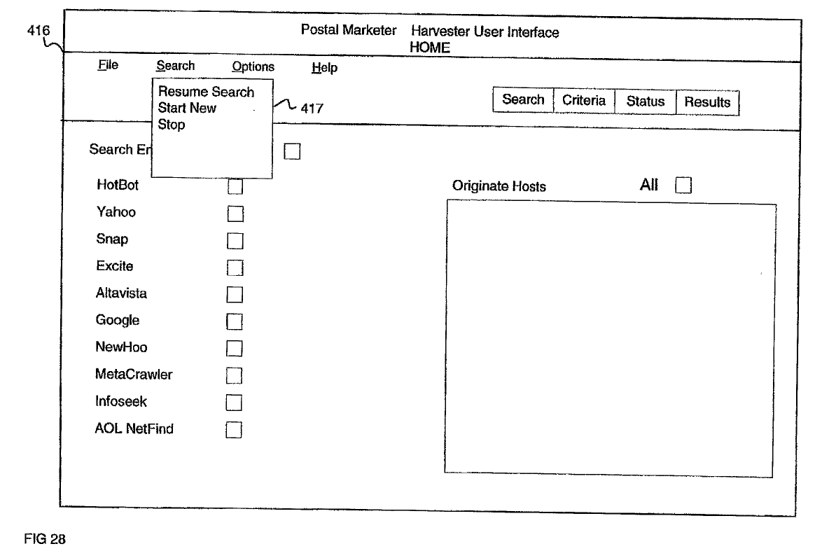

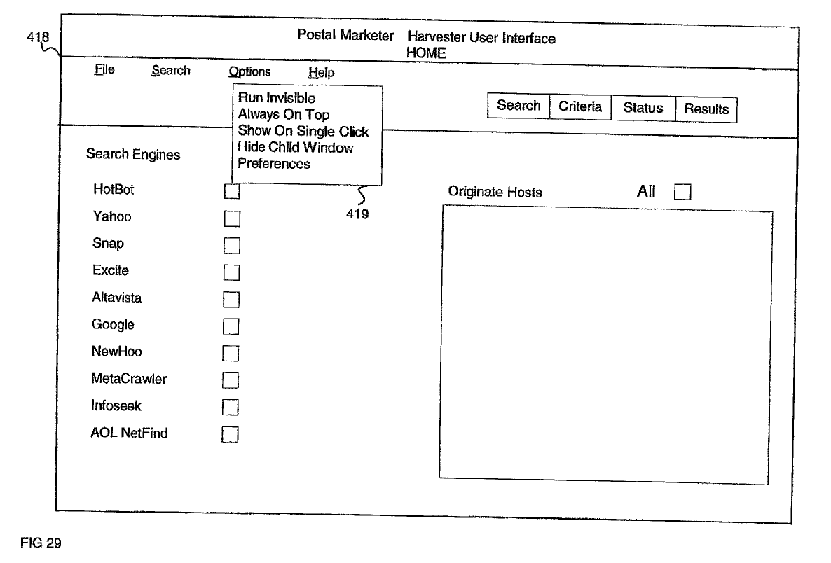

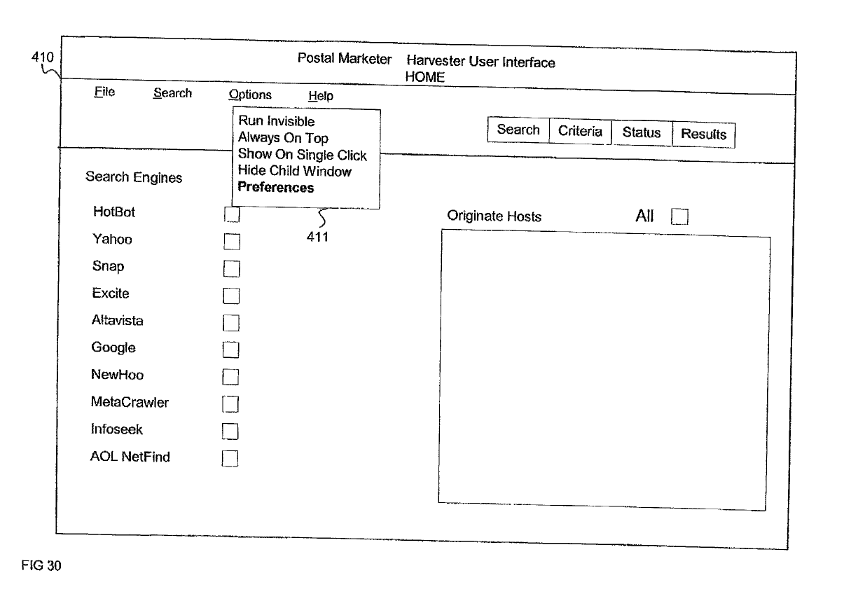

At Step 1305 FIG. 3A, operator starts search. See FIG. 28. The operator selects “start new” from the “search command menu” which activates an operating system dialog window as shown in FIG. 28. The operator enters the directory path and then name of the file to be created where results will be stored. Once the operator initiates the “OK” command, the apparatus begins its search activities.

At Step 1310 FIG. 3A, apparatus initiates contact with search engines or specified URLs. If during Step 1215 the operator selected the “search engine” type of collection strategy, then the apparatus will initiate contact with the search engines and apply the search algorithms as described in Step 1210 as the “Find Request” column Or if during Step 1215 the operator selected the “IP address sequence” or the “URL set” type then the apparatus will initiate the search by contacting the sites at those specific IP addresses or specific URL addresses. The apparatus opens a thread via the connection to the Internet to the server at the specified addresses or specified search engines. If using search engines, then the apparatus collects the URL of every match returned by the search engine and stores those in a table that is in memory or hardware storage on the computer, which forms part of the apparatus.

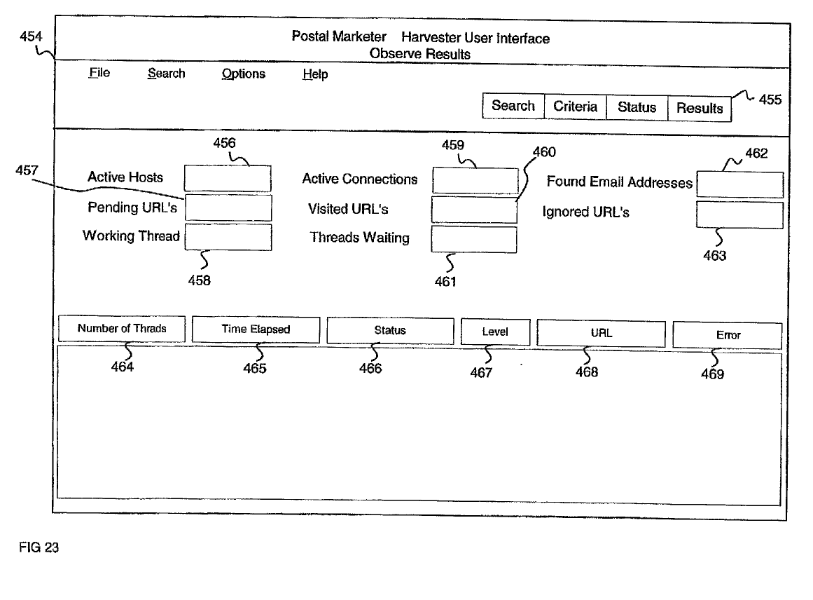

At Step 1315 FIG. 3A, apparatus reports status. See FIG. 23. The status reporting dialog window displays in real time the following categories of data “active hosts count”, “pending URLs count”, visited URLs count”, “ignored URLs”, “working threads count”, “threads waiting for memory”, “active connections count”, and “found emails count”. The same dialog window also reports information in real time in a grid of rows divided by four columns labeled “domain”, “IP”, “connections” and “error” where each provides real time information on an active thread.

The “active hosts count” field displays information that indicates the number of host computers to which the apparatus is connected at a given moment in time. While the unit could, for example, be connected by twenty threads, it is possible for there to be only one active host or, on the other extreme, it is possible for twenty threads to be connected to twenty different active hosts where “hosts” are specific servers which serve a specific URL.

The “pending URLs count” field displays, in real time, the number of URLs which have been stored in a table and are awaiting a visit by the apparatus for the purpose of matching criteria, comparing criteria, and then if “matching” storing emails, or content of HTML file or body text.

The “visited URLs count” field displays, in real time, the number of URLs that the apparatus visited and downloaded content from and compared.

The “ignored URLs count” field displays, in real time, the number of URLs that were ignored based on the criteria that was entered by the operator in Step 1235.

The “working threads count” field indicates, in real time, the number of threads using actual communication bandwidth and interfacing with the computer's RAM memory.

The “threads waiting for memory” field indicates, in real time, the number of threads that are open to an outside server on the Internet but awaiting memory before they can download content into the computer, which comprises one of the components of the apparatus.

The “active connections” count indicates, in real time, the number of active connections with servers.

The “found emails count” indicates the number of email addresses collected if the operator selected “email addresses” during Step 1290.

The “domain” column of the grid, which displays the real time activity of each thread, indicates the domain name and full directory path of the web site page accessed by the thread at the specific time observed.

The column labeled “IP” on the status grid indicates the IP address of the contacted server host.

The “connections” column of the status grid indicates a total number of connections to the specific host for the given IP address for that thread connection. In other words, if there are three separate rows connected to the same host, then each of the rows would have the number “three” in the connections column.

The “error” column of the status grid indicates any error messages, which occurred during the connection.

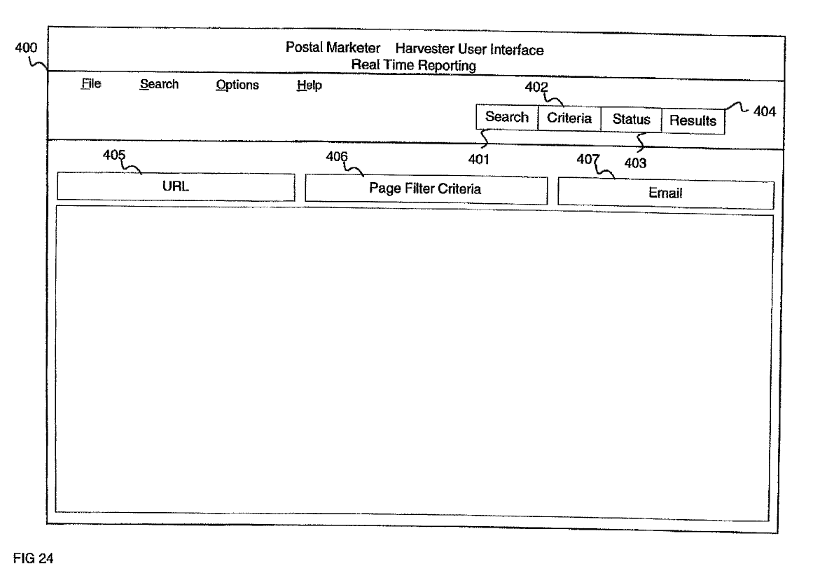

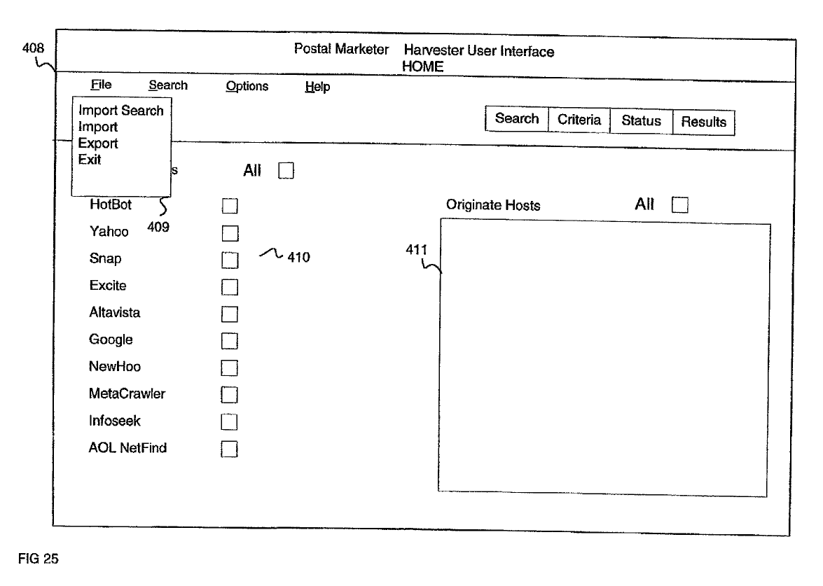

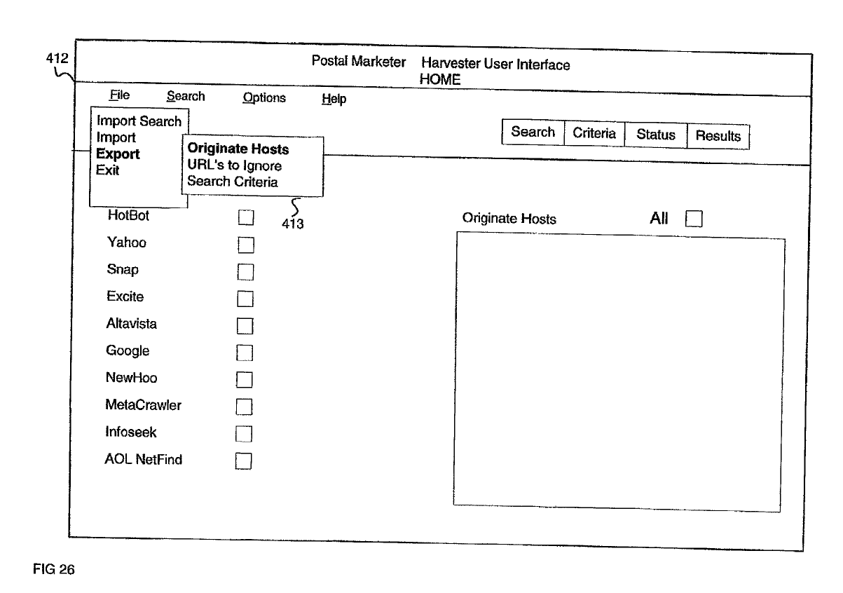

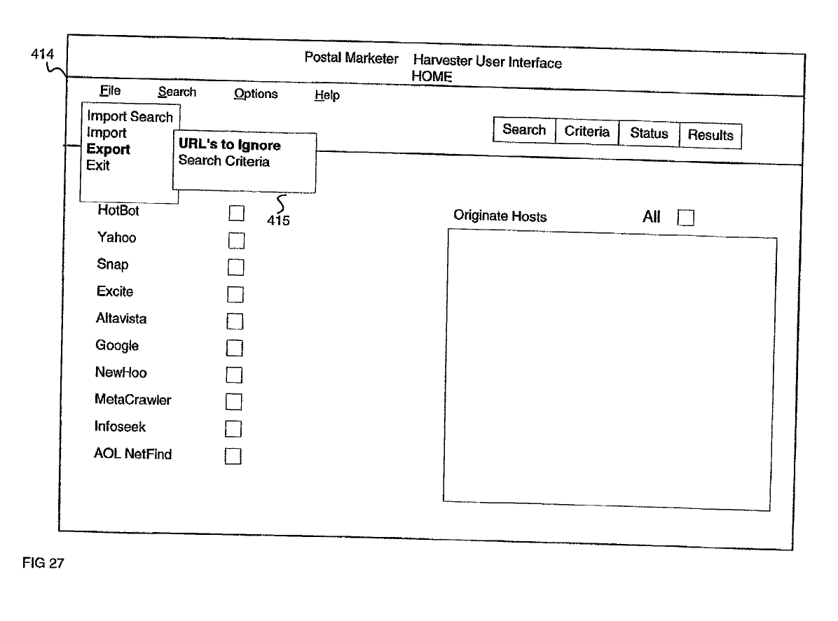

At Step 1320 FIG. 3A, apparatus reports results. See FIG. 24. As the apparatus locates email addresses or pages which match a page qualifying criteria as entered in Step 1225, those results are stored in a text file on the computer's storage device such as a hard drive in the pre specified folder that was selected during Step 1305. The apparatus also reports, in real time, to the apparatus dialog window in the results interface to a grid that contains rows for each qualified match and divides those rows into three columns labeled “URL”, “page filter criteria”, and “email”.

The column labeled “URL”, lists the URL of the website page which qualified based on the criteria entered during Step 1225. The “page filter criteria” column indicates the specific page filter criterion that was matched by the content of the selected page. For example, if the page filter criteria contained the phrase “computer programmer” and that is the phrase that matched the content of the search page then “computer programmer” would appear in the column “page filter criteria” for the specific row dedicated to that URL address. The “email” column would display the found and stored email address in cases where “email addresses” was selected by the operator during Step 1285.

At Step 1325 FIG. 3A, apparatus downloads content and conducts comparisons. The apparatus “visits” the web sites corresponding to each URL collected and qualified in previous steps and in later steps. A “visit” encompasses, but is not limited to, the apparatus computer via its Internet connection communicating with the Internet site server of the corresponding URL address and locating the file, generally composed of HTML code and body text, specified by the URL address. The contents of that HTML and body text file are then downloaded, via the Internet connection, into the computer memory and or mass storage device and stored in such a format such as ASCII or as normal protocol at the time, so as to be “read” by the computer for the purpose of comparing the content using methods described in the following steps based on criteria entered in previous steps. In other word, the apparatus will visit the site located at each URL returned during previous steps, download the content of the sites and “read” the content of the site and decide if it matches the link qualifying criteria or the page qualifying criteria so that actions can be taken as described in the following steps.

At Step 1330 FIG. 3A, apparatus collects URL addresses contained in HTML statements commonly called “Hyperlinks” and generally referenced with the command suffix “HREF=” for only those visited website pages that match the link qualifying criteria entered during Step 1220. For the content of each page downloaded, as described in Step 1325 the apparatus searches the content for character combinations, words, phrases and/or word and phrase combinations that match the link qualifying criteria entered during Step 1220 and if a “match” is identified then the content is searched for hyperlinks and those hyperlinks are stored in a table located in the memory or mass storage of the computer part of the apparatus. A “hyperlink” is the common Internet terminology for a word or set of words that, through the use of HTML code, can designate a specific URL or other Internet address on the same server or another server on the Internet. Hyperlinks are generally referenced with the HTML command “HREF=”. The hyperlinks are stored in the format of URL address in a table along with other hyperlinks collected in previous steps and later steps so that as threads become available to the process those URL addresses can be visited and the apparatus will conduct Steps 1310 and following steps to the content those pages.

At Step 1340 FIG. 3A, if during Step 1290 “Email Addresses” was selected, then the apparatus collects and stores email addresses that are located in the text content of the downloaded page for only those visited website pages that match the page qualifying criteria entered during Step 1225. The apparatus searches the content of every page downloaded in Step 1325 for matching characters, words, phrases or combinations of words and phrases as entered during Step 1225 as page qualifying criteria If a “match” is found and if during Step 1290 “email addresses” was selected then the apparatus searches the content for sets of characters where such a pattern exists that there are a set of ASCII or text characters before and after a “@” and bordered by space characters. In other words, the apparatus searches the content for email addresses. Any email addresses found are stored in a table in the memory or mass storage device of the computer that composes part of the apparatus.

At Step 1345 FIG. 3A, if during Step 1290, “Pages as HTML” was selected, then the apparatus collects and stores the entire HTML code file of the downloaded page for only those visited website pages that match the page qualifying criteria entered during Step 1225. The apparatus searches the content of every page downloaded in Step 1325 for matching characters, words, phrases or combinations of words and phrases as entered during Step 1225 as page qualifying criteria. If a “match” is found and if during Step 1290 “Pages as HTML” was selected then the apparatus collects and stores the entire HTML code file of the downloaded page for only those visited website pages that match the page qualifying criteria entered during Step 1225.

At Step 1350 FIG. 3A, if during Step 1290, “Pages as Text” was selected, then the apparatus collects and stores the entire body text of the downloaded page for only those visited website pages that match the page qualifying criteria entered during Step 1225. The apparatus searches the content of every page downloaded in Step 1325 for matching characters, words, phrases or combinations of words and phrases as entered during Step 1225 as page qualifying criteria. If a “match” is found and if during Step 1290 “Pages as Text” was selected then the apparatus collects and stores the entire body text of the downloaded page for only those visited website pages that match the page qualifying criteria entered during Step 1225.

At Step 1355 FIG. 3A, if “Pages as HTML or “Pages as Text” are selected in Step 1290, then each “matching” page is stored as a file onto a mass storage device, such as the hard drive, in a desirable format such as HTML or ASCII and contact information is “normalized”. For the purpose of the discussion of our invention the word “normalize” and its derivations mean that a piece of information is identified as belonging to an operator determined class or category such as Name, Street Address, City, State, Postal Code, Voice Phone, Fax Phone or Email Address. The purpose of “normalizing” the data is to allow for the storage of the collected information into a database so that specific operator determined classes or categories could be easily searched, sorted and reported. For example, the total universe of data collected over a period of time might consist of ten million resumes. A search for the word “Jersey” against the entire text of the ten million database resume records might turn up records that describe people involved in the manufacture of Jerseys, people who grow Jersey Tomatoes, and people who are Bruce Springsteen fans. A search for the word “Jersey” against the State field of the ten million database resume records would only turn up records of people who live in New Jersey.

Pattern Analysis Algorithms

Each file is analyzed at a time determined to be effective and convenient by the operator using an application program that resides on the computer that harvested the document or another computer as may be desired in our invention. An application software program compares the text of each stored page with known “patterns” that would indicate the likelihood of a set of characters, or a set of words or a set of phrases to be a specific piece of desired contact information such as Name, Street Address, City, State, Postal Code, Voice Phone, Facsimile Phone, and Email Address. For example, the application program developed by we and used by our preferred embodiment of our invention uses the following pattern comparisons to isolate likely phone numbers. Where “#” res any ASCII character that re the digits 0 through 9 then:

Pattern Variables

0=(###) ###-####

1=###.###.####

2=###-###-####

3=(###)###-####

4=(###)### ####

5=(###)-###-####

6=(###) ### ####

7=(###).###.####

8=### ### ####

9=### ###-####

10=###-### ####

11=### - ### - ####

12=(###) ### - ####

Upon locating a “phone number” pattern, the application program developed by we and used by our preferred embodiment of our invention searches an operator specified number of characters before the located pattern and searches for a match to one of the following “modifiers” and assigns the “phone number” to one of three possible database record fields: Home, Office or Fax. It is important to note that this is an example only based on our notion of important contact information to normalize and based on our notion of modifiers that would appropriately identify the patterns. Other operators could decide on a different set of Pattern Variables and Modifiers in order that the system organize the data in a manner more suitable to the expected end use.

[Modifier]

Home=Home

Home=home

Fax=Fax

Fax=fax

Office=Office

Office=office

Home=ho:

Home=Ho:

Home=H:

Home=Voice

Home=voice

Office=work

Office=Work

Office=W:

Office=w:

Fax=Fx

Fax=fx

Fax=F:

Fax=f:

Fax=Facsimile

Fax=facsimile

Office=wrk

Office=WRK

Fax=FAX

Home=HOME

Home=HM

Office=OFF

Office=Off

Office=O:

Office=WORK

Home=phone

Home=VOICE

Home=HOME PHONE

Office=Work Phone

Home=Call

Home=call

Home=Phone

Home=Ph

Office=(o)

Fax=(f)

One embodiment of our invention does not use an application program to isolate patterns and normalize the operator determined contact information but instead requires an operator, using a general purpose computer, monitor and keyboard equipped with an editor application program, such as but not limited to Microsoft Word, to view the content of each harvested and stored document and isolate the operator determined contact information and “copy and paste” that information to a predetermined location on the document which shall be described in more detail in following steps.

At step 1360 FIG. 3A, normalized documents are imported into a database. There are many database application programs available to be purchased and installed on any assortment of general purpose computers equipped with any combination of Microprocessors, mass storage device and memory configurations, monitors and keyboards. For the purpose of integration into our invention, said software can be operated on an assortment of operating systems. Whatever the case, in order to operate successfully as part of our invention the application software must be capable of importing records from the very minimum an ASCII text file and be capable of storing and normalized information into operator specified fields and creating indexes or pointers or other programming methods that would allow for the rapid search and retrieval of records.

Our preferred embodiment of the part of the apparatus used in this step consists of a Compaq Proliant 30005/300 128mb, 512k cache server equipped with a 10/100 base T NIC Ethernet interface card and 3-9.1 gb w-ultra SCSI-3 hard drives and Compaq V50 color monitor and a Smart Array controller and a 24 gigabyte DAT backup tape drive and a SCO Unix operating system. This server is connected to other computers that form part of our invention via a Netelligent 24 port 10 base T hub. The database application software installed on this server was developed and is sold by Bond International Software (London, England) and is known as Adapt V.8.6 Software. Methods for building large databases such as that reed by element 472 FIG. 14 are well known to those with ordinary skill in the art as demonstrated by the attached documents: 16. Bond International Software, PLC., Application Design Manual Version 8.7, August 2001, 467 pages; 12. IBM Corporation International Technical Support Organization, Building VLDB(very Large DataBases) for BI (Business Intelligence) Applications on OS/390: Case Study Experiences, January 2000; 10. Offer Drori, Using an Information Reduction Model in Hypertext Virtual Node as a Direction for Solving the Data Explosion Problem, Offer Drori, October 1995, 8 pages and 11. Ya^{o}ar Tonta, Indexing in hypertext databases., Ya^{o}ar Tonta, 1992, 6 pages.

In our preferred embodiment of our invention, data is organized into the upper left hand corner of each harvested document as it appears on the computer monitor where the first line is reserved for the name the second line is reserved for he street address, the third line is reserved for the city followed by a “comma” followed by the state followed by the postal code. The fourth line is reserved for the voice telephone number, the fifth line is reserved for the work telephone number, the sixth line is reserved for the fax telephone number and the seventh line is reserved for the email address. It is important to note that this order may be changed or that classes or categories of information may be deleted or added. Once the desired contact information is located and listed in the organizing format as described above, then it is considered “normalized”.

In our invention, data is organized into the upper left hand corner of each harvested document as it appears on the computer monitor using the “copy” and “paste” commands of the “Microsoft Word” word-processing application program. However, any text editor or word-processing application may be used. If the selected text editor or word-processing application provides for pattern recognition macros, plug-ins or other application add-ons, then such pattern recognition devices or methods may be used to identify, locate and move contact information into the upper left of the text document or otherwise into a desirable field in a storage or memory array, table or database.

On our preferred embodiment of our invention, the Adapt Database Software is activated and the import instruction is issued and the document is imported by the Adapt Database Software into the database whereby the normalized contact information is imported into the appropriate designated fields. The import step is conducted for every document harvested. This step may be accomplished using database software other than Adapt (such as Resumix) and the import step would be customized to fit the requirements of the given database product in use.

At Step 1365 FIG. 3A, database is indexed. Depending on the database design and the features of the database application program selected for the apparatus, the indexing of the data can take place as each record is imported and stored or in a batch at a later time. The specific commands, which must be issued, to cause the indexing step would be specific to the application software and computer configuration selected for the apparatus. In our preferred embodiment of our invention, records are indexed overnight as a batch based on an automated command that is executed by the operating system at 2:00a.m every day.

At Step 1370 FIG. 3A, records reported. If our invention is operated on a daily basis, it can be expected that the number of records collected and stored into the database will increase continually. At any point in time, for whatever reason, when the need arises to contact a specific group of individuals based on prior professional experiences as recorded on their resume or other data that may be recorded on their resume, the database may be accessed and information reported. For example, one may wish to contact programmers of “Peoplesoft Software”. One method that might be used is to search the database for all records whose text contains the words Peoplesoft and Computer Programmer or Peoplesoft and Programmer or Peoplesoft and Software. Using commands specific to the application software selected for use with our invention, the operator could instruct the apparatus to isolate the records and report them to a printer in a format that is standard for Avery labels thus printing out individual labels containing the name, street address, city state and zip code for those individuals so that a post card or letter could be mailed to those individuals communicating whatever message is desired.

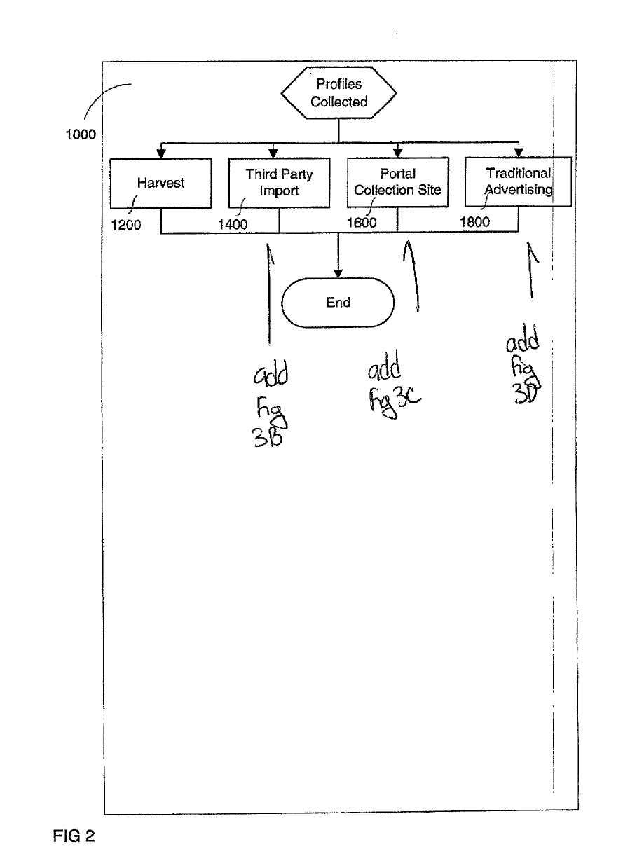

Another example could report the home telephone numbers of the selected records to an electronic file that could later be displayed on the computer monitor of a telemarketing prospector. Another example could be a report of the email addresses, which could be exported to an emailing program so that a help-wanted advertisement could be sent via email to those individuals that have relevant background reed on heir resume. At Step 1400 FIG. 2 and FIG. 3B, information on prospective contacts is collected and normalized using a combination of Steps 1410 through 1430 FIG. 3B. At Step 1410 FIG. 3B, operator of the system defines, locates and acquires desirable collections of information on prospective contacts from the many organizations such as employment agencies, Internet job hunter websites, newsgroups which supply, generally for a fee, professional profile record in a format that can be easily imported into a database or normalized as described later in Steps 2000 through 2140. At Step 1420 FIG. 3B, the system normalizes data collected in Step 1410 FIG. 3B to our invention's standards using the systems described later in Steps 2000 through 2140. At Step 1430 FIG. 3B, the system stores the information on prospective contacts that was normalized in Step 1420 FIG. 3B into a computer storage device using the systems described later in Steps 3000 through 3060 FIG. 5.

Steps 1600 et seq.

At Step 1600 FIG. 2 and FIG. 3C, a professional profile Collection Device, in the form of a server software program, is placed on Internet community web portals such as demonstrated by element 800 in 0. Using the professional profile Collection Device, individual visitors to the Internet community web portals submit their resumes, curriculum vitae, professional profiles, job applications, biographies or other format in which a career biographies might exist using an interface such as that demonstrated in FIG. 39 and FIG. 39A so that they are ultimately stored in the Contact Database shown as Element 472 of FIG. 14 and shown in FIG. 17.

At Step 1610 FIG. 3C, the system searches for websites that could serve as professional profile collection points and contacts the operators of desirable sites and reaches an agreement to install and maintain a professional profile collection device, in the form of a server software program, as demonstrated by element 800 in 0 and FIG. 39 and FIG. 39A. A reward provided to third party website owners by the invention for profiles submitted from websites supporting our invention's professional profile collection points provides an incentive for operators and owners of websites to install the professional profile collection point software on their website. professional profiles are tagged by our invention's professional profile collection point software with an identification code reing the website via which it was submitted. That code is stored in a field in the Contact Database allowing for easy tabulation of submissions.

At Step 1620 FIG. 3C, the system installs and maintains a professional profile Collection Device, in the form of a server software program, as demonstrated by element 800 in 0 and FIGS. 39 and 39A. Then, at Step 1630 FIG. 3C, professional profiles are submitted to professional profile Collection Devices posted on websites when visitors click on a button or hyperlink object such as that demonstrated by element 800 0 and are then invited to fill a computer interface displayed form such as that demonstrated in FIGS. 39 and 39A. Then, at Step 1640 FIG. 3C, professional profiles arrive at a collection point element 472 of FIG. 14 where they are stored in the Contact Database element 472 FIG. 14 in a computer storage device. Their need not be a normalizing step in the sequence from Step 1600 through 1640 since the form at FIGS. 39 and 39A may be designed to force input of data into fields as standardized by the system administrator of the system. For example, the professional profile Collection Device server software can be programmed to parse the name field element 863 FIG. 39 into first name and last name using code that is known in the Art or, the professional profile Collection Device server software can be programmed to configure the form at FIG. 39 to input first name and last name as separate entry fields instead of one name field The form components of FIG. 39 should be configured such that the input fields match the contact information fields in the Contact Database at element 472 FIG. 14 which are dependent on the fields that shall be used in the different layouts as described in Steps 10000 through 10035 FIG. 6 and their possible variations.

Steps 1800 et seq.

At Step 1800 FIG. 2 and FIG. 3D, advertisements are placed in traditional help wanted advertising media such as newspapers, magazines, job websites, and trade journals. Prospective Contacts respond to the advertisements by mailing, faxing, submitting via website such as in FIG. 40, FIG. 39 and FIG. 39A or emailing their professional profiles, resumes, curriculum vitae, job applications, biographies or other format in which a career biographies might exist so that it they are ultimately stored in the Contact Database shown as Element 472 of FIG. 14 and shown in FIG. 17.

At Step 1810 FIG. 3D, the system determines the types of prospects that shall be needed for future advertising and what employment positions those types of contacts might hold Then, at Step 1820 FIG. 3D, the system places advertisements in traditional help wanted advertising media such as newspapers, magazines, job websites, and trade journals. At Step 1830 FIG. 3D, Prospective Contacts respond to the advertisements placed in Step 1820 FIG. 3D by mailing, faxing, submitting via website such as in FIG. 40, FIG. 39 and FIG. 39A or emailing their professional profiles, resumes, curriculum vitae, job applications, biographies or other format in which a career biographies might exist and they are stored at a collection point element 471 of FIG. 14 until later steps when they are normalized and stored in the Contact Database element 472 FIG. 14.

At Step 1840 FIG. 3D, the system normalizes data collected in Step 1830 FIG. 3D to our invention's standards using the systems described later in Steps 2000 through 2140. Then, at Step 1850 FIG. 3D, the system stores the information on prospective contacts that was normalized in Step 1840 FIG. 3D into a computer storage device demonstrated as the element 472 FIG. 14 using the systems described later in Steps 3000 through 3060 FIG. 5.

At Step 2000 professional profiles are “Normalized”. As used in this patent application for describing our invention, “Normalizing” means converting data into a uniform format for a database. Our invention normalizes contact information such as Name, Street Address, City, State, Postal Code, Telephone Numbers and Email Address and normalizes content information such as a prospect's practical, academic, and corporate experience; cover letters, forms or other communication indicating the prospects preferences, objectives or goals; publications, documents; and testimonial or reference documentation.

The content information most valuable to our invention's professional profile database is that which specifically refers to a candidate's practical, academic, and corporate experience; cover letters, forms or other communication indicating the candidates preferences, objectives or goals; publications, ation documents; and testimonial or reference documentation. One of the objectives of normalization can be to remove non-relevant content information such as advertisement headers and third party information and objects such as pictures and tables. The advantage to this is to save data storage space from being used to hold data that is not used by our invention.

Our invention receives resumes, curriculum vitas, professional profiles and other forms of contact records from many different sources, using many different formats and uniquely readable by different application programs. Sources of professional profiles can include, but not be limited to: our invention's harvesting method [FIGS. 3, 3A] [1200]; professional profiles harvested by publiclly available professional profile harvesting web spidering systems and implemented by the operator of our invention, professional profiles received by postal mail, electronic mail hand delivery, facsimile machine or other method as may exist as a consequence implementation of step 1400 FIG. 2 and FIG. 3B, step 1600 FIG. 2 and FIG. 3C, 1800 FIG. 2 and FIG. 3D, or other method as may exist and be implemented by the operator of our invention; by individual candidates, resumes e-mailed by search agents services, downloads from subscriber databases, responses to other forms of prospecting that may exist or come to exist.

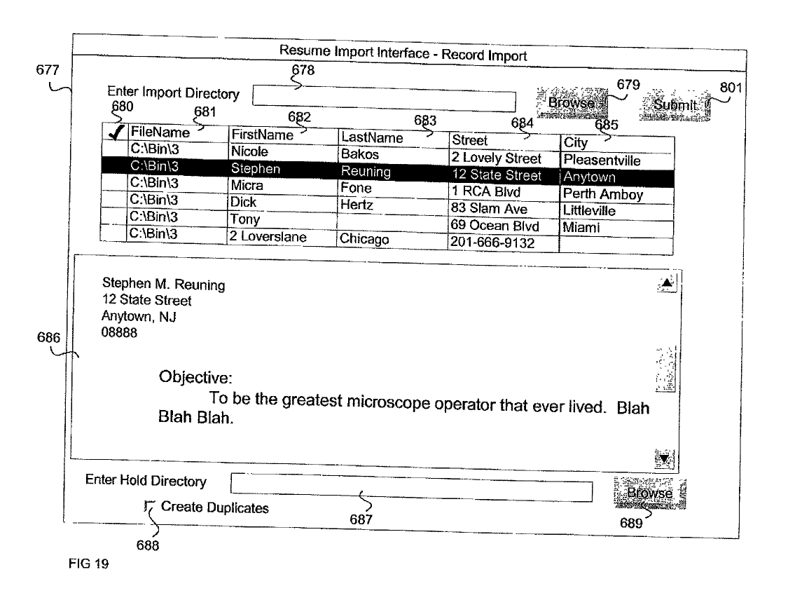

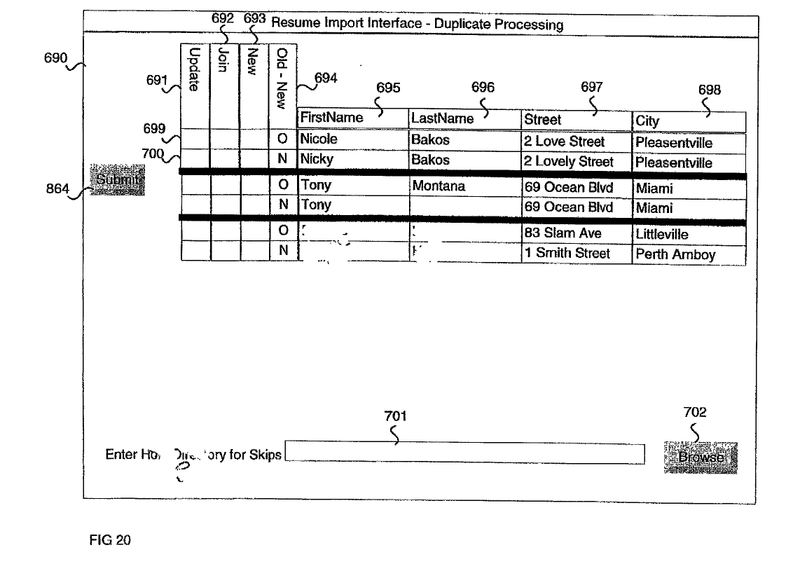

For proper importation of field specific data, the Resume Import software installed at element 472 FIG. 14 and the workstation(s) at element 471 FIG. 14, which interface is demonstrated in FIG. 19, requires that contact information be positioned at the upper left on the first page of import documents m a specific order and delimited as shown in samples in FIGS. 18 and 18A. professional profiles in all their forms and associated documents received from different sources do not always display contact information in the upper left position, nor necessarily together in the document, nor within a single source document nor in the appropriate order. Often, a prospective contact's name is located in one place, his address in another and her telephone numbers in yet another place. In some cases, the contact information is spread through several different documents, which are normalized into one by the system. Operators of the system normalize the resumes by locating all contact information within the text of received documents and copying and pasting that information into the upper left position of a single normalized document in the appropriate order.

Some sources provide resumes containing undesirable graphics, headers, or other nonprofessional experience related text. The system may further normalize the resumes by removing such content.

Professional profiles, in all their forms, are created and stored in many different software application formats. These formats are designated by file extensions, which are generally the last three letters of a filename following a dot For example, “johns_resume.txt.”, in which case “.txt” is the file extension indicating that the file a stored as an ASCII document which may be opened by almost any type of computer application software such as Microsoft Word or Microsoft notepad In the invention, the system further normalize the resumes by converting them to a file format known as “Rich Text Format” designated by the “.rtf” file extension. The following are typical file extensions and their corresponding software application source. .doc=MSWord Document; .htm=HTML/Internet Browser Document; .pdf=Adobe Acrobat Reader; .zip=Compressed Format Winzip or Pkzip.

As those skilled in the Art know, importing is a technique used to enter data into a computer database. One method of entering data into a database comprises typing the data directly into a computer interface. This method could be used to enter resumes into the Contact database. However, the professional profile in all their forms in most cases have already been typed once by their producer and it does not make sense to do that work over again. Instead, the system use a technique known by those skilled in the Art as “importing”. Most database software, including the ADAPT database application software used in the invention, provides a facility for importing During the import phase, the system causes the contact information to be located on an import document and placed in the appropriate record fields of the database and the content information placed into the appropriate indexed content information field of the Contact Database system.

Normalization—Manual

At Step 2010 the system chooses a method for normalizing professional profiles that is called “Semi-manual” because it involves a large amount operator intervention as compared to the “Automated” method described in Step 2100. The semi-manual method takes place in Steps 2010 through 2055. At Step 2015 the system uses a computer workstation demonstrated by element 475 FIG. 14 equipped with word-processing application software such as Microsoft Word and other applications capable of reading the generally accepted and conventionally used file formats used by the general public and individuals to publish and deliver resumes and other forms of professional profiles and opens files collected in Steps 1000 through Steps 1999 FIG. 1, FIG. 2, FIG. 3, FIG. 3A, FIG. 3B, FIG. 3C, and FIG. 3D for viewing and manipulation on the computer display. During Step 2015 the operator of the system opens a professional profile document that was collected in a previous step.

At Step 2020 the system reviews the document opened in Step 2015 for special conditions. professional profile documents, in all their forms, are received in many different formats. Most are fairly standard such that one resume is contained in a single document and the contact information is located at the top of the document followed by a standard resume format. However, there are special conditions, which require more complex processing and special attention. For example, some sources, such as resume submission agents, regularly submit multi-resume documents. In a different example, Steps 1200 through 1370 often collect and store HTML based professional profiles with hyperlink to contact information and separate parts of resumes. The discussion herein attempts to standardize procedures but operators of the system must stay keep aware of changing conditions and adjust to changing circumstances.

At Step 2025 the system selects all relevant content information copy in the message window opened during Step 2015 and uses the copy command to load the selected text into memory. Then, at Step 2030 the system uses the paste special unformatted text command of Microsoft Word (or similar command in another word-processing application) to place text into Info_Coord_ResumeTemplate.dot (opened in word-processing application during previous step).

In the invention, a special type of document, known by those skilled in the Art as a “template”, stores special macros, which are activated by pressing function keys. A specific template created for the system is called the “Info Coord Resume Template.dot” stores the macros that are used to normalize professional profiles, in all their forms. A copy of that template must be stored in each system administrator's login's Template folder. The path varies slightly from one MS Operating System to another. The template is used so certain function keys can be used as shortcuts for complex procedures. The invention uses the following shortcuts F2=Paste Special and Reset Document Font to Normal, Times, 12pt, F3=Paste DMC Stamp, F12=Save as rtf. The code within the Info_Coord_Template.dot file of the invention is as follows.

```
Sub pastespecial()
′
′ pastespecial Macro
′ Macro recorded 4/4/01 by scanner4
′
  Selection.Find.ClearFormatting
  With Selection.Find
```

.Text = “** Received by Die”
.Replacement.Text =“”
.Forward = True
.Wrap = wdFindContinue
.Format = False
.MatchCase = False
.MatchWholeWord = False
.MatchWildcards = False
.MatchSoundsLike = False
.MatchAllWordForms = False

```
  End With
  Selection.Find.Execute
  Selection.MoveDown Unit:=wdLine, Count:=3
  Selection.pastespecial Link:=False, DataType:=wdPasteText,
```

Placement:=_{—wdInLine, DisplayAsIcon:=False}

```
  Selection.Find.ClearFormatting
  With Selection.Find
```

.Text = “** Received by Die”
.Replacement.Text = “”
.Forward = True
.Wrap = wdFindContinue
.Format = False
.MatchCase = False
.MatchWholeWord = False
.MatchWildcards = False
.MatchSoundsLike = False
.MatchAllWordForms = False

```
  End With
  Selection.Find.Execute
  Selection.MoveDown Unit:=wdLine, Count:=2
  Selection.TypeParagraph
  Selection.MoveUp Unit:=wdLine, Count:=1
  Selection.WholeStory
  Selection.Style = ActiveDocument.Styles(“Normal”)
  Selection.FontName = “Times New Roman”
  Selection.FontName = “Times New Roman”
  Selection.Font.Size = 12
  Selection.Find.ClearFormatting
  With SelectionFind
```

.Text = “** Received by Die”
.Replacement.Text = “”
.Forward = True
.Wrap = wdFindAsk
.Format = False
.MatchCase = False
.MatchWholeWord = False
.MatchWildcards = False
.MatchSoundsLike = False
.MatchAllWordForms = False

```
  End With
  Selection.Find.Execute
  Selection.MoveDown Unit:=wdLine, Count:=2
  Selection.TypeParagraph
  Selection.TypeParagraph
  Selection.MoveUp Unit:=wdLine, Count:=1
End Sub
Sub saveasrtf()
′
′ saveasrtf Macro
′ Macro recorded 4/6/01 by scanner4
′
  Selection.GoTo What:=wdGoToLine, Which:=wdGoToFirst, Count:=1,
  Name:=“”
  Selection.FindClearFormatting
  With Selection.Find
```

.Text = “ **Received by Die”
.ReplacementText = “”
.Forward = True
.Wrap = wdFindContinue
.Format = False
.MatchCase = False
.MatchWholeWord = False
.MatchWildcards = False
.MatchSoundsLike = False
.MatchAllWordForms = False

```
  End With
  Selection.EndKey Unit:=wdLine, Extend:=wdExtend
  Selection.Copy
  ActiveDocument.SaveAs
EndSub
Sub pastedmcstamp()
′
′ pastedmcstamp Macro
′ Macro recorded 4/10/01 by scanner4
′
  Selection.TypeParagraph
  Selection.TypeParagraph
  Selection.TypeText Text:=_{—}
```

“********** Received by Diedre Moire Corporation, Inc. *******”

```
  Selection.TypeText Text:=“*****”
  Selection.TypeParagraph
  Selection.TypeText Text:=_{—}
```

“**********Proprietary Information ***************”

```
  Selection.MoveLeft Unit:=wdCharacter, Count:=40
  Selection.TypeText Text:=“*******”
  Selection.MoveRight Unit:=wdCharacter, Count:=40
  Selection.TypeText Text:=“******”
  Selection.TypeParagraph
  Selection.TypeParagraph
End Sub
```

Step 2035

At Step 2035 the system revisits the document opened in Step 2015. If contains attachments then the operator opens the attachment, if not the operator closes and deletes the document. If a new document is opened during this step then the operator returns to Step 2025 and continues the procedure on the newly opened document Then, at Step 2040 the system inspects all Headers or Footers for contact information. If yes, then the operator shall copy then paste special unformatted text into Info_Coord_ResumeTemplate.dot (opened in word-processing application during a previous step). At Step 2045 the system removes advertisements and non-prospect related information.

At Step 2050 the system copies and pastes contact information into top left of document in the standard delimited format as in FIG. 18 and FIG. 18A. Then, at Step 2055 the system saves the normalized document to a subdirectory on a computerized storage device where it shall await importation during Step 3000 FIG. 1. At Step 2100 the system chooses a method for normalizing professional profiles that is called “Automated” because it involves a smaller amount of operator intervention as compared to the “Semimanual” method described in Step 2010 through 2055. The automated method takes place in Steps 2100 through 2140.

Normalization—Automatic

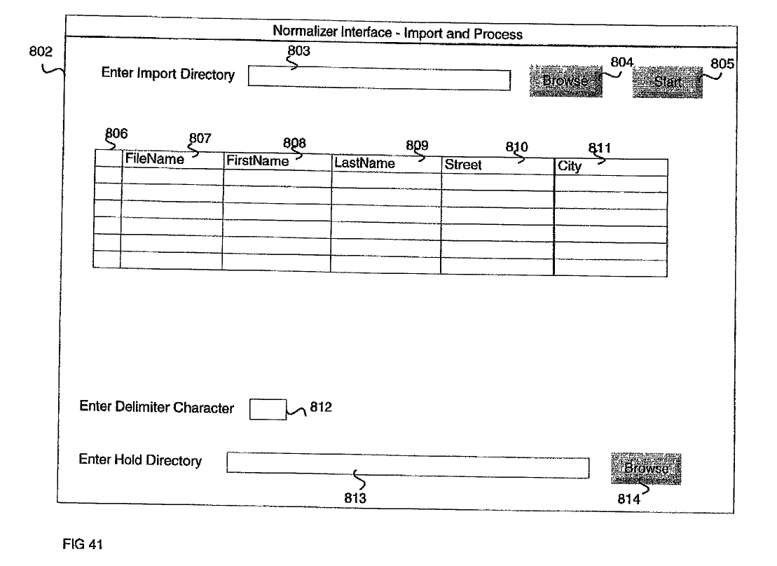

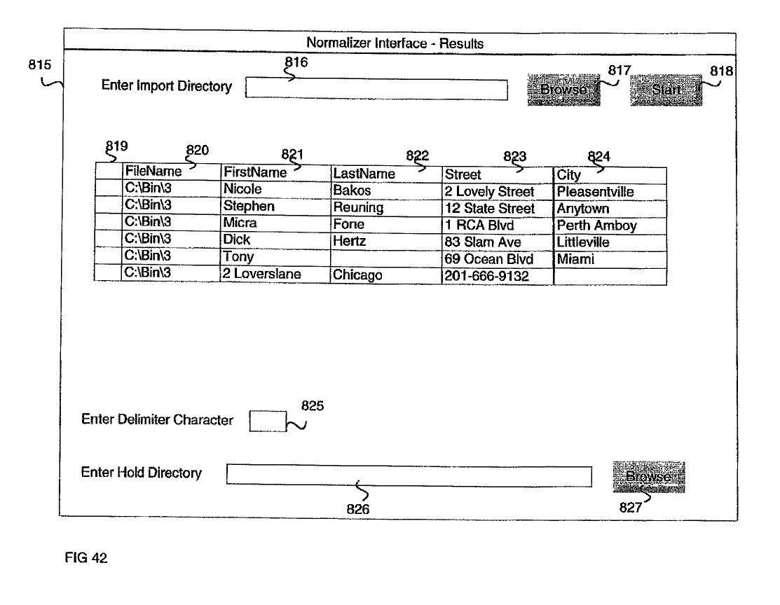

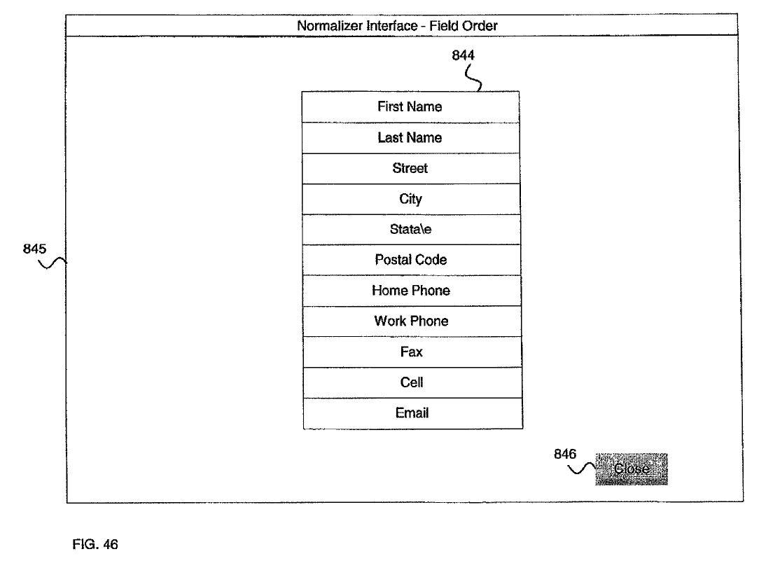

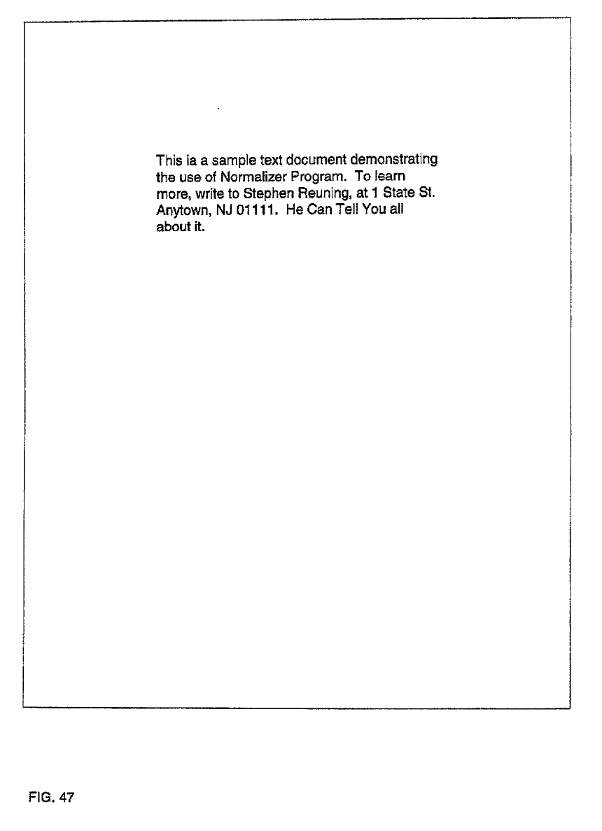

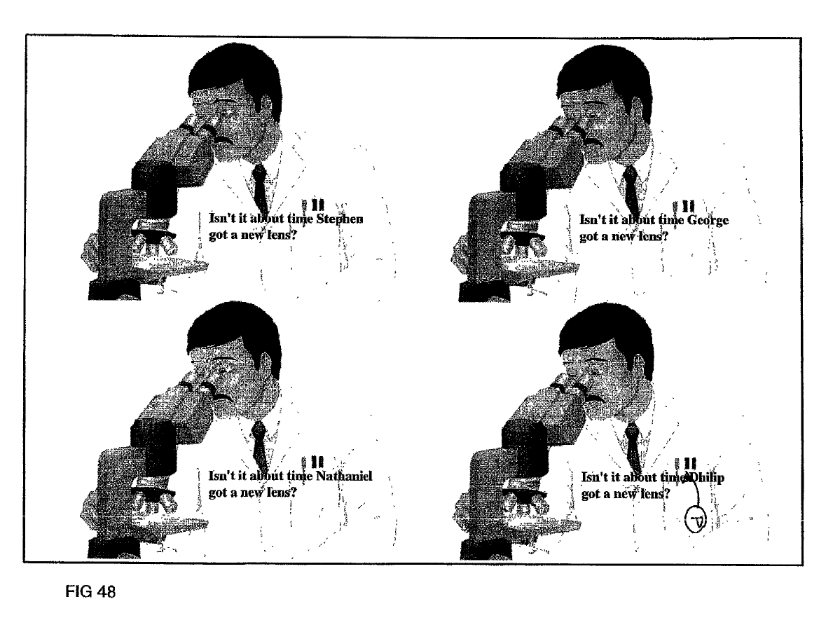

At Step 2105 the system adjusts preferences and options in the Normalizer Program FIGS. 41 through 46. The Normalizer Program is written in C+ however no particular programming language has been indicated for carrying out the various tasks described herein because it is considered that the operation, steps, and procedures described in the specification and illustrated in the accompanying drawings are sufficiently disclosed to permit one of ordinary skill in the art to practice the instant invention including the Normalizer Program. The Normalizer Program searches the text of all sorts of documents such as those reed by the file extensions: .htm, .doc, .txt, .rtf, etc., which those skilled in the art would understand to define document types and their associated application programs, and identifies and parses contact information such as those listed in the table in 6. There are many versions of parsing software commercially available and, while none known by the inventor perform the intelligent identification of non-tagged contact information as our invention's Normalizer Program does, some may be substituted for the Normalizer Program into the system, especially in the case of importing pre-tagged or field delimited contact information and professional profiles. The following are examples of “non-tagged” and “tagged” contact information.

Non-tagged:

Stephen Reuning

1 State St.

Anytown, N.J.

Tagged:

First Name: Stephen

Last Name: Reuning

Street: 1 State St.

City:Anytown

State: N.J.

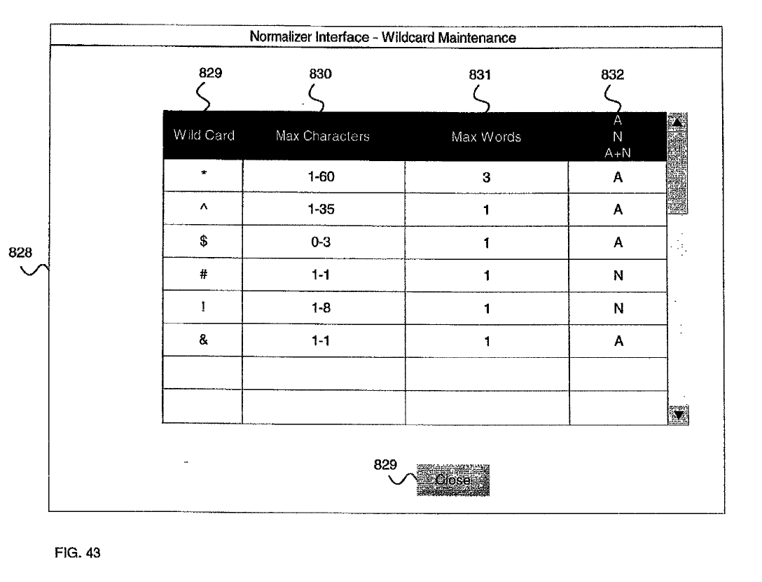

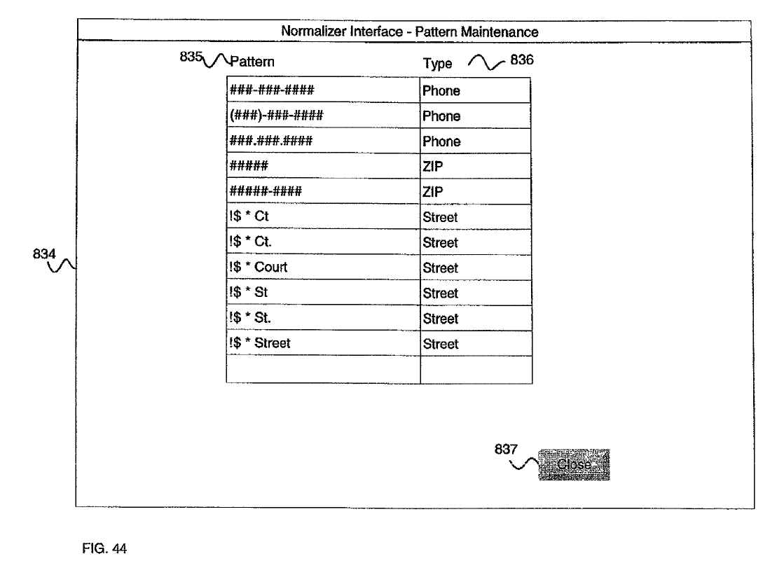

At Step 2105 the system adjusts preferences and options in the Normalizer Program by entering the Nomalizer Program Wildcard Maintenance computer software interface FIG. 43 where the operator sets parameters for wild card symbols that shall be used later when entering patterns in the Normailizer Program Pattern Maintenance computer software interface FIG. 44 and ultimately by the Normalizer Program to compare character sets in text files with patterns stored in its Pattern Table as in 4. Referring to 3, for illustration purposes, six wildcard variables are declared by the operator. The Wild Card column element 829 3 indicates the wild card character declared. The Max Characters column element 830 3 indicates the maximum number of characters that may be matched to the wild card declared. The Max Words column element 831 3 indicates the maximum number of words within the maximum number of characters set in element 830 that may be matched to the wild card declared. The A N A&N column element 832 3 indicates the whether the string of characters reed by the wild card are limited to alpha, numeric or alpha and numeric that may be matched to the wild card declared In a later step, when the Normalizer Program reads and compares character sets, the beginning of a character set is recognizable by a space character, a space and quote character, or by the fact that it is the beginning of a new line or paragraph while the end of a character set is recognizable by a space or a punctuation mark and space such as a period followed by a space or a comma followed by a space or a question mark followed by a space. Other characters and symbols may be added to define the beginning and end of character sets as necessary. Character sets can be compared to patterns element 835 set up during Step 2105 using the Normalizer Program Pattern Maintenance Interface 4 and identified as a type element 836 4. For example, if the document opened during Step 2115 by the Normalizer Program were the document demonstrated in 7, then the address “1 State St.” would be located within the text and identified to be parsed as “Street” because it matched the pattern (!$ * St) listed in row 10 Pattern column element 835 of the table shown in 4 and the corresponding type indicated in the Type column element 836 4 equals “Street”. It matches because the “!” wildcard character searches for a 1 to 8 character numeric set, the “$” wildcard character searches for a 0 to 3 character alpha set, the “*” wild card searches for a 1 to 60 character alpha set, and “St.” searches for its exact match.

At Step 2105 the system adjusts preferences and options in the Normalizer Program by entering the Nomalizer Program Pattern Maintenance computer software interface FIG. 44 where the operator sets parameters for patterns which shall be compared to character strings during Steps 2115 through 2130. Some samples of patterns that may be entered follow:

Type “Phone” Patterns

(###) ###-####

###.###.####

###-###-####

(###)###-####

(###)### ####

(###)-###-####

(###) ### ####

(###).###.####

### ### ####

### ###-####

###-### ####

### - ### - ####

(###) ### - ####

Type=“Name” Patterns

ˆ &.ˆ

^

^, III

^, Ph.d

ˆ &ˆ phd

^, Jr.

^, Sr.

^, Esq.

^, II

^, MD

Type “Street” Address Patterns

!$ * Ct

!$ * Ct.

!$ * Court

!$* St

!$ * St.

!$* Street

!$*Ave

!$* Ave.

!$ * Avenue

!$ * Blvd

!$ * Blvd.

!$ * Boulevard

!$ * Rd

!$ * Rd.

!$ * Road

!$ * Dr

!$ * Dr.

!$ * Drive

!$ * Ln

!$ * Ln.

!$ * Lane

!$ * Ste

!$ * Ste.

!$ * Suite

!$ * Pkway

!$ * Parkway

!$ * Pl

!$ * Pl.

!$ * Place

!$ * Cir

!$ * Cir.

!$ * Circle

!$ * Terr

!$ * Terr.

!$ * Terrance

!$ * Ctr

!$ * Ctr.

!$ * Center

!$ * Way

!$ * Walk

!$ * Hill

!$ * Sqr

!$ * Sqr.

!$ * Square

!$ * Row

!$ * Alley

Type=“ZIP” Postal Code Patterns

#####

#####-####

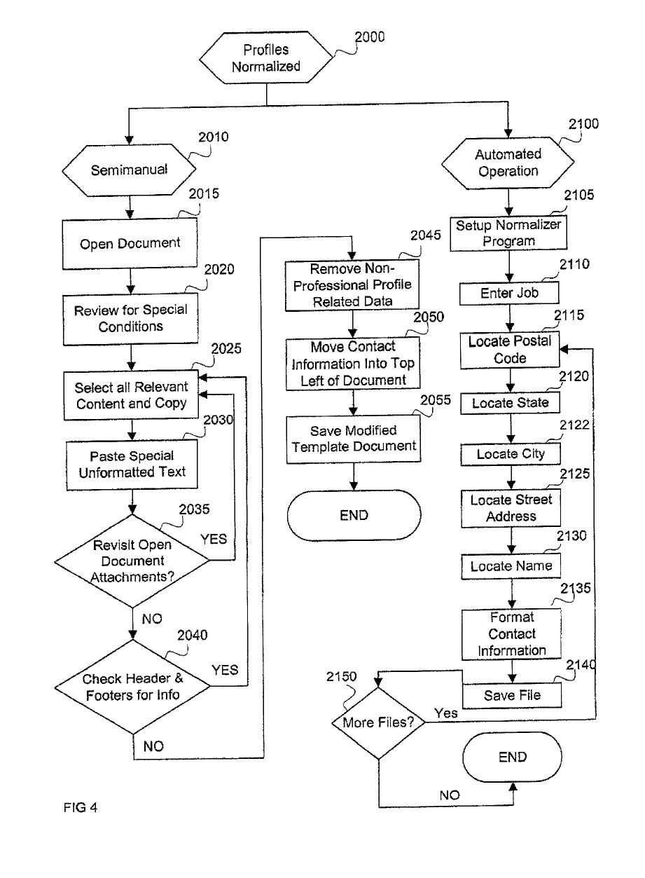

The pattern strings are input and reported in the Pattern column element 835 4 using the wildcards declared in Step 2105 FIG. 4 at the interface demonstrated in 3. By double clicking on a row in the table shown in 4 the operator may activate the update interface for the pattern reed by that row. By double clicking on an empty row in the table shown in 4 the operator may activate the input interface for the pattern reed by that row. The type column element 836 4 indicates what a character set matching the pattern shall be designated as and ultimately stored in an array or table in memory during Steps 2115 through 2130. For example, the pattern “!$ * Street” demonstrated in the bottom row of the table in 4 would match the following character set in a text document: “5A West First Street” and thusly that string would be designated as type=street since the Type designated in the pattern “!$ * Street” row is “Street” as shown in 4.

At Step 2105 the system adjusts preferences and options in the Normalizer Program by entering the Nomalizer Program Tag Maintenance computer software interface FIG. 44 where the operator sets parameters for tags which shall be compared to character strings during Steps 2115 through 2130. Some samples of patterns that may be entered follow:

Home Phone Number Tags

HOME

Home

home

HM

Ho:

ho:

H:

Call

call

PHONE

Phone

phone

Ph

VOICE

Voice

Voice

Fax Phone Number Tags

FAX

Fax

fax

Fx

fx

F:

f:

(f)

Facsimile

Facsimile:

Work Phone Number Tags

WORK

Work

work

w:

WRK

wrk

Office

office

(o)

OFF

Off

O:

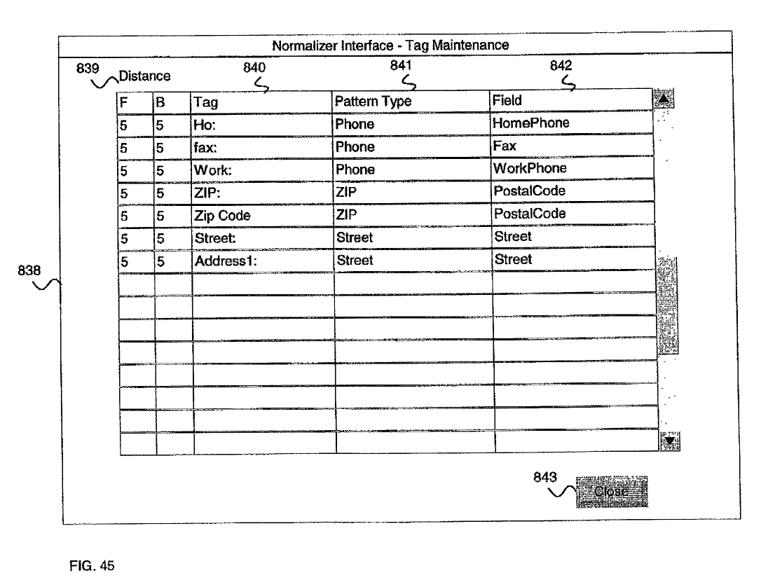

The tags are input and reported in the Tag column element 840 5. By double clicking on a row in the table shown in 5 the operator may activate the update interface for the tag reed by that row. By double clicking on an empty row in the table shown in 5 the operator may activate the input interface for the tag reed by that row. The Tag column element 840 5 functions to input and report character sets that will be used to seek matches during later steps 2110 through 2130 FIG. 4 as the Normalizer Program attempts to locate and identify specific contact information. The Pattern Type column element 841 FIG. 45 functions to input and report an identifier which refers to a type of pattern declared in Step 2105 using the Normalizer Program Pattern Maintenance interface 4, that shall correspond to the tag in the same row. The Field column element 842 5 functions to input and report the Field, such as one of those demonstrated in 6 that shall correspond to the tag in the same row. The Distance column element 839 5 is divided into two columns, one labeled as “F” for “forward” and the other labeled as “B” for “backward” functions to input and report the number of characters backward and forward that the corresponding tag (same row) must be to the pattern type designated in the Pattern Type column element 841 5 in order to be rated a “True” match under some of the conditions described in Steps 2110 through 2130 later in this document For example: The sixth row of the table in 5 for illustration purposes shows the following values: Distance F=5; Distance B=5; Tag=Street:; Pattern Type=Street; Field=Street. If, while executing Steps 2110 through 2130, the Normalizer Program locates a string of characters such as “Street: 1 State St.” then it shall relegate that string to the Street field and set the status as True because the string “Street:” is located within 5 characters of the string “1 State St.” and the string “1 State St.” matches the pattern set for illustration purposes (!$ * St.) in row 10 of the table shown in 4 and that pattern is designated to be “Street” in the Type column element 836 of 4.

At Step 2105 the system stores and imports Tag and Pattern profiles such that different tag and pattern collections can be applied to document from different sources.

At Step 2105 the system store into a table a list of known States and Provinces and their abbreviations.

In our invention, the object of Steps 2110 through 2130 is to locate and identify strings of characters reing contact information such as name, street address, city, state, zip code, etc. in documents of different varieties following different formats. In some cases, contact information will be tagged within documents with identifiers like “Home Address” and in other cases contact information will have no obvious identifiers such as the example demonstrated in 7. Since the process to identify contact information in documents with tagged contact information is simpler, the Nomalizer Program searches for tagged information first then follows with more complex logical decision making (described in the following paragraphs) in order to intelligently guess what might be contact information and then catalog it into fields. The following description of Steps 2110 through 2135 are for illustrative purposes since those of ordinary skill in the art will realize that the sequence of events and logical decisions could be modified to get the same or similar results.

At Step 2110 the system uses a computer workstation [471] equipped with application software programmed to identify contact information by recognizing patterns and parsing character sets into data fields (Normalizer Program) and using an interface such as the one demonstrated in 1 selects a directory on a computer storage device from which to import and normalize files.

At Step 2115 the Normalizer Program opens the first file of the directory submitted by the operator in Step 2110 FIG. 4 and searches for postal code patterns which were declared in Step 2105 using an interface like or similar to that demonstrated in FIG. 44 and, for each matching set of characters, stores them in a table or array in memory in the column reserved for postal code.

Step 2120 et seq.

At Step 2120 the Normalizer Program continues with the file opened in Step 2115 FIG. 4 searching for a string of characters bordered by space characters just before the location of the postal codes located in Step 2115 FIG. 4 and compares that string of characters to a set of known States or Provinces and, searches for a Tag and accompanying string of characters matching those designated in the Normalizer Program Tag Maintenance interface as a State Pattern Type and, in the case of locating a match sets the status column to the value “true” or in the case of failing to find a match sets the status column to the value “false” and stores the string in a table or array in memory in the column reserved for State in the row that corresponds to the Postal Code following directly and located and stored in Steps 2115.

At Step 2122 the Normalizer Program continues with the file opened in Step 2115 FIG. 4 searching for a string of characters bordered by space characters just before the location of the state string located in Step 2120 FIG. 4 and compares that string of characters to a set of known Cities and, searches for a Tag and accompanying string of characters matching those designated in the Normalizer Program Tag Maintenance interface as a City Pattern Type and, in the case of locating a match sets the status column to the value “true”, unless the status has already been set to false in an earlier step, or in the case of failing to find a match sets the status column to the value “false” and stores the string in a table or array in memory in the column reserved for City in the row that corresponds to the State or Province and Postal Code following directly and located and stored in Steps 2115 and 2120.

At Step 2125 the Normalizer Program continues with the file opened in Step 2115 searching for a string of characters ending with a space character and starting with an Integer where the string does not exceed sixty characters (this number can be adjusted) just before the location of the City string located in Step 2122 FIG. 4 and, searches for a Tag and accompanying string of characters matching those designated in the Normalizer Program Tag Maintenance interface as a Street Pattern Type and, in the case of a successful find, stores the string in a table or array in memory in the column reserved for Street in the row that corresponds to the City and State or Province and Postal Code following directly and located and stored in Steps 2115, 2120 and 2122.

At Step 2130 the Normalizer Program continues with the file opened in Step 2115 FIG. 4 searching for a string of characters bordered by space characters just before the location of the street string located in Step 2125 FIG. 4 and compares that string of characters to a set of known Last Names and, searches for a Tag and accompanying string of characters matching those designated in the Normalizer Program Tag Maintenance interface as a Name Pattern Type and, in the case of locating a match sets the status column to the value “true”, unless the status has already been set to false in an earlier step, or in the case of failing to find a match sets the status column to the value “false” and stores the string in a table or array in memory in the column reserved for Last Name in the row that corresponds to the Street Address, City and State or Province and Postal Code following directly and located and stored in Steps 2115, 2120,2122 and 2125.

Then, the Normalizer Program continues with the file opened in Step 2115 FIG. 4 searching for a string of characters bordered by space characters just before the location of the Last Name string located in the first part of Step 2130 FIG. 4 and compares that string of characters to a set of known First Names and, searches for a Tag and accompanying string of characters matching those designated in the Normalizer Program Tag Maintenance interface as a Name Pattern Type and, in the case of locating a match sets the status column to the value “true”, unless the status has already been set to false in this step or an earlier step, or in the case of failing to find a match sets the status column to the value “false” and stores the string in a table or array in memory in the column reserved for First Name in the row that corresponds to the Street Address, City and State or Province and Postal Code following directly and located and stored in Steps 2115, 2120, 2122 and 2125.

At Step 2135 the Normalizer Program continues with the file opened in Step 2115 FIG. 4 by preparing to store it as a text document with the data saved in a table or array in memory during Steps 2115 through 2130 with the delimiter selected using the element 812 FIG. 41 between each data field such that the file would display in a computer text window as shown in FIG. 18 if the delimiter character were a Return character or as shown in FIG. 18A if the delimiter character was a Tab character.

At Step 2140 the Normalizer Program continues with the file opened in Step 2115 FIG. 4 by storing it on a computer storage device as a text document with the data saved in a table or array in memory during Steps 2115 through 2130 with the delimiter selected using the element 812 FIG. 41 between each data field such that the file would display in a computer text window as shown in FIG. 18 if the delimiter character were a Return character or as shown in FIG. 18A if the delimiter character was a Tab character.

Update Data and Screen Redundancies

At Step 3000, the system imports the files saved in Step 2140 into the Contact Database [472]. At Step 3010, the system selects documents saved in Step 2140 using a resume import program which computer software interface is demonstrated in FIG. 19. The path to the storage directory where the selected documents are stored is entered [678]. At Step 3020, the system opens the files selected and parses the data fields. The parsed fields are stored in an array in memory and displayed [FIG. 19]. Row 2 of the table [680, 681, 682, 683, 684, and 685] shows how the delimited elements [704] are displayed in the Resume Import Interface.

At Step 3030, the system compares contact information from the files opened with contact information of records already stored in the Contact Database [472] and decides if it duplicates an already stored prospective contact record. If the record is a duplicate then our invention proceeds to Step 3040. If the record is not a duplicate, then our invention proceeds to Step 3050. At Step 3040, the system joins information from a file selected during Step 3010 with a record stored in the Contact Database [472]. In one embodiment, a Resume Import Program displays a Duplicate Processing interface which reports a table consisting of rows and columns [691, 692, 693, 694, 695, 696, 697 and 698] and displays rows where the row designated as “O” in the column [694] means the row has data from an “Old” record, ie., one that is already stored in the Contact Database and where the row designated as “N” in the column [694] means the row has data from an “New” record, ie., one that was selected for import during Step 3010. The contact information in the O row is compared against the information in the N row to decide to join the records or create a new record in the Contact Database for the document indicated by the N row. The operator can select “Update” [691], “Join” [692] or “New” [693] to indicate a decision. Selecting “Update” [691] changes the contact field information indicated in the O row to that in the N row on the record already stored in the Contact Database and to join the content information, such as that shown in element 686, to the content information field already stored as part of this individual prospective contact's record in the Contact Database.

Selecting “Join” [691] leaves the contact field information indicated in the O row unchanged in the Contact Database and joins the content information [e.g., 686] to the content information field already stored as part of this individual prospective contact's record in the Contact Database. Selecting “New” [691] instructs our invention system to create a new record in the Contact Database using the information from the file selected [3010]. If no selection is made from element 691, 692 or 693, then the document reed by the N row is stored in a “Hold” directory on a computer storage device as directed by the path entered [701]. A selection is entered by clicking in the selected column, displaying a check mark in the box and then clicking on the Submit button [864].

At Step 3050, the system, when no duplicate record is matched during Step 3030, creates a new prospective contact record for the file selected [3010] in the Contact Database element [472] and imports the information from a file selected [3010]. At Step 3060, the system checks for files not yet processed that were selected [3100], and executes Steps 3020 through 3050 for each not yet processed file.

Advertisement Submission

At Step 4000, new advertisers are entered into an Advertisement Submission Program database [575]. This may be dome using a computer software user interface [FIGS. 34A and 34B]. A media type is selected for processing in later steps based on input by an advertiser. At Step 4010, the Advertisement Submission Interface [575] is started and demonstrated by FIG. 34A.

An Advertisement Submission Program includes a database [FIG. 34] installed on a server [575] with user interfaces [FIGS. 34A, 34B, 34C, 34D-1, 34D-2, 34E, 34F, 34G, 34H, 34I, 34J, 34K, 34L, 34M, and 34N]. The Advertisement Submission Program implements the entry, update, storage, reading, sorting, importing, exporting, reporting and other manipulation of advertiser identity and contact information in the form of user records which are stored in a database structure such as that demonstrated by Table 1 [150]. An Advertisement Submission Program implements the entry, update, storage, reading, sorting, importing, exporting, reporting and other manipulation of advertisement submissions in the form of advertisement records which are stored in a database structure such as that demonstrated by Table 2 [151].

An Advertisement Submission Program implements the entry, update, storage, reading, sorting, importing, exporting, reporting and other manipulation of image records in the form of image records which are stored in a database structure such as that demonstrated by Table 3 [152]. An Advertisement Submission Program implements the entry, update, storage, reading, sorting, importing, exporting, reporting and other manipulation of Headlines submissions in the form of Headline records which are stored in a database structure such as that demonstrated by Table 4 [153]. An Advertisement Submission Program implements the entry, update, storage, reading, sorting, importing, exporting, reporting and other manipulation of media selections in the form of media records which are stored in a database structure such as that demonstrated by Table 5 [188].

An Advertisement Submission Program implements the entry, update, storage, reading, sorting, importing, exporting, reporting and other manipulation of contact list submissions in the form of list records which are stored in a database structure such as that demonstrated by Table 6 [350]. An Advertisement Submission Program implements the entry, update, storage, reading, sorting, importing, exporting, reporting and other manipulation of Letterhead submissions in the form of Letterhead records which are stored in a database structure such as that demonstrated by Table 7 [151]. The Advertisement Submission Database Program shall be called upon in later steps, to retrieve and report images and objects.

Many different database programs and utilities are available to be used on a wide variety of computers and operating systems that can be used to implement or build the system. The method for storing images and other objects and linking searchable fields back to those images and other objects vary from one software program to another and would be known to those skilled in the art. The system, in later steps, assembles computerized images and objects such as what those with ordinary skill in the art would understand as “text objects” or “image objects” or “variable data” or “JPEG objects”, etc. into printable and electronically deliverable advertisements. No particular database software or object and image storing and retrieving methodology has been indicated for carrying out the various tasks described herein because it is considered that the operation, steps, and procedures described in the specification and illustrated in the accompanying drawings are sufficiently disclosed to permit one of ordinary skill in the art to practice the instant invention.

An Advertisement Submission Program is accessed by the operator of the system via a display and keyboard at the server [575] or, in the case of a distributed computing network such as a client/server environment or a browser to Internet environment, via a remote client [480]. We wrote our Advertisement Submission Program in C++, Java and HTML.

At Step 4020, an advertiser of the system selects an option from an Advertisement Submission Program Interface Start Page [575]. An Advertisement Submission Program interface Start Page FIG. 34A provides processing selections [201, 202, 203, 204 and 205]. Individual operators using our invention to select an advertising medium, select or input graphic components, select or input text components, select or input contact lists and/or submit them for merge and distribution create a advertiser record in the database Table 1 [150] by selecting [201] an Advertisement Submission Program interface Start Page FIG. 34A whereby an Advertisement Submission Program shows the Add New Advertiser Interface [FIG. 34B]. If an advertiser record describing the advertising operator already exists then that operator selects [202] at Step 4020 and the Advertisement Submission Program displays a computer software interface such as the Submit New Advertisement interface [FIG. 34C].

At Step 4030, a media type is selected [221] from an Advertisement Submission Program Interface Submit New Advertisement page [575] [FIG. 34C]. Media types are designed, created and input into an Advertisement Submission Program database by the system administrator of the system. Samples of media types are demonstrated in FIG. 35A, which is a Post Card media type; FIG. 35F, which is a Letterhead media type; and FIG. 35G, which is a left border and Letterhead media type. The “Select media type” field [221] as a scrolling selection list [366] and by clicking a selection the operator causes an Advertisement Submission Program to display a description of the selected media type.

Steps 5000 et seq.

At Step 5000, the system provides image selections based on the media type selected in Step 4030. An advertiser inputs a selection [222, 553, 552] from an Advertisement Submission Program Interface Submit New Advertisement Page [575] and demonstrated by FIG. 34C. By clicking a selection, the operator causes an Advertisement Submission Program to display a selection available to the selected media type [222, 553, 552] from an Advertisement Submission Program Interface Submit New Advertisement based on what is available for the media type selected [4030]. For example, if the operator had selected “Post Card 5×8” at element 221 in Step 4030 and then selected Food/restaurant element 365 FIG. 34I at element 222 FIG. 34C then an Advertisement Submission Program displays an interface [FIG. 34H] where the operator can review and select from image thumbnails that are specific to the Post Card media type. Other categories of image thumbnails may be reviewed by scrolling the images list [365] that is displayed at element 357 FIG. 34H. If the operator had selected “Post Card 5×8” at element 221 FIG. 34C in Step 4030, then no selections would appear at elements 553 and 552 FIG. 34C because such selections do not apply to the Post Card media type. If the operator had selected “ZFold Letter2” at element 221 FIG. 34C in Step 4030 then selections would appear at elements 553 and 552 FIG. 34C because such selections apply to the “Zfold Letter2” media type. Samples of “ZFold Letter2” are demonstrated in FIGS. 35G and 35H. If the operator had selected “ZFold Letter2” at element 221 FIG. 34C in Step 4030 then an item [553] is selected to display an interface such as that demonstrated in FIG. 34H where the operator can review and select from Letter Head image thumbnails that are specific to the “ZFold Letter2” and the operator selects an item at element 552 to cause an Advertisement Submission Program to display an interface such as that demonstrated in FIG. 34H where the operator can review and select from Left Border image thumbnails that are specific to the Zfold Letter2”.

At Step 5005 FIG. 7, the system Advertisement Submission Program determines, based on the media type selection made by the advertiser in Step 4030 FIG. 9, which set of steps to follow. At Step 5010 FIG. 7, the system Advertisement Submission Program, based on the media type selection made by the advertiser in Step 4030 FIG. 9 and the advertiser's user ID, displays a selection of image titles in an Advertisement Submission Program Submit New Advertisement interface FIG. 34c at element 222 Select Post Card Image. At Step 5020 FIG. 7, the advertiser of the system Advertisement Submission Program decides to use images already stored in an Advertisement Submission Program database or to submit a new image and indicates selection by selecting element 222 or element 576 of FIG. 34C. At Step 5030 FIG. 7, the advertiser of the system Advertisement Submission Program proceed to Step 11000 FIG. 1 and FIG. 6A if advertiser chose “Submit New Post Card Image” element 576 FIG. 34C during Step 5020. At Step 5040 FIG. 7, the advertiser of the system Advertisement Submission Program selects an image from an Advertisement Submission Program database.

At Step 5050 FIG. 7, the system Advertisement Submission Program, based on the media type selection made by the advertiser in Step 4030 FIG. 9 and the advertiser's user ID, displays a selection of image titles in an Advertisement Submission Program Submit New Advertisement interface FIG. 34c at element 553 Select Letter Head. At Step 5060 FIG. 7, the advertiser of the system Advertisement Submission Program decides to use images already stored in an Advertisement Submission Program database or to submit a new image and indicates selection by selecting element 553 or element 577 of FIG. 34C. At Step 5070 FIG. 7, the advertiser of the system Advertisement Submission Program proceed to Step 11000 FIG. 1 and FIG. 6A if advertiser chose “Submit New Letter Head” element 577 FIG. 34C during Step 5060. At Step 5080 FIG. 7, the advertiser of the system Advertisement Submission Program selects an image from an Advertisement Submission Program database.

At Step 5090 FIG. 7, the system Advertisement Submission Program, based on the media type selection made by the advertiser in Step 4030 FIG. 9 and the advertiser's user ID, displays a selection of image titles in an Advertisement Submission Program Submit New Advertisement interface FIG. 34c at element 553 Select Letter Head and/or element 552 Select Left Border if Desired. At Step 5100 FIG. 7, the advertiser of the system Advertisement Submission Program decides to use images already stored in an Advertisement Submission Program database or to submit a new image and indicates selection by selecting element 553 or element 577 of FIG. 34C and element 552 or element 578 of FIG. 34C. At Step 5110 FIG. 7, the advertiser of the system Advertisement Submission Program proceed to Step 11000 FIG. 1 and FIG. 6A if advertiser chose “Submit New Letter Head” element 577 FIG. 34C during Step 5100 or “Submit New Border” element 578 FIG. 34C during Step 5100. At Step 5120 FIG. 7, the advertiser of the system Advertisement Submission Program selects an image from an Advertisement Submission Program database.

The advertiser is not limited to choosing an image or object already stored [364, 365, 366, 367, 569] and can indicate the intention of adding a new image or object to an Advertisement Submission Program database [576, 577, 578], which causes an Advertisement Submission Program to display an interface [FIG. 34 D-1, FIG. 34 D-2]. An Advertisement Submission Program interfaces [FIG. 34 D-1 and FIG. 34 D-2] achieve similar results and illustrate two differing strategies for presenting selections. In FIG. 34D-1, the interface shows the options to submit an object and a name for the object. For example, fields correspond to Post Card images [228 and 865], Letter Head images [579 and 866] or Left Border images [582 and 867].

A sample Post Card image is demonstrated by element 590 FIG. 35B; a sample Letter Head image is demonstrated by element 531 FIG. 35F; a sample Left Border image is demonstrated by element 537 FIG. 35G. In the case of FIG. 34D-2, the interface s the options to submit an image or object and a name for the image or object and then indicate which type of image or object it should be stored as using the selection list element 587 FIG. 34D-2. Elements 228, 579 and 582 of FIG. 34D-1 and element 586 of FIG. 34D-2 refer to the “Path” of a new image or object meaning the path to a directory on a storage device on a computer or network where the image file or object file is stored. The operator may type in a path, for example: “C:\my stuff\images\coffee_cup” or, as any person with ordinary skill in the art would understand how to do, browse the network or directories in search of the image or object file.

The “Browse” button is used on many interfaces demonstrated as part of our invention and as any person with ordinary skill in the art would understand how to do, browse the network or directories in search of computer files stored on computer storage devices. Clicking a Submit button on the Advertising Submission Program Submit New Image interface, such as that demonstrated by FIG. 34D-1 and FIG. 34D-2, causes the database to create a new record in Table 3 element 152 FIG. 34, Table 4 element 153 FIG. 34, Table 7 element 552 FIG. 34, or Table 8 element 557 FIG. 34 or other Tables as may be created. Each new record is assigned a unique ID in the corresponding tables REF Code field, and the advertiser's reference code from element 168 FIG. 34 is stored in the Owner Code field of the newly created database record so that images, objects headlines etc. may be filtered based on ownership in other steps. For example, an advertiser Ms. Smith may input a Head Line named “Smith's Pie Company”.

The Headline record stored in the database Headline's Table element 153 by Ms. Smith would contain her Reference Code from her advertiser record created in Steps 4000 through 4030 so that an Advertisement Submission Program could be configured to show that headline at element 553 FIG. 34C only when Ms. Smith's login was in used to activate the interface. An Advertisement Submission Program may be configured to show all stored images and objects at elements 222, 553, 552 and any other selection device of our invention and method or be configured to show only stored images and objects at elements 222, 553, 552 and any other selection device of our invention that were created by the specific advertiser logged into an Advertisement Submission Program interface and those designated by a reference code which makes the image or object selection open to all or a class of users. When an operator submits a Headline, image or other object using an Advertisement Submission Program the program responds with a message such as those demonstrated in FIG. 34D-3.

In the case of a Message Saved Successfully message element 705 FIG. 34D-3 the message displays the name entered by the operator and stored by the program element 708 FIG. 34D-3, the reference number assigned and stored in the REF Code field for the record element 709 FIG. 34D-3 and the type (Headline, Letter Head, Left Border, etc.) of the record element 710 FIG. 34D-3. In the case of a Name Already Taken message element 706 FIG. 34D-3 the message displays an input field element 712 so the operator may rename the record with a name that hasn't already been used. In the case of a Save Failed Because message element 707 FIG. 34D-3 the message displays an message field element 715 so the operator nay understand why the record was not stored.

Step 6000 et seq.

At Step 6000 FIG. 1 and FIG. 8, the system provides headline selections based on the media type selected in Step 4030 FIG. 9 for which an advertiser inputs a selection using element 223 FIG. 34C from an Advertisement Submission Program Interface Submit New Advertisement page located at element 575 FIG. 14 and demonstrated by FIG. 34C and the choice to enter a new headline by selecting element 226 FIG. 34C. At Step 6010 FIG. 8, the advertiser of the system Advertisement Submission Program decides to use headlines already stored in an Advertisement Submission Program database or to submit a new headline and indicates selection by selecting element 223 or element 226 of FIG. 34C. At Step 6020 FIG. 8, the advertiser of the system uses an Advertisement Submission Program Submit New Headline interface FIG. 34E to enter a new headline element 234 FIG. 34E. At Step 6030 FIG. 8, the advertiser of the system stores the headline entered in Step 6020 FIG. 8 in the Advertisement Submission Database FIG. 34 by clicking the Submit button on an Advertisement Submission Program Submit New Headline interface FIG. 34E. When the operator clicks on element 226 FIG. 34C an Advertisement Submission Program responds by activating an Advertisement Submission Program Submit New Headline interface such as that demonstrated in FIG. 34E. The operator types into element 234 FIG. 34E then, clicks on the Submit button to save the entry causing a new record to be created in Table 4 element 153 FIG. 34.

At Step 6040 FIG. 8, the advertiser of the system reviews the list of headlines available by scrolling the list in at element 223 of FIG. 34C of an Advertisement Submission Program Submit New Advertisement page FIG. 34C. At Step 6050 FIG. 8, the advertiser of the system selects a headline from the list of headlines available by scrolling the list at element 223 of FIG. 34C of an Advertisement Submission Program Submit New Advertisement interface FIG. 34C by clicking on it so that it is highlighted At Step 6060 FIG. 8, or at any step when the operator wishes to store the selections made at an Advertisement Submission Program Submit New Advertisement interface FIG. 34C, the advertiser submits the selections made at an Advertisement Submission Program Submit New Advertisement page FIG. 34C by clicking on the Submit button element 237 and then our invention stores them in the Advertisement Submission Database FIG. 34 and an Advertisement Submission Program activates the View and Update Submitted Advertisements interface FIG. 34G which displays the layout of an assembled advertisement based on the advertisers selections made during Steps 4000 through 7050 FIGS. 1, 9, 8 and 10. An operator of the system clicks on the Active List Selection button element 870 FIG. 34G and the program activates an Advertisement Submission Program List Selection interface FIG. 34J from which the operator begins the execution of Steps 8020 through 8120 FIG. 11.

Step 7000 et seq.

At Step 7000 FIG. 1 and FIG. 10, the advertiser of the system enters advertising copy into an Advertisement Submission Program Submit New Advertisement page FIG. 34C by typing it in directly or copying and pasting it from an already created document. At Step 7010 FIG. 10, the advertiser of the system decides whether to copy and paste advertisement copy from an already created document or type the advertisement copy directly into the interface and based on that choice proceeds to Step 7060 or Step 7020 FIG. 10 accordingly. At Step 7020 FIG. 10, if the advertiser of the system chose to copy and paste advertisement copy from an already created document in Step 7010 then open the document file in which the advertisement copy is stored. For example, if the advertising copy below:

Top notch Programmers are needed NOW!!! Must have experience with C++ on UNIX developing financial applications. We hire fast and pay tons of money! Tons of unsuspecting investors have provided our thirteen year old CEO with a half billion dollars in capital and he has to use it before the dot com bubble bursts. So, hop on board play table tennis all day and drink free Pepsi®! Oh, and maybe write a line or two of computer code. $120,000 per year starting salary!! This is an ideal position for individuals with patent experience.

were stored in a Microsoft Word document C:\my_ads\greatob.doc then the advertiser opens C:\my_ads\greatob.doc and selects the text then selects the copy command then opens an Advertisement Submission Program Submit New Advertisement page FIG. 34C and places the cursor into element 225 and selects the paste command causing the above advertising copy to appear in the input box at element 225 FIG. 34C. At Step 7030 FIG. 10, if the advertiser of the system chose to copy and paste advertisement copy from an already created document in Step 7010 then select and copy the advertisement text from the document opened in Step 7020 FIG. 10. At Step 7040 FIG. 10, if the advertiser of the system chose to copy and paste advertisement copy from an already created document in Step 7010 then open an Advertisement Submission Program Submit New Advertisement interface page FIG. 34C. At Step 7050 FIG. 10, the advertiser of the system pastes the advertisement copy copied in Step 7030 FIG. 10 into element 225 FIG. 34C of an Advertisement Submission Program Submit New Advertisement interface page.

At Step 7060 FIG. 10, the advertiser of the system opens an Advertisement Submission Program Submit New Advertisement interface page FIG. 34C then, at Step 7070 FIG. 10, the advertiser of the system types advertisement copy into element 225 FIG. 34C of an Advertisement Submission Program Submit New Advertisement interface page.

At Step 7050 FIG. 10 or Step 7070 FIG. 10, the advertiser of the system selects the Submit button element 237 FIG. 34C and causes the Advertising Submission Program to create a record in an Advertisement Submission Program database Table 2 element 151 FIG. 34 where: the Headline Code field element 170 FIG. 34 stores the HREF Code element 185 of the record of the Headline selected; the Reference Code field element 171 is a program generated unique ID for the newly created advertisement record; the State field element 172 FIG. 34 remains empty until Step 8000 through 9060 FIGS. 1, 11 and 12 or a subset of those steps are completed but when filled contains geographic criteria for narrowing a list of prospective contacts; the Keywords field element 173 FIG. 34 remains empty until Step 8000 through 9060 FIGS. 1, 11 and 12 or a subset of those steps are completed but when filled contains keyword criteria for targeting a list of prospective contacts; the Contact field element 174 FIG. 34 stores the Contact Name element 156 FIG. 34 from the record of the logged in user or may be updated if an Advertisement Submission Program is configured with a contact name input field at the Submit New Advertisement interface such as that demonstrated in FIG. 34C; the Contact Phone field element 175 FIG. 34 stores the Phone element 162 FIG. 34 from the record of the logged in user or may be updated if an Advertisement Submission Program is configured with a contact phone input field at the Submit New Advertisement interface such as that demonstrated in FIG. 34C; the Contact Fax field element 176 FIG. 34 stores the Fax element 164 FIG. 34 from the record of the logged in user or may be updated if an Advertisement Submission Program is configured with a contact fax field at the Submit New Advertisement interface such as that demonstrated in FIG. 34C; the Contact email field element 177 FIG. 34 stores the Email element 163 FIG. 34 from the record of the logged in user or may be updated if an Advertisement Submission Program is configured with a contact email field at the Submit New Advertisement interface such as that demonstrated in FIG. 34C;: the Owner Code field element 178 FIG. 34 stores the Reference Code element 168 FIG. 34 from the record of the logged in user; the Image Code field element 179 FIG. 34 stores the HREF Code element 182 FIG. 34 of the record of the image or object selected; the Job Name field element 180 FIG. 34 stores the information entered into element 868 FIG. 34C during Steps 7070 or 7050; the Media Code field element 187 FIG. 34 stores the MREF Code element 190 FIG. 34C of the record of the media type selected at element 221 FIG. 34C; the Date field element 371 FIG. 34 stores the date that the record was created; the Letter Head Code field element 373 FIG. 34 stores the LHREF Code element 554 FIG. 34 of the record of the letter head image or object selected; the Left Border Code field element 562 FIG. 34 stores the LBREF Code element 559 FIG. 34 of the record of the left border image or object selected, the List Code field element 563 FIG. 34 remains empty until Step 8000 through 9060 FIGS. 1, 11 and 12 or a subset of those steps are completed but when filled stores the LREF Code element 352 FIG. 34 of the record of the list selected.

While one with ordinary skill in the art could envision several different database structures which could accomplish an Advertisement Submission Program database functions, for illustration purposes an Owner Code field is demonstrated in FIG. 34 Table 2 element 178, Table 3 element 718, Table 4 element 192, Table 6 element 869, Table 7 element 556, and Table 8 element 561 of an Advertisement Submission Program database which references the Reference Code field of Table 1 element 168. By including an Owner Code in these tables in the manner demonstrated by FIG. 34 sort routines for the purpose of reporting images and objects and records created by a specific advertiser login are later executed by the system using the information in those fields.

Step 8000

At Step 8000 FIG. 1 and FIG. 11, operating an Advertisement Submission Program List Selection interface FIG. 34J, the advertiser of the system submits a list of prospects from a source other than our invention's Contact Database and submits that list to be merged with the advertisement copy and selected images into the selected media type OR requests the help of an experienced Query Artist who will later search for a list of prospects from the Contact Database element 472 FIG. 14 submits that list to be merged with the advertisement copy and selected images into the selected media type OR searches for a list of prospects from the Contact Database element 472 FIG. 14 and submits that list to be merged with the advertisement copy and selected images into the selected media type. For the purpose of illustration, a specialized system administrator called a “Query Artist” is referenced herein. The efficient selection of search criteria requires subjective decision making and may be best carried out by an individual skilled in the art of research and database manipulation, a Query Artist, and the decision to designate such a skilled operator for Steps 8080 through 8120 FIG. 11 is advisable and while increasing the advantage of the system is not necessary to its successful operation. During Step 8040 an advertising operator requests that a Query Artist create a prospective contact list by selecting element 847 FIG. 34J from an Advertisement Submission Program List Selection interface and then clicking the Submit button element 377 FIG. 34J. An Advertisement Submission Program List Selection interface provides an input field element 378 FIG. 34J so that the advertiser may enter phone or email contact data that may be used by the Query Artist during Steps 8080 through 8110 to contact advertiser for the purpose of discussing possible lists. The invention stores the data entered into input field element 378 FIG. 34J in the field element 173 FIG. 34. The element 563 FIG. 34 is updated with a code assigned to designate the selection of element 847 FIG. 34J.

At Step 8010 FIG. 11, the advertiser of the system opens an Advertisement Submission Program Start Page interface FIG. 34A, selects option “View and update submitted advertisements” element 203 FIG. 34A, the Program opens an Advertisement Submission Program View and Update Submitted Advertisements interface FIG. 34F where the operator of our invention enters an identification code and password, then the program displays a list of advertisements in a table element 372 FIG. 34F then the operator selects an advertisement by clicking on its row, then the program opens an Advertisement Submission Program View and Update Submitted Advertisements interface FIG. 34G and the operator then clicks on the Activate List Selection button element 870 FIG. 34G and then the program opens an Advertisement Submission Program List Selection Interface FIG. 34J.

At Step 8020 FIG. 11, the advertiser of the system proceeds to Step 8050 FIG. 11 if the advertiser decided to enter a list of prospects from a source other than our invention's Contact Database or proceeds to Step 8030 FIG. 11. At Step 8030 FIG. 11, the advertiser of the system proceeds to Step 8040 FIG. 11 if the advertiser decided to seek the help of an experienced Query Artist to search our invention's Contact Database or proceeds to Step 8080 FIG. 11 if the advertiser decided to search for a list of prospects from the Contact Database element 472 FIG. 14 and submit that list to be merged with the advertisement copy and selected images into the selected media type. At Step 8040 FIG. 11, the advertiser of the system highlights the radio button element 847 FIG. 34J and clicks the Submit button element 377 FIG. 34J.

At Step 8050 FIG. 11, the advertiser of the system highlights the radio button element 375 FIG. 34J and clicks the Submit button element 377 FIG. 34J which action opens an Advertisement Submission Program List Transfer interface FIG. 34K At Step 8060 FIG. 11, the advertiser of the system enters the network path to the storage location of the file containing a pre-prepared contact list into an Advertisement Submission Program List Transfer interface input field element 380 FIG. 34K At Step 8070 FIG. 11, the advertiser of the system submits the list which path was entered in Step 8060 FIG. 11 into the Advertisement Submission Database FIG. 34 by clicking the Submit button element 382 FIG. 34K

At Step 8080 FIG. 11, the advertiser of the system highlights the radio button element 376 FIG. 34J and clicks the Submit button element 377 FIG. 34J then the program opens an Advertisement Submission Program Create a List interface FIG. 34L. As those skilled in the Art know, searching is a technique used to sort and retrieve sets of records from a computer database. One method of retrieving desired sets of records from a database comprises inputting search criteria into a computer interface and then instructing the program to search based on that criteria. Most database software, including the ADAPT database application software used in the invention, provides a facility for searching and retrieving. During a search routine at Steps 8090 through 8110 FIG. 11, the system locates prospective contact records stored in the Contact Database at element 472 FIG. 14 that match the criteria entered into an Advertisement Submission Create a List interface as in FIG. 34L.

The words or phrases entered into the input field elements at 385 FIG. 34L are used in what any person with ordinary skill in the art would understand as a Boolean search using the “OR” element 386 and the “AND” element 387 arguments. While one with ordinary skill in the art could envision several different search criteria interface designs and structures that could accomplish Advertisement Submission Program search functions, for illustration purposes Our invention's search criteria interface is demonstrated in FIG. 34L. The State input field demonstrated as element 388 FIG. 34L is easily modified for geographic appropriateness such as provinces by any person with ordinary skill in the art. The State input field demonstrated as element 388 FIG. 34L searches specifically against the State field demonstrated in element 674 FIG. 17.

At Step 8090 FIG. 11, the advertiser of the system enters search criteria into the fields, demonstrated by element 385 FIG. 34L, of an Advertisement Submission Program Create a List interface FIG. 34L and clicks the Submit button element 389 FIG. 34L. At Step 8100 FIG. 11, the system displays the total number of matches at element 391 FIG. 34L. At Step 8110 FIG. 11, the advertiser of the system reviews the number of matches displayed at element 391 FIG. 34L and decides whether the list should be expanded or narrowed. If list is acceptable “as is” then the advertiser proceeds to Step 8120 if not, then the advertiser proceeds to Step 8090 in order to run search again using expanding or narrowing criteria.

At Step 8120 FIG. 11, the system submits the list to Advisement Submission Database FIG. 34 and element 472 FIG. 14 by clicking on the Submit button element 389 FIG. 34L. At Step 9000 FIG. 1 and FIG. 12, the system opens an Advertisement Submission Program Start Page interface FIG. 34A, selects option “View and update submitted advertisements” element 203 FIG. 34A, opens an Advertisement Submission Program View and Update Submitted Advertisements interface FIG. 34F where the operator of our invention enters an identification code and password, the system displays a list of advertisements in a table element 372 FIG. 34F then the operator of our invention selects and advertisement by clicking on its row and, in response, our invention opens an Advertisement Submission Program View and Update Submitted Advertisements interface FIG. 34G and the operator of the system reviews the advertisement and then chooses to modify or accept the advertisement.

Step 9000 et seq.

At Step 9010 FIG. 12, the system opens an Advertisement Submission Program is Start Page interface FIG. 34A. At Step 9020 FIG. 12, the operator of the system selects option “View and update submitted advertisements” element 203 FIG. 34A. At Step 9030 FIG. 12, the operator of the system enters a user identification into element 341 FIG. 34F and the corresponding password into element 342 FIG. 34F and then clicks the Submit button element 343 FIG. 34F. At Step 9040 FIG. 12, based on the criteria entered in Step 9030 FIG. 12 our invention reports to an Advertisement Submission Program View and Update Submitted Advertisements interface FIG. 34F in table element 372 FIG. 34F a list of matching advertisements. The operator of the system selects an advertisement by clicking on its row in element 372 FIG. 34F.

At Step 9050 FIG. 12, based on the row clicked in element 372 FIG. 34F during Step 9040 FIG. 12 our invention displays advertisement components in an Advertisement Submission Program View and Update Submitted Advertisements interface FIG. 34G so that the operator can view and review said advertising components and decide modify or accept the advertisement. At Step 9060 FIG. 12, based on the decision to decide modify or accept the advertisement made in Step 9050 FIG. 12, the operator of the system clicks on the Accept button element 348 FIG. 34G or the Modify button element 349 FIG. 34G.

Operators may wish to update information that was stored into the Advertisement Submission Database element 575 FIG. 14 during Steps 4000 through 9060 and can do that during Steps 9000 through 9060 FIG. 12. Operators may skip steps during the advertisement submission process during Steps 4000 through 9060 with the intention of returning to the process at a later time and filling in any omitted information or inputting omitted selections. In order to review, update or resubmit an advertisement an operator of the system opens an Advertisement Submission Program Start Page interface FIG. 34A, selects option “View and update submitted advertisements” element 203 FIG. 34A, the Program opens an Advertisement Submission Program View and Update Submitted Advertisements interface FIG. 34F where the operator of our invention enters an identification code and password, then the program displays a list of advertisements in a table element 372 FIG. 34F then the operator selects an advertisement by clicking on its row, then the program opens an Advertisement Submission Program View and Update Submitted Advertisements interface FIG. 34G.

The operator clicks on the Modify button element 349 FIG. 34G and the Advertisement Submission Program s the operator with a dialog window with two selections: Modify Ad Submission OR Modify List. In the case of selecting Modify Ad Submission, the program activates the Advertisement Submission Program Submit New Advertisement interface such as that illustrated in FIG. 34C where the selections and data input previously for the specified advertisement are displayed and the operator continues as described in earlier Steps 4000 through 8120. In the case of selecting Modify List, the program activates an Advertisement Submission Program List Selection interface such as that demonstrated in FIG. 34J and the operator continues as described in Steps 8000 through 8120.

At Steps 10000 through 10035, a workstation demonstrated as element 486 FIG. 14 has certain application software installed which processes variable image and text data into printer instructions. The invention has installed in the Darwin Workstation (an Apple Macintosh computer) QuarkXPress and Scitex Darwin Desktop Version 2.0 herein incorporated as reference. For illustration purposes the following is the creation of the advertisement postcard demonstrated in FIGS. 35A, 35B, 35C, 35D and 351. The graphic demonstrated as element 590 FIG. 35B is created during step 11000 FIG. 1 and stored as a QuarkXPress file (.eps file) on the Darwin Workstation element 486 FIG. 14 during step 10015 FIG. 6. The operator of the system starts the QuarkXPress application program and activates Darwin Pilot.

The Darwin Pilot splash screen activates along with the Navigator Palette and the Darwin CoPilot FIG. 36D. The operator of the system creates a Post Card Front Job and Profile by clicking the Jobs-New button on the Navigator Palette and the Darwin Workstation s an interface as shown in FIG. 36A. The operator enters a job name such as “Post Card Media Front” into element 611 FIG. 36A and chooses “Create New Profile” from the scroll list at element 613 FIG. 36A. The Darwin New Profile interface opens FIG. 36 and the operator enters “Post Card Media Front” into element 596 FIG. 36. The operator defines the following field name(s) as part of Step 10030 FIG. 6: FirstName, if using layout demonstrated as element 849 of FIG. 351, or FirstName and Headline1 and Headline2, if using layout demonstrated as element 848 of FIG. 35I in order to accomplish the result as in FIG. 35B and enters them into the interface as demonstrated by element 598 of FIG. 36. The profile is then saved as part of Step 10035 FIG. 6.

The operator of the system opens the Pages interface FIG. 36 from the Darwin Navigator Palette and drags and drops the QuarkXPress file version of the graphic component demonstrated as element 590 FIG. 35B which was formatted and stored during Steps 11000 through 11040 FIG. 6A and Steps 10000 through Steps 10035 FIG. 6. The graphs file is opened and becomes active in the QuarkXPress active application where the operator selects the content tool from the tool palette then from the Darwin CoPilot palette drags the variable fields to the text box demonstrated as elements 857 and 855 FIG. 35I of the layout. The operator of the system creates a Post Card Back Job and Profile by clicking the Jobs-New button on the Navigator Palette and the Darwin Workstation s an interface as shown in FIG. 36A. The operator enters a job name such as “Post Card Media Back” into element 611 FIG. 36A and chooses “Create New Profile” from the scroll list at element 613 FIG. 36A. The Darwin New Profile interface opens FIG. 36 and the operator enters “Post Card Media Back” into element 596 FIG. 36.

The operator defines the following field name(s) as part of Step 10030 FIG. 6: FirstName, LastName, Street, City, State, Postal Code and Copy in order to accomplish the result as in FIG. 35A and enters them into the interface as demonstrated by element 598, 599, 600, 601, 602 and 603 of FIG. 36. The profile is then saved as part of Step 10035 FIG. 6. The operator of the system opens the Pages interface FIG. 36 from the Darwin Navigator Palette and drags and drops the QuarkXPress file version of the graphic component demonstrated as element 514 FIG. 35D which was formatted and stored during Steps 11000 through 11040 FIG. 6A and Steps 10000 through Steps 10035 FIG. 6. The graphic file is opened and becomes active in the QuarkXPress active application where the operator selects the content tool from the tool palette then from the Darwin CoPilot palette drags the variable fields to the text boxes demonstrated as elements 858 and 859 FIG. 35D of the layout. The profile layouts can be saved and reused as advertisers submit advertisement requests.

At Step 10005 FIG. 6, the operator of the system designs media layouts such as those demonstrated in FIG. 35D, FIG. 35E, and 35H. At Step 10010 FIG. 6, the operator of the system creates a graphic such as that demonstrated as element 590 FIG. 35B using any of the many available graphic programs and converts to our invention's standard layout using a graphic layout application such as QuarkXPress FIG. 36C. At Step 10015 FIG. 6, the operator of the system stores the graphic created and converted into our invention's standard into a computer storage device such as that demonstrated in FIG. 14 as element 486 Darwin Workstation. At Step 10020 FIG. 6, the operator of the system determines the variable images and text files to be applied in variable data documents such as those demonstrated in FIGS. 35D, 35E and 35H. At Step 10025 FIG. 6, the operator of the system stores the variable data documents selected in Step 10020 into the Darwin library using the Darwin Library Interface FIG. 36H. At Step 10030 FIG. 6, the system fields are defined as in FIG. 36 and saved as a profile. At Step 10035 FIG. 6, the system saves a profile created in the New Profile Interface of Darwin FIG. 36.

In our invention, the Scitex Darwin and QuarkXPress applications are used to manipulate images and objects, assemble images and objects with variable data such as mailing list contact information, and prepare and export to a printer. The Scitex Darwin Version 2.0 Tutorial manual is herein incorporated as reference and serves to explain and disclose procedures supportive of the system and the invention At Step 11000 FIG. 1 and FIG. 6A, the operator of the system creates or obtains images; uses graphic manipulation software applications to adjust images to standard sizes, resolutions and formats and stores the images.

At Step 11010 FIG. 6A, the operator of the system creates or obtains images.

The only limitations on the number of media types, images and objects which can be made available to advertisers during Steps 4000 through 6060 are based on the limitations of the computer hardware and storage devices, operating systems and application software employed in the system and the number of media types, images and objects entered during Steps 10000 through 12030. At Steps 11010 FIG. 6A an operator of the system creates or selects images that shall be used in other steps to be assembled into advertisements such as the image example at element 590 FIG. 35B which becomes part of the advertisement demonstrated as element 367 FIG. 35A; or such as the image example at element 531 FIG. 35F which becomes part of the advertisement demonstrated as element 530 FIG. 35F; or such as the image examples at elements 531 and 538 FIG. 35G which becomes part of the advertisement demonstrated as element 536 FIG. 35G.

Images are created by an number of methods familiar to those skilled in the art including but not limited to: film and digital photography; manual and digital drawing and painting; copying and merging; etc. Systems and methods for artwork design are well documented and such a system is herein incorporated as reference as U.S. Pat. No. 5,649,220 Yosefi. Images may also be rented and purchased from third party sources such as stock graphic suppliers. The greatest advantage is afforded when images supportive of the needs of advertiser's are stored in advance of their implementation of the system by advertisers. For example, if the system administrator expects that advertisers shall be using the system to create advertisements related to “dining out” then the system administrator would create a greater advantage by stocking the Advertisement Submission Database with images of dinner tables, restaurants and food.

Methods for displaying images in the form of thumbnails as displayed in FIG. 34H are well known to those with ordinary skill in the art At Step 11020 FIG. 6A, the operator of the system uses graphic manipulation software applications to adjust images to standard sizes, formats and resolution. As would be understood by one skilled in the art, image size, format and resolution standards are defined based on the computer hardware, operating system and application software used to affect the system and their planned use in the system. Several different versions of the same image are stored by the system so they may be recalled during process steps and displayed or merged without reformatting of their graphic file at that time. For example, post card images such as those shown as element 590 FIG. 35B and element 358 FIG. 34H could be of the same image and stored as two different files of different formats, the image at 358 FIG. 34H as a JPEG or GIF, and the image at 590 FIG. 35B as a QuarkXPress file in two different storage directories.

In the invention, images displayed in an Advertisement Submission Program interface such as that demonstrated by FIG. 34H are stored in the JPEG format however, one with ordinary skill in the art could envision the system storing those images in another format gaining the same or other advantages. At Step 11030 FIG. 6A, the operator of the system uses graphic manipulation software applications to adjust resolutions and formats of images. The graphic format and resolution of an image file necessary to display on a computer interface such as that demonstrated in FIG. 34H may be different and more than likely of lower resolution than that which would be required in the printing layout used during Steps 13000 through 15000. The invention uses QuarkXPress and Adobe Photoshop AND Adobe Illustrator to modify and store images. A person with ordinary skill in the art could use these or other graphic applications to practice the instant invention based on the description herein.

At Step 11040 FIG. 6A, the operator of the system stores the images into appropriate databases and directories on computer storage devices. Images and objects such as the previously exampled post card image, letterhead, left border, headline and copy text may be created and stored within our invention apparatus or outside but must ultimately be imported from a portable storage device such as a floppy disk accessed by the system or via network accessed computer storage device. An Advertisement Submission Program interfaces demonstrated in FIG. 34 D-1 and FIG. 34 D-2 achieve similar results and illustrate two differing strategies for ing selections to the operator of the system yet should no be considered limiting. In the case of FIG. 34D-1, the interface s the options to submit an image or object and a name for the image or object with fields specific to the type. For example, field elements 228 and 865 FIG. 34D-1 correspond to Post Card images; field elements 579 and 866 FIG. 34D-1 correspond to Letter Head images; field elements 582 and 867 FIG. 34D-1 correspond to Left Border images.

A sample Post Card image is demonstrated by element 590 FIG. 35B; a sample Letter Head image is demonstrated by element 531 FIG. 35F; a sample Left Border image is demonstrated by element 537 FIG. 35G. In the case of FIG. 34D-2, the interface s the options to submit an image or object and a name for the image or object and then indicate which type of image or object it should be stored as using the selection list element 587 FIG. 34D-2. Elements 228, 579 and 582 of FIG. 34D-1 and element 586 of FIG. 34D-2 refer to the “Path” of a new image or object meaning the path to a directory on a storage device on a computer or network where the image file or object file is stored. The operator may type in a path, for example: “C:\my stuff\images\coffee_cup” or, as any person with ordinary skill in the art would understand how to do, browse the network or directories in search of the image or object file. The “Browse” button is used on many interfaces demonstrated as part of our invention and as any person with ordinary skill in the art would understand how to do, browse the network or directories in search of computer files stored on computer storage devices. Clicking a Submit button on the Advertising Submission Program Submit New Image interface, such as that demonstrated by FIG. 34D-1 and FIG. 34D-2, causes the database to create a new record in Table 3 element 152 FIG. 34, Table 4 element 153 FIG. 34, Table 7 element 552 FIG. 34, or Table 8 element 557 FIG. 34 or other Tables as may be created. Each new record is assigned a unique ID in the corresponding tables REF Code field, and the advertiser's reference code from element 168 FIG. 34 is stored in the Owner Code field of the newly created database record so that images, objects headlines etc. may be filtered based on ownership in other steps.

For example, an advertiser Ms. Smith may input a Head Line named “Smith's Pie Company”. The Headline record stored in the database Headline's Table element 153 by Ms. Smith would contain her Reference Code from her advertiser record created in Steps 4000 through 4030 so that an Advertisement Submission Program could be configured to show that headline at element 553 FIG. 34C only when Ms. Smith's login was in used to activate the interface. An Advertisement Submission Program may be configured to show all stored images and objects at elements 222, 553, 552 and any other selection device of our invention and method or be configured to show only stored images and objects at elements 222, 553, 552 and any other selection device of our invention that were created by the specific advertiser logged into an Advertisement Submission Program interface and those designated by a reference code which makes the image or object selection open to all or a class of users. When an operator submits a Headline, image or other object using an Advertisement Submission Program the program responds with a message such as those demonstrated in FIG. 34D-3.

In the case of a Message Saved Successfully message element 705 FIG. 34D-3 the message displays the name entered by the operator and stored by the program element 708 FIG. 34D-3, the reference number assigned and stored in the REF Code field for the record element 709 FIG. 34D-3 and the type (Headline, Letter Head, Left Border, etc.) of the record element 710 FIG. 34D-3. In the case of a Name Already Taken message element 706 FIG. 34D-3 the message displays an input field element 712 so the operator may rename the record with a name that hasn't already been used.

In the case of a Save Failed Because message element 707 FIG. 34D-3 the message displays an message field element 715 so the operator may understand why the record was not stored. In the invention images are stored.

At Step 12000 FIG. 1 and FIG. 6B, the operator of the system creates or obtains headlines then uses text manipulation software applications to adjust the headline text to standard sizes and formats and stores the headlines then at Step 12010 FIG. 6B, the operator of the system creates or obtains headlines then at Step 12020 FIG. 6B, the operator of the system uses text manipulation software applications to adjust headlines to standard sizes and formats then at Step 12030 FIG. 6B, the operator of the system stores the headlines into appropriate databases and directories on computer storage devices.

Step 1300 et seq.

At Step 13000 FIG. 1 and FIG. 37, the operator of the system selects an advertisement submission for processing then, using the graphic processing software applications located at element 486 FIG. 14, prepares the layout for printing and merging into the list selected or submitted by an advertiser or Query Artist during Steps 8000 through 8120 FIG. 11, imports the list previews the job using a computer software interface at element 486 FIG. 14 and then inputs the command to print or export the advertisements.

At Step 13010 FIG. 37, the operator of the system opens an Advertisement Submission Program Start Page FIG. 34A then at Step 13020 FIG. 37, the operator of the system clicks on the element 204 of an Advertisement Submission Program Start Page FIG. 34A to activate an Advertisement Submission Program Process Advertisements interface FIG. 34M. At Step 13030 FIG. 37, the operator of the system selects an option from an Advertisement Submission Program Process Advertisements interface FIG. 34M and in response our invention reports a list of advertisement submissions in the table element 399 FIG. 34M. The system administrator could search for advertisements submitted on a specific date by entering a date into input field element 393 FIG. 34M which, upon clicking the submit button element 394 FIG. 34M, searches the Date field element 371 FIG. 34 and reports matching advertisement submission records stored in Table 2 element 151 FIG. 34.

The system administrator of the system could search for advertisements submitted by a specific advertiser by selecting an advertiser from the scroll selection list field element 393 FIG. 34M which, upon clicking the submit button element 396 FIG. 34M, searches the Owner Code field element 178 FIG. 34 and reports matching advertisement submission records stored in Table 2 element 151 FIG. 34. The scrolling selection list at element 393 FIG. 34M can be configured to display advertisers by any field or fields from Table 1 element 150 FIG. 34. For example, selection could be made by displaying contact names from field 156 FIG. 34 or Reference Code field 168 FIG. 34. The system administrator could search all advertisements and report them in date order by clicking the submit button element 397 FIG. 34M, which causes the program to sort on the Date field element 371 FIG. 34 and reports matching advertisement submission records stored in Table 2 element 151 FIG. 34.

The system administrator could search all advertisements and report them in Firm Name order by clicking the submit button element 398 FIG. 34M, which causes the program to sort on the Finn Name field element 155 FIG. 34 and reports matching advertisement submission records stored in Table 2 element 151 FIG. 34. The system administrator clicks on an advertisement submission listed in the table element 399 FIG. 34M to activate the Advertisement Submission Program Advertisement Export interface which, for the advertisement submission selected, displays the corresponding data reported from the Advertisement Submission Database into the field elements 871, 872, 876, 877 and 878. Field element 871 FIG. 34N reports data from element 191 FIG. 34 for the cross-referenced record based on the reference code in element 187 FIG. 34 for the matching record. Field element 873 FIG. 34N reports data from element 717, 719, 720 or 721 FIG. 34 for the cross-referenced record based on the reference code in element 170, 179, 373 or 562 FIG. 34 for the matching advertisement submission record. Field element 874 FIG. 34N reports data from element 185, 182, 554 or 559 FIG. 34 for the cross referenced record based on the reference code in element 170, 179, 373 or 562 FIG. 34 for the matching advertisement submission record. Field element 875 FIG. 34N reports the object or image type from element 184, 181, 553 or 558 FIG. 34 for the cross-referenced record based on the reference code in element 170, 179, 373 or 562 FIG. 34 for the matching advertisement submission record. Field element 876 FIG. 34N reports data from element 156 FIG. 34 for the cross-referenced record based on the reference code in element 178 FIG. 34 for the matching advertisement submission record. Field element 877 FIG. 34N reports data from element 178 FIG. 34 for the matching advertisement submission record. Field element 878 FIG. 34N reports data from element 881 FIG. 34 for the matching advertisement submission record. The system administrator of the system clicks the Post button element 879 FIG. 34N causing the Advertisement Submission program to export the List and images and objects stored in the Advertisement Submission database or pointed to by the Advertisement Submission database into a job file at the Darwin Workstation element 486 FIG. 14.

In the case that an advertiser selected element 847 FIG. 34J during Step 8040 FIG. 11 which would be indicated by the code in element 563 FIG. 34 then a Query Artist would conduct Steps 8080 through 8120 FIG. 11. Systems and methods for merging images and text are well documented and such a system is herein incorporated as reference as U.S. Pat. No. 5,845,302 Cyman, Jr., et al.; U.S. Pat. No. 6,205,452 Warmus, et al. and U.S. Pat. No. 5,963,968 Warmus, et al. At Step 13040 FIG. 37, the operator of the system activates the graphic processing software applications located at Darwin Workstation element 486 FIG. 14. At Step 13050 FIG. 37, the operator of the system loads an already stored profile or creates a profile using the graphic processing software applications located at Darwin Workstation element 486 FIG. 14.

With the graphic application program such as QuarkXPress open, the operator activates the Darwin Pilot then from the Navigator palette selects Pages causing the program to open the Pages Window where the operator selects a layout to display as a thumbnail as in FIG. 36E. In our invention, during Steps 10000 through 12030 images and objects are stored in the Darwin Library where library items are pointers to images and text files such as those used in the post card image, letterhead, headline and left border examples discussed earlier which are stored as files in a computer storage device. Cataloging objects and images in the Darwin Library demonstrated in FIG. 36H makes assembling the final advertisement layout a simpler task. In our invention, the operator of the system selects Library from the Navigator palette of the Darwin program causing the Library window to appear as shown in FIG. 36H. The operator selects Add New Item button and a file selection dialog window opens. From the File selection window the operator browses the directories in search of the images and objects to be cataloged into the Library and selects those to be included for use in other steps.

At Step 13060 FIG. 37, the operator of the system imports variable field data from a file created or stored during Steps 8000 through 8120 FIG. 11. Activating the graphics program such as Darwin Pilot, the operator of the system selects the Data Import command from the Navigator palette and the program displays the Import window. The operator then imports the list submitted during Steps 8000 through 8120 FIG. 11 that corresponds to the advertisement submission being processed and assigns the fields in accordance to the procedures of the graphic application program such as those explained in the Scitex Darwin Tutorial incorporated herein as reference.

At Step 13070 FIG. 37, the operator of the system assigns a QuarkXPress layout using a Scitex Darwin software application to the job. At Step 13080 FIG. 37, the operator of the system using QuarkXPress and a Scitex Darwin software application assembles the components of the job. In our invention, he operator of the system activates the QuarkXPress and Darwin CoPilot applications at element 486 FIG. 14 and clicks the Pages box on the Navigator palette. The operator drags and drops the Layout image from its directory location or the Darwin Library making it an available layout in the Pages window. The operator activates the QuarkXPress Content Tool and from the Darwin CoPilot palette drags and drops the appropriate profiled field or fields, for example, First Name, into the text box on the image and arranges components to space properly.

At Step 13090 FIG. 37, the operator of the system using QuarkXPress and a Scitex Darwin software application to preview the job. The system administrator clicks the Show preview/proof button of the Darwin CoPilot palette causing the program to open the Preview/Proof window. The operator of the system clicks on a row in the table of the Preview/Proof window then selects the Preview Current Record command. The program displays a sample of the advertisement, as it shall appear for the specific contact listed in the row selected. The operator then defines the Darwin pages saving the Darwin Job Pages. At Step 13100 FIG. 37, the operator of the system using QuarkXPress and a Scitex Darwin software application inputs the command to print or export the advertisements.

The system could operate a word-processing program with variable information merge capabilities such as Microsoft Word 2000 to accomplish many of its advantages is however certain advantages of the more sophisticated application software chosen for the preferred embodiment of our invention are not duplicated. Field variables may be formatted into documents created using word-processing applications such as Microsoft Word 2000 so that a layout such as that demonstrated in FIG. 35J is assembled by an system administrator from the objects and images stored or selected during Steps 5000 through 9000. The FIG. 35J is a Microsoft Word 2000® document that may be merged with a field delimited text file by any person with ordinary skill in the art so as to result in a custom addressed letter for each contact listed in the field delimited text file.

The disadvantage of this method is in the printing process because it merges the images, objects and text before sending to the printer. Consequently, each letter must be translated into its digital printing code separately. The process of translating a document into digital printing code is known by those with ordinary skill in the art as RIP or RIPping and is incorporated as reference in the document from Xerox Corporation, Variable Information Customer Expectations Document DocuColor 2045/2060CSX CreoScietex Darwin Desktop 3.1, 21 pages. The preferred embodiment of the system incorporates software and hardware which RIP's printing elements such as text, images and objects separately once and then merges them at the printer server element 488 FIG. 14 and FIG. 16. This avoids the processing time that is used when each letter must be translated into its digital printing code separately such as printing from a Microsoft Word 2000 document. Printing elements such as text, images and objects separately once and then merging them at the printer server allows for much faster printing rates and less processor consumption.

Step 14000 et seq.

At Step 14000 FIG. 1 and FIG. 38, the operator of the system opens the print processor, selects a printer to process the print job, loads materials into the printer, executes the print command which activates the print server [488], removes the printed materials and cuts, folds, inserts bundles, stamps and otherwise prepare for delivery.

At Step 14010 FIG. 38, the operator of the system opens the print processor located at Darwin Workstation element 486 FIG. 14 that displays a computer software interface such as shown in FIG. 36F. n our invention, the Scitex DFE printer is set to VPS and the operator selects Print Runs—New from the Navigator palette opening a Print Run window such as that demonstrated in FIG. 36F. The operator enters a print run name and selects the all button indicating that advertisements should be printed for all the records imported from the contact list imported during Step 13060 FIG. 37 and then saves the print run. The operator clicks Print Runs on the Navigator palette to open the Print Runs window demonstrated in FIG. 36G, selects the print run and clicks the Execute the selected print run button. At Step 14020 FIG. 38, the operator of the system selects the printer or computer storage device to receive the print job.

At Step 14030 FIG. 38, the operator of the system loads paper and printing supplies into printer located at element 487 FIG. 14. The preferred embodiment of the system employs a Xerox DocuColor 2060 Digital press because it print a larger number of sheets more quickly than other printers and prints in color. A preferred substitute printer for situations where color printing is not required is the Xerox Docutech 2000 series 65. Printers with larger sheet size capacity offer advantages because several advertisements can be printed in a single print cycle and separated by cutting later see The Challenge Machinery Company, Spartan 120 and Model 20 Specification Sheet herein incorporated as reference (Art item 8. The Challenge Machinery Company, Spartan 120 and Model 20 Specification Sheet, 1433 Fulton Avenue Grand Haven, MI 49417 USA, Phone: (616) 842-8300, Fax: (616) 847-6665, February 2001, 6 pages). Printing more advertisements per printing cycle reduces costs when equipment leases and maintenance charges are calculated per print cycle and the rate of advertisements printer per period of time is increases. For example, four 5.5×8.5 inch post cards could be printed on an 11×17 sheet at nearly the same speed for nearly the same cost as one 5.5×8.5 inch printed on the same printer see 8.

Methods for printing documents with merged digital objects are described in: 1. Xerox Corporation, DocuColor 2045 and 2060 Digital Press Customer Expectations Document Feb. 12, 2001 Version, 32 pages; 2. Xerox Corporation, Xerox DocuColor 130CSX Digital Color Production System Installation Planning Guide Launch Version September 2000, 50 pages; 3. Xerox Corporation, Xerox DocuColor 130CSX Digital Color Press Customer Planning Guide Version Jun. 27, 2000, 35 pages; 4. Xerox Corporation, DocuColor 2000 CSX Color Server Customer Expectations Document Version Apr. 2, 2001, 11 pages; 5. Xerox Corporation, Variable Information Customer Expectations Document DocuColor 2045/2060CSX CreoScietex Darwin Desktop 3.1, 24 pages; 6. Scitex Corporation, Document No. 771-51196 Catalog No. 399Z51196A Workflow Guidelines Scitex Darwin Version 2.0 December 1997, 14 pages and 7. Scitex Corporation, Document No. 399Z51072B, Scitex Darwin Tutorial Version 2.0 May 1998, 77 pages.

At Step 14040, the operator of the system executes the print command from a software application interface such as that demonstrated in FIG. 36F or element 493. At Step 14050, the operator of the system removes the printed materials from a printer and cuts, folds, inserts bundles, stamps and otherwise prepare for delivery such as in FIG. 35. The system description herein uses post card and letter media for illustrative purposes as examples. Our system may be operated to assemble other media types. For example, the media created and stored [10000-10035] could include electronically deliverable objects such as HTML files or Audio files or Video file which are delivered via electronic mail instead of postal mail. Any person with ordinary skill in the art could configure database tables such as described in FIG. 34 or adding tables to the database structure that would point to HTML objects or Voice or sound objects or video objects in the same way the Advertisement Submission database is demonstrated to point to image and text objects herein.

The Advertisement Submission program may be configured to affect Steps 5000 through 12000 such that HTML objects or voice or sound objects or video objects are substituted for static images and static text. If the system is configured to deliver media types using HTML objects or Voice or sound objects or Video objects via electronic mail then at Step 13000 the advertisement submitted [9000-9060] is merged with a list of electronic mail addresses selected, assembled or stored [8000-8120] and delivered using commercially available electronic bulk mail delivery software such as Extractor Pro licensed and maintained by KowaBunga Technologies 962 Newburgh, Westland, Mich. 48185 and herein incorporated as reference (Art item 9. KowaBunga Technologies, http://www.extractor.com/software.htm, Extractor Pro V8.0 962 Newburgh, Westland, Mich. 48185, June 2001 3 pages). Those with ordinary skill in the art could implement the sound and voice objects referred to herein and implement the instant invention using published systems such as that described in U.S. Pat. No. 6,067,348 Hibbeler and herein incorporated as reference.

Step 1000 et seq.

At Step 1000 FIG. 1, professional profiles are collected by the system using the Harvest method described in Steps 1200 through 1370 FIGS. 3 and 3A and/or by using the Third Party Import method described in Steps 1400 through 1430 FIG. 3B and/or by using the Portal Collection Site method described in Steps 1600 through 1640 FIG. 3C and/or by using the Traditional Advertising method described in Steps 1800 through 1850 FIG. 3D. The professional profiles collected by the system are stored in a Contact Database that stores the entire text contents of each professional profile in such a manner or format that the entire text of every professional profile may be searched for matching characters, words, phrases, combinations of words, combinations of phrases or combinations of words and phrases and in the case of a match reported back to the operator or invention system as a match. In addition to storing the entire text contents of each professional profile as described, the system also stores the contact information from each professional profile collected, such as name, street address, City, State, Zip Code, email address, etc. into specifically assigned fields in the Contact Database such that the database program can report or export to a file in delimited format the contact information from each matching record as night be searched for in Steps 8080 through 8120 FIG. 11.

At Step 2000, contact information (such as Name, Street Address, City, State, Zip Code, Email Address, etc.) are searched for and located within the professional profile documents collected in Step 1000 and copied and pasted or otherwise recreated at the top of the professional profile as in FIGS. 18 and 18A so that a computer program may properly import the contact information into the appropriate record fields when the professional profile document is imported into a Contact Database. At Step 3000 FIG. 1, professional profiles collected in Step 1000 and reorganized in Step 2000 are imported into a Contact Database.

At Step 4000 FIG. 1, an advertiser selects a media type such as “post card” or “email” or “Z Fold Letter” from a list. Reacting to the advertiser's selection, the system provides, via computer display, image and object selections relevant to the selected media type. At Step 5000 and 6000 FIG. 1, an advertiser selects images and objects from lists generated and displayed by the system based on the media type selected in Step 4000. During Step 5000 and 6000, the advertiser may choose to submit images and objects other than those made available by the system and instructs our invention and method to execute Steps 11000 through 11040 FIG. 6A or Steps 12000 through 12030 FIG. 6B. Images and objects could include but are not limited to text, image files such as JPEG and GIF, video files such as AVI and MPEG, audio files such as MP3, etc.

At Step 7000, an advertiser inputs text copy that shall appear in the advertising media assembled, and delivered during Steps 13000 through 15000 FIG. 1. At Step 7000 FIG. 1, an advertiser inputs voice or sound recording(s) that shall be included in the advertising media assembled, and delivered during Steps 13000 through 15000 FIG. 1. At Step 7000, an advertiser inputs video recording(s) that shall be included in the advertising media assembled, and delivered during Steps 13000 through 15000 FIG. 1. At Step 7000, an advertiser inputs an HTML object that shall be included in the advertising media assembled, and delivered during Steps 13000 through 15000 FIG. 1.

At Step 8000, an operator inputs search criteria. These may be in the form of characters, words, phrases, combinations of words, combinations of phrases or combinations of words and phrases. In some cases, the operator may input Boolean expressions such as “OR” and “AND,” causing the system to search the Contact Database for a set of professional profiles that meet desired conditions. Once a satisfactory set of professional profiles is selected, the system exports the contact information such as name, street address, City, State, Zip Code, email address, etc. to a file or database record in a delimited format where it is stored for later use in Steps 13000 through 15000. At Step 8000, an operator inputs a delimited field list of contact information from a source other than the system into the data structure where it is stored for later use in Steps 13000 through 15000.

At Step 9000, an operator stores the data entered and the selections made during Steps 4000 through 8120 and views the advertisement as it shall appear assembled or be broadcast assembled. For the purpose of illustration three examples of media types are demonstrated in this patent document: Post Card; Letterhead Z Fold Letter; and Left Border and Letterhead Z Fold Letter. At Step 10000 FIG. 1, an operator of the system creates and stores media types that may be the same or may be different from the demonstrated Post Card; Letterhead Z Fold Letter; and Left Border and Letterhead Z Fold Letter into the Advertisement Submission Database so that they may appear as selections during Steps 4000 through 4030 and their related images and objects may appear as selections during Steps 5000 through 6060.

Step 11000 et seq.

At Step 11000 and 12000, an operator stores text, images and objects, in an Advertisement Submission Database so that they may appear as selections [5000-6060], be stored [9000], and be assembled into complete deliverable advertisements [13000-15000]. At Step 13000, an system administrator using a client interface or Internet browser and processes advertisement submissions made by advertisers [4000-9060] by assembling the components selected [5000-6060] and the Components or advertising copy entered [7000-7070] into a deliverable unit, in the case of email distributed advertisement media types, and a variable information print layout, in the case of printed advertisement media types.

At Step 14000, the variable information (such as name, street address, City, State, Zip Code, email address) is merged from the contact record information stored as a delimited field file [8000] into a print layout [13000] and the merged advertisements are printed. At Step 14000, an system administrator loads a printer with paper, toner and any other required supplies; executes the print command; removes printed advertisements; and cuts, folds, inserts in to envelopes and otherwise prepares advertisements for delivery as necessary.

At Step 15000, an operator, in the case of letters, post cards and other media types delivered by the Post Office, applies postage, bundles and delivers advertisements to the Post Office. At Step 15000, an operator, in the case of HTML formatted advertisements, sound advertisement objects, video advertisement objects on other media types delivered via electronic mail, exports or imports or otherwise transfers electronic mail addresses selected and stored [8000-9060] into a bulk mail handing software application and executes the commands to deliver the HTML formatted advertisement, sound advertisement objects, video advertisement objects on other media types to those electronic mail addresses.

Our Currently-preferred Hardware

The hardware description is for illustration purposes only. The number of computer processors and the method for interfacing used, may vary. Factors that affect required capacity include the number of searches, the size of the professional profiles downloaded and the number of new profiles desired.

Systems other than Windowst NT 4.0 could be used. Other operating systems such as Unix®, OS2®, and Macintosh® could be used, provided they allow the operation of software necessary to our invention.

Element 481 can consist of twenty general purpose computers manufactured by the Compaq® computer company, each equipped with a 360 mhz Pentium® II processor by Intel, 128 megabytes of RAM, a 1.4 gigabyte hard-drive, an Ethernet 10 base T-interface card connected via a category 5 RJ45 patch cable to an Compaq® Ethernet hub, connected in turn to a proxy server, connected to a dsu/csu device, connected to a Cisco® router, connected to a T-1 Internet connection. Attached to the general-purpose computer processors are two video monitors. Above the monitors is a KVM switch manufactured by NTI Corporation, used to switch the keyboard, monitor, and mouse interfaces from one genera purpose computer to another. The purpose of the KVM configuration is to reduce the need for monitors, mice, and keyboards. Our invention uses a monitor and keyboard only at certain times. Therefore, it is not necessary to have a number of keyboards, mice, and monitors equal to the number of general-purpose computers. (See FIG. 13) Installed in each general-purpose computer is application software which causes the functionality as described in Steps 1210 through Step 1355 and whose interface is displayed in FIGS. 1-15.

This embodiment also includes a Compaq® Proliant 3000 5/300 128mb, 512k cache, CD-Rom equipped, NIC interface 10/100TX PCI database server equipped with three 9.1 gigabyte hard drives connected via an ultra SCSI array controller, backup device, and a SCO Unix® operating system. Also installed on this database server is a database tool produced by Bond International Software (London, England) called ADAPT® v.8.6. This server is connected to an Ethernet hub which enables a connection to the other general purpose computers, and to three workstations that are to conduct Step 1355 and the following steps. Our invention consists additionally of three Compaq® Prosignia desktop Windows® NT 4.0 workstations, each equipped with the Adapt database software and, through the network, interfaces with the SCO Unix server which serves the three client work stations for the purpose of importing, querying, sorting and reporting.

Element 470 consists of Compaq® workstations connected to a LAN switch. Other workstations and Internet browsing computers and appliances as might exist are demonstrated as element 480 and access the invention from outside the Local Area Network via the Internet connection [476, 477, 478 479]. Said workstations and Internet browsing computers and appliances may be equipped with client software or browser software which provides access to the servers [472, 575, 488].

Element 488 consists of a color printer. The operation and setup are detailed in: 1. Xerox Corporation, DocuColor 2045 and 2060 Digital Press Customer Expectations Document Feb. 12, 2001 Version, 32 pages; 2. Xerox Corporation, Xerox DocuColor 130CSX Digital Color Production System Installation Planning Guide Launch Version September 2000, 50 pages; 3. Xerox Corporation, Xerox DocuColor 130CSX Digital Color Press Customer Planning Guide Version Jun. 27, 2000, 35 pages; 4. Xerox Corporation, DocuColor 2000 CSX Color Server Customer Expectations Document Version Apr. 2, 2001, 11 pages; 5. Xerox Corporation, Variable Information Customer Expectations Document DocuColor 2045/2060CSX CreoScietex Darwin Desktop 3.1, 24 pages; 6. Scitex Corporation, Document No. 771-51196 Catalog No. 399Z51196A Workflow Guidelines Scitex Darwin Version 2.0 December 1997, 14 pages and 7. Scitex Corporation, Document No. 399Z51072B, Scitex Darwin Tutorial Version 2.0 May 1998, 77 pages.

The examples and embodiments are for illustration and disclosure only, and do not limit our appended claims. Similarly, the documents and refereces discussed here demonstrate teachings currently known in the art, but these documents do not constitute “prior art” for an anticipation and obviousness analysis. In the appended claims, we use singular nouns and pronouns (“a,” “an,” “the”) to mean one or more.

1. A method for harvesting professional profiles, the method comprising:
Searching the Internet,
Identifying web pages and Internet postings containing professional profile data,
Collecting said professional profile data,
Identifying in said professional profile text strings constituting contact information data, and
Storing said Professional Profile and said contact information data into a data structure.

2. The method of claim 1, wherein said contact information comprises an extractable e-mail address.

3. A method for normalizing data from a document containing professional profile data, the method comprising:
Obtaining said document,
Reading said document,
Identifying in said document text strings constituting contact information data, and
Storing said professional profile data and said contact information data into a data structure.

4. The method of claim 3, wherein said contact information comprises an extractable e-mail address.

5. The method of claim 3, further comprising:
Reading documents and combining to create a professional profile,
Identifying in said professional profile text strings constituting contact information data, and
Copying said professional profile and contact information data into a data structure.

6. The method of claim 3, further comprising:
Sorting the data in said data structure to identify profiles meeting a specified parameter, and
Merging said contact information with a pre-defined document template to create a personalized document.

7. The method of claim 3, wherein said professional profile is obtained by harvesting from the Internet.

8. The method of claim 3, wherein said professional profile is obtained from a third party source [selected from the group consisting essentially of data suppliers, resume collection website companies, and equivalents thereof].

9. The method of claim 3, wherein said professional profile is obtained via a professional profile collection program on a website.

10. The method of claim 3, wherein said professional profile is obtained as a response to help wanted advertising.

11. The method of claim 6, wherein said pre-defined document template can incorporate an electronic object.

12. The method of claim 11, wherein said pre-defined document template includes an advertising message.

13. Sorting a set of professional profiles to identify sales and advertisement prospects.

14. The method of claim 13, further comprising:
Obtaining a professional profile,
Identifying in said professional profile text strings constituting contact information data, and
Storing said Professional Profile and said contact information data into a data field or data fields in a data structure.

15. The method of claim 13, wherein said professional profile is obtained by harvesting from the Internet.

16. The method of claim 13, wherein said professional profile is obtained from a third party source [selected from the group consisting essentially of data suppliers, resume collection website companies, and equivalents thereof].

17. The method of claim 13, wherein said professional profile is obtained via a professional profile collection program on a website.

18. The method of claim 13, wherein said professional profile is obtained as a response to help wanted advertising.

19. A method for creating a list of sales or advertising prospects, the method comprising:
Obtaining professional profiles,
Storing said professional profiles in a data structure, and
Sorting to identify a subset of professional profiles stored in said data structure.

20. The method of claim 19, further comprising:
Exporting said contact information data from said subset of professional profiles to create a list.

21. The method of claim 20, wherein said list may take the form of:
A printed list,
A digital file,
A delimited format file,
A format which causes a message to be delivered to each professional profile's contact, or
A merged document.

22. The method of claim 19, wherein said professional profile is obtained by harvesting from the internet.

23. The method of claim 19, wherein said professional profile is obtained from a third party source [selected from the group consisting essentially of data suppliers, resume collection website companies, and equivalents thereof].

24. The method of claim 19, wherein said professional profile is obtained via a professional profile collection program on a website.

25. The method of claim 19, wherein said professional profile is obtained as a response to help wanted advertising.

26. A method for advertising, the method comprising:
Selecting one or more items from a collection of computer stored images, computer stored text objects, computer stored audio objects, computer stored video objects, or other computer stored objects,
Combining said selections into a deliverable medium (advertisement),
Sorting professional profiles in a data structure, and
Merging contact information from said professional profiles into said deliverable medium.

27. The method of claim 26, further comprising:
Delivering said deliverable medium to prospects.

28. The method of claim 26 further comprising:
Printing said deliverable medium as a post card or letter

29. The method of claim 26, wherein said professional profile is obtained by harvesting from the internet.

30. The method of claim 26, wherein said professional profile is obtained from a third party source [selected from the group consisting essentially of data suppliers, resume collection website companies, and equivalents thereof].

31. The method of claim 26, wherein said professional profile is obtained via a professional profile collection program on a website.

32. The method of claim 26, wherein said professional profile is obtained as a response to help wanted advertising.

33. A method of selecting advertisement and notice delivery addresses, the method comprising:
Searching a data structure containing professional profiles,
Identifying a subset of professional profiles,
Identifying in said professional profiles text strings constituting contact information data, and
Exporting said contact information data.

34. A system for harvesting professional profiles, the system comprising:
Searching the Internet,
Identifying web pages and Internet postings containing professional profile data,
Collecting said professional profile data,
Identifying in said professional profile text strings constituting contact information data, and
Storing said Professional Profile and said contact information data into a data structure.

35. The system of claim 1, wherein said contact information comprises an extractable e-mail address.

36. A system for normalizing data from a document containing professional profile data, the system comprising:
Obtaining said document,
Reading said document,
Identifying in said document text strings constituting contact information data, and
Storing said professional profile data and said contact information data into a data structure.

37. The system of claim 36, wherein said contact information comprises an extractable e-mail address.

38. The system of claim 36, further comprising:
Reading documents and combining to create a professional profile,
Identifying in said professional profile text strings constituting contact information data, and
Copying said professional profile and contact information data into a data structure.

39. The system of claim 36, further comprising:
Sorting the data in said data structure to identify profiles meeting a specified parameter, and
Merging said contact information with a pre-defined document template to create a personalized document.

40. The system of claim 36, wherein said professional profile is obtained by harvesting from the Internet.

41. The system of claim 36, wherein said professional profile is obtained from a third party source [selected from the group consisting essentially of data suppliers, resume collection website companies, and equivalents thereof].

42. The system of claim 36, wherein said professional profile is obtained via a professional profile collection program on a website.

43. The system of claim 36, wherein said professional profile is obtained as a response to help wanted advertising.

44. The system of claim 39, wherein said pre-defined document template can incorporate an electronic object.

45. The system of claim 44, wherein said pre-defined document template includes an advertising message.

46. Sorting a set of professional profiles to identify sales and advertisement prospects.

47. The system of claim 46, further comprising:
Obtaining a professional profile,
Identifying in said professional profile text strings constituting contact information data, and
Storing said Professional Profile and said contact information data into a data field or data fields in a data structure.

48. The system of claim 46, wherein said professional profile is obtained by harvesting from the internet.

49. The system of claim 46, wherein said professional profile is obtained from a third party source [selected from the group consisting essentially of data suppliers, resume collection website companies, and equivalents thereof].

50. The system of claim 46, wherein said professional profile is obtained via a professional profile collection program on a website.

51. The system of claim 46, wherein said professional profile is obtained as a response to help wanted advertising.

52. A system for creating a list of sales or advertising prospects, the system comprising:
Obtaining professional profiles,
Storing said professional profiles in a data structure, and
Sorting to identify a subset of professional profiles stored in said data structure.

53. The system of claim 52, further comprising:
Exporting said contact information data from said subset of professional profiles to create a list.

54. The system of claim 53, wherein said list may take the form of:
A printed list,
A digital file,
A delimited format file,
A format which causes a message to be delivered to each professional profile's contact, or
A merged document.

55. The system of claim 52, wherein said professional profile is obtained by harvesting from the internet.

56. The system of claim 52, wherein said professional profile is obtained from a third party source [selected from the group consisting essentially of data suppliers, resume collection website companies, and equivalents thereof].

57. The system of claim 52, wherein said professional profile is obtained via a professional profile collection program on a website.

58. The system of claim 52, wherein said professional profile is obtained as a response to help wanted advertising.

59. A system for advertising, the system comprising:
Selecting one or more items from a collection of computer stored images, computer stored text objects, computer stored audio objects, computer stored video objects, or other computer stored objects,
Combining said selections into a deliverable medium (advertisement),
Sorting professional profiles in a data structure, and
Merging contact information from said professional profiles into said deliverable medium.

60. The system of claim 59, further comprising:
Delivering said deliverable medium to prospects.

61. The system of claim 59 further comprising:
Printing said deliverable medium as a post card or letter

62. The system of claim 59, wherein said professional profile is obtained by harvesting from the internet.

63. The system of claim 59, wherein said professional profile is obtained from a third party source [selected from the group consisting essentially of data suppliers, resume collection website companies, and equivalents thereof].

64. The system of claim 59, wherein said professional profile is obtained via a professional profile collection program on a website.

65. The system of claim 59, wherein said professional profile is obtained as a response to help wanted advertising.

66. A system of selecting advertisement and notice delivery addresses, the system comprising:
Searching a data structure containing professional profiles,
Identifying a subset of professional profiles,
Identifying in said professional profiles text strings constituting contact information data, and
Exporting said contact information data.
